(19) United States
(12) Patent Application Publication
(10) Pub. No.: US 2024/0353230 A1
(43) Pub. Date: Oct. 24, 2024

(54) PROBE BASED ROUTING DIRECTIONS

(71) Applicant: Apple Inc., Cupertino, CA (US)

(72) Inventors: Christian J. West, Sunnyvale, CA (US); Daniel Chen, Sunnyvale, CA (US); Adam K. Wigmore, Sunnyvale, CA (US); Sofia Boutahar, Sunnyvale, CA (US); Daniel A. Palm, Aptos, CA (US); Guido Brueckner, San Francisco, CA (US); Song Gao, Milpitas, CA (US); Ilya M. Sandler, Cupertino, CA (US); Kaspar Fischer, San Francisco, CA (US); Daniel R. Delling, Monte Sereno, CA (US); Julian M. Dibbelt, San Jose, CA (US)

(73) Assignee: Apple Inc., Cupertino, CA (US)

(21) Appl. No.: 18/638,548

(22) Filed: Apr. 17, 2024

Related U.S. Application Data
(60) Provisional application No. 63/497,086, filed on Apr. 19, 2023.

(51) Int. Cl. G01C 21/30

(52) U.S. Cl. CPC G01C 21/30

(57) ABSTRACT

The present application relates to devices and components including apparatus, systems, and methods to generate direction paths to be utilized for providing directions based on probe data of prior travel on a road system.

### CROSS-REFERENCE TO RELATED APPLICATIONS

This application claims priority to U.S. provisional application No. 63/497,086, entitled “Probe Based Routing for Directions,” filed on Apr. 19, 2023, the disclosure of which is incorporated by reference herein in its entirety for all purposes.

### BACKGROUND

As society has grown and individuals have routinely travelled to new and different locations, use of directions to guide individuals from one location to another has become common place. Technological advances in computer technology have allowed computer devices to provide directions from one location to another. In the case of mobile computer devices, it has become common place for the mobile computer devices to provide directions as the individuals travel from one location to the other.

Legacy approaches for providing directions by computer devices have included displaying directions on low fidelity maps. These low fidelity maps would often show representations of roads to be travelled in accordance with the directions, although omitted many details of the roads (such as lane details) as well as other elements that would appear in the area related to the low fidelity map displayed (such as parking area details, median details, and shoulder details).

Advancements in computer technology has allowed computer devices to display higher fidelity maps. These higher fidelity maps may display additional details that were not displayed in the low fidelity maps of legacy approaches. For example, the higher fidelity maps may display lane details, parking area details, median details, and/or shoulder details. The display of these additional details presented in the higher fidelity maps may present opportunities for more detailed directions and/or may present additional challenges.

### BRIEF DESCRIPTION OF THE DRAWINGS

FIG. 1 illustrates an example system arrangement in accordance with some embodiments.

FIG. 2 illustrates another example system arrangement in accordance with some embodiments.

FIG. 3 illustrates an example procedure for generating probe lines in accordance with some embodiments.

FIG. 4 illustrates an example map representation showing a probe trip in accordance with some embodiments.

FIG. 5 illustrates another example map representation showing a map matching of a map matched probe trip in accordance with some embodiments.

FIG. 6 illustrates an example decision trigger area arrangement with checkpoints in accordance with some embodiments.

FIG. 7 illustrates another example decision trigger area arrangement with checkpoints in accordance with some embodiments.

FIG. 8 illustrates another example decision trigger area arrangement with checkpoints in accordance with some embodiments.

FIG. 9 illustrates an example quadruple checkpoint arrangement, for path generation in accordance with some embodiments.

FIG. 10 illustrates an example probe trip arrangement corresponding to the quadruple checkpoint arrangement of FIG. 9 in accordance with some embodiments.

FIG. 11 illustrates an example clipped trips arrangement in accordance with some embodiments.

FIG. 12 illustrates an example sampling arrangement in accordance with some embodiments.

FIG. 13 illustrates an example aggregated points arrangement in accordance with some embodiments.

FIG. 14 illustrates an example segment path arrangement in accordance with some embodiments.

FIG. 15 illustrates an example quadruple checkpoint arrangement for path generation in accordance with some embodiments.

FIG. 16 illustrates an example probe trip arrangement corresponding to the quadruple checkpoint arrangement of FIG. 15 in accordance with some embodiments.

FIG. 17 illustrates an example clipped trips arrangement in accordance with some embodiments.

FIG. 18 illustrates an example sampling arrangement in accordance with some embodiments.

FIG. 19 illustrates an example aggregated points arrangement in accordance with some embodiments.

FIG. 20 illustrates an example segment path arrangement in accordance with some embodiments.

FIG. 21 illustrates an example road system arrangement in accordance with some embodiments.

FIG. 22 illustrates an example road system arrangement in accordance with some embodiments.

FIG. 23 illustrates an example direction path generation arrangement in accordance with some embodiments.

FIG. 24 illustrates an example path merging arrangement in accordance with some embodiments.

FIG. 25 illustrates an example display interface that may be displayed by a computing device in accordance with some embodiments.

FIG. 26 illustrates another example display interface that may be displayed by a computing device in accordance with some embodiments.

FIG. 27 illustrates a diagram showing a flow chart corresponding to an example process for generating a path segment to be utilized for production of direction paths in accordance with some embodiments.

FIG. 28 is a diagram showing a flow chart corresponding to an example process for generating a direction path utilizing a path segment in accordance with some embodiments.

FIG. 29 is a diagram showing a flow chart corresponding to an example process for presenting an indication of a portion of a direction path in accordance with some embodiments.

FIG. 30 is a diagram showing a flow chart corresponding to an example process for producing and storing a path to be utilized for production of direction paths in accordance with some embodiments.

FIG. 31 is a diagram showing a flow chart corresponding to an example process for generating a direction path utilizing a path in accordance with some embodiments.

FIG. 32 is a diagram showing a flow chart corresponding to an example process for presenting an indication of a portion of a direction path in accordance with some embodiments.

FIG. 33 illustrates an example user device in accordance with some embodiments.

FIG. 34 is a block diagram of an example computing device that can implement the features and processes of FIGS. 1-32 in accordance with some embodiments.

FIG. 35 illustrates an example architecture or environment configured to implement techniques described herein in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples; that depart from these specific details. In certain instances, descriptions of well-known devices, circuits, and methods are omitted so as not to obscure the description of the various embodiments with unnecessary detail.

Example of the present disclosure are directed to, among other things, methods, systems, devices, and computer-readable media (e.g., described technology and/or described techniques) for generating direction paths for providing directions to a user. In some examples, a system may utilize quadruples of checkpoints associated with decision trigger areas to determine path segments through the decision trigger areas. The system may determine probe trips that pass through the quadruples of checkpoints and aggregate the probe trips to produce the path segments for the decision trigger areas. The system may generate direction paths using the path segments. Portions of the direction paths may be displayed on a high fidelity map on a user device to provide directions to a user.

In some embodiments described herein, a quadruple of checkpoints may correspond to a decision trigger area. The quadruple of checkpoints may include an entry checkpoint corresponding to the decision trigger area, a first intermediate checkpoint corresponding to the decision trigger area, a second intermediate checkpoint corresponding to the decision trigger area, and an exit checkpoint corresponding to the decision trigger area. The quadruple of checkpoints may define a maneuver performed through the decision trigger area. Limiting the probe trips to probe trips that passed through the quadruple of checkpoints may provide for determining a path segment based on prior trips of users through the decision trigger area that performed the maneuver corresponding to the quadruple of checkpoints. The described technology may improve the accuracy of a direction path (e.g., a path that can be utilized for providing directions from a first location to a second location) by utilizing previously captured probe data from previous traversals of one or more decision trigger areas (e.g., roadway intersections, roadway exits, roadway entrances, roadway lane merges, roadway lane splits, maintenance operations affecting the road system, construction affecting the road system, obstructions affecting the road system, and/or travel experiences affecting the road system) corresponding to a maneuver to be performed along the direction path. Such improvements may provide more accurate suggested positioning (e.g., lane location and/or positioning on a road system) for road system traversal than legacy approaches for providing directions between locations.

In some embodiments, one or more of the checkpoints within a quadruple of checkpoints may correspond to different decision trigger areas. For example, a first checkpoint of the quadruple may correspond to a first decision trigger area, a second checkpoint of the quadruple may correspond to a second decision trigger area, and so forth. As another example, a first checkpoint and a second checkpoint of the quadruple may correspond to a first decision trigger area, a third checkpoint of the quadruple may correspond to a second decision trigger area, and a fourth checkpoint to a third decision trigger area. Having the checkpoints corresponding to different decision trigger areas may allow the system to take into account future and previous maneuvers to be performed when determining a path segment to be utilized for generating direction paths.

Turning now to a first particular example, in this example is provided a computer system for generating a first path segment (e.g., a suggested path for traversal of a portion of a road system) to be utilized for production of direction paths (e.g., suggested paths for traversal from a first location to a second location). In some cases, the first path segment may correspond to a decision trigger area (e.g., an area of a road system where a driver is presented with multiple options from which a driver can select to proceed and/or is presented with more or fewer lanes in which to proceed), where the first path segment can suggest a portion of the decision trigger area (e.g., a lane and/or area) to traverse based on a maneuver (e.g., proceeding straight through the decision trigger area, turning through the decision trigger area, and/or performing a lane change through the decision trigger area) to be performed through the decision trigger area. The computer system may identify a quadruple of checkpoints for the decision trigger area and identify a plurality of probe trips that pass through the quadruple of checkpoints. The computer system can aggregate the plurality of probe trips to generate a path segment that can be utilized for generating direction paths for providing directions from a first location to a second location.

The described technology, including that of the first example, provides technical solutions to solve technical problems of the conventional approaches. For example, conventional approaches for generating direction paths may not utilize historical driver data to generate direction paths for providing directions. The conventional approaches can utilize predefined rules for determining direction path for providing directions without additional input. These conventional approaches may be suitable for low fidelity maps (e.g., maps that lack details, such as lane indications of roadways) where specific details of the direction paths can be omitted. Further, the predefined rules of the conventional approaches may be incorrect in certain instances, such as where details of the road system are unavailable, incorrect, or have not been updated. The described techniques, however, provide automated technical solutions that can utilize captured probe data to produce accurate direction paths that can be utilized with high fidelity maps (e.g., maps that include lane indications, crosswalk indications, and/or other elements included in or around the road system that are not shown in low fidelity maps). These improvements may be realized by the use of aggregating probe trips passing through a quadruple of checkpoints corresponding to a single decision trigger area, the quadruple of checkpoints being associated with a maneuver to be performed through the decision trigger area.

Turning now to a second particular example, in this example is provided a computer system for generating a direction path (e.g., a suggested path for traversal along a road system from a first location to second location) to be utilized for providing directions from a first location to a second location. In some cases, the direction path may be generated by merging a plurality of path segments to produce the direction path. The path segments can be generated based on aggregation of plurality of probe trips that pass through quadruples of checkpoints associated with decision trigger areas. Each of the path segments may correspond to a corresponding decision trigger area, where the direction path suggests a traversal through each of the decision trigger areas from the first location to the second location.

The described technology, including that of the second example, provides technical solutions to solve technical problems of conventional approaches. For example, conventional approaches for generating direction paths may not utilize historical driver data to generate direction paths for providing directions. The conventional approaches can utilize predefined rules for determining direction path for providing directions without additional input. These conventional approaches may be suitable for low fidelity maps (e.g., maps that lack details, such as lane indications of roadways) where specific details of the direction paths can be omitted. Further, the predefined rules of the conventional approaches may be incorrect in certain instances, such as where details of the road system are unavailable, incorrect, or have not been updated. The described techniques, however, provide automated technical solutions that can utilize path segments generated based on previously captured probe data to generate direction paths for providing directions. These improvements may be realized by the use of aggregating probe trips passing through quadruples of checkpoints with each quadruple of checkpoints corresponding to a corresponding single decision trigger area to generate path segments. The path segments may then be merged to generate direction paths.

Turning now to a third particular example, in this example is provided a device for presenting a portion of a direction path from a first location to a second location. In some cases, the direction path may be received in response to the device transmitting a request for directions from the first location to the second location. The direction path may have been generated based on merging of a plurality of path segments. Each of the path segments may be generated based on aggregation of probe trips that pass through a quadruple of checkpoints associated with a corresponding decision trigger area. The device can receive the direction path and display portions of the direction path as the device travels along a portion of a road system corresponding to the direction path. The displayed portions of the direction path can indicate a portion of the road system (e.g., a lane and/or area of the road system) suggested for traversing for travel from the first location to the second location.

The described technology, including that of the third example, provides technical solutions to solve technical problems of the conventional approaches. For example, conventional approaches for displaying a direction path may not indicate a suggestion of a portion of a road system to be traversed. Further, the portion of the direction path illustrated may not correspond to previously captured probe trips of drivers traversing the road system. These conventional approaches may be suitable for low fidelity maps where specific details of the direction paths can be omitted. Further, the conventional approaches may be inaccurate based on the lack of utilizing probe data for generation of the direction paths. The described techniques, however, provide automated technical solutions that can provide accurate and detailed direction paths to be displayed for directions between locations. These improvements may be realized by the use of direction paths generated based on captured probe trip data that can show details available to be displayed on a high fidelity map, such as suggested lanes and/or positions for travel.

Turning now to a fourth particular example, in this example is provided a computer system for generating a path to be utilized for production of direction paths. In some cases, the path may be generated based on checkpoints corresponding to multiple decision trigger areas. For example, the computer system may identify a quadruple of checkpoints corresponding to multiple decision trigger areas and identify a plurality of probe trips that pass through the checkpoints. The computer system can aggregate the plurality of probe trips to generate the path.

The described technology, including that of the fourth example, provides technical solutions to solve technical problems of the conventional approaches. For example, conventional approaches for generating direction paths may not utilize historical driver data to generate direction paths for providing directions. The conventional approaches can utilize predefined rules for determining direction path for providing directions without additional input. These conventional approaches may be suitable for low fidelity maps where specific details of the direction paths can be omitted. Further, the predefined rules of the conventional approaches may be incorrect in certain instances, such as where details of the road system are unavailable, incorrect, or have not been updated. The described techniques, however, provide automated technical solutions that can utilize captured probe data to produce accurate direction paths that can be utilized with high fidelity maps. These improvements may be realized by the use of aggregating probe trips passing through a quadruple of checkpoints corresponding to multiple decision trigger areas, the quadruple of checkpoints being associated with maneuvers to be performed through the decision trigger areas.

Turning now to a fifth particular example, in this example is provided a computer system for generating a direction path to be utilized for providing directions from a first location to a second location. In some cases, the direction path may be generated by merging a plurality of paths to produce the direction path. The paths can be generated based on aggregation of plurality of probe trips that pass through quadruples of checkpoints associated with decision trigger areas. Each of the paths may correspond to multiple corresponding decision trigger areas, where the direction path suggests a traversal through each of the decision trigger areas from the first location to the second location.

The described technology, including that of the fifth example, provides technical solutions to solve technical problems of conventional approaches. For example, conventional approaches for generating direction paths may not utilize historical driver data to generate direction paths for providing directions. The conventional approaches can utilize predefined rules for determining direction path for providing directions without additional input. These conventional approaches may be suitable for low fidelity maps where specific details of the direction paths can be omitted. Further, the predefined rules of the conventional approaches may be incorrect in certain instances, such as where details of the road system are unavailable, incorrect, or have not been updated. The described techniques, however, provide automated technical solutions that can utilize paths generated based on previously captured probe data to generate direction paths for providing directions. These improvements may be realized by the use of aggregating probe trips passing through quadruples of checkpoints with each quadruple of checkpoints corresponding to multiple corresponding decision trigger areas to generate paths. The paths may then be merged to generate direction paths.

Turning now to a sixth particular example, in this example is provided a device for presenting a portion of a direction path from a first location to a second location. In some cases, the direction path may be received in response to the device transmitting a request for directions from the first location to the second location. The direction path may have been generated based on merging of a plurality of paths. Each of the paths may be generated based on aggregation of probe trips that pass through a quadruple of checkpoints associated with multiple corresponding decision trigger areas. The device can receive the direction path and display portions of the direction path as the device travels along a portion of a road system corresponding to the direction path. The displayed portions of the direction path can indicate a portion of the road system (e.g., a lane and/or area of the road system) suggested for traversing for travel from the first location to the second location.

The described technology, including that of the sixth example, provides technical solutions to solve technical problems of the conventional approaches. For example, conventional approaches for displaying a direction path may not indicate a suggestion of a portion of a road system to be traversed. Further, the portion of the direction path illustrated may not correspond to previously captured probe trips of drivers traversing the road system. These conventional approaches may be suitable for low fidelity maps where specific details of the direction paths can be omitted. Further, the conventional approaches may be inaccurate based on the lack of utilizing probe data for generation of the direction paths. The described techniques, however, provide automated technical solutions that can provide accurate and detailed direction paths to be displayed for directions between locations. These improvements may be realized by the use of direction paths generated based on captured probe trip data that can show details available to be displayed on a high fidelity map, such as suggested lanes and/or positions for travel.

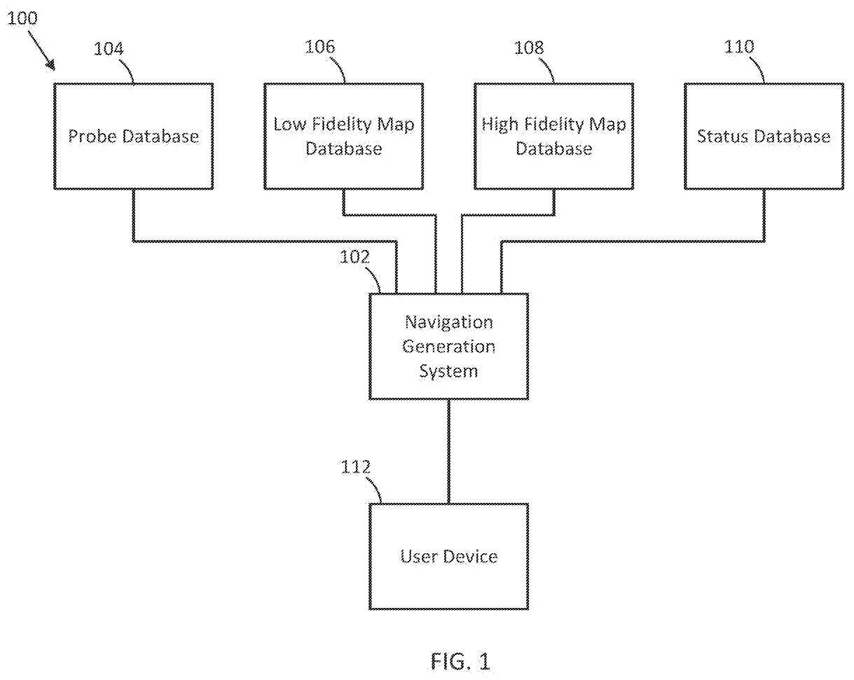

FIG. 1 illustrates an example system arrangement 100 in accordance with some embodiments. In particular, the system arrangement 100 indicates entities in accordance with some embodiments that can generate direction paths for providing directions between locations.

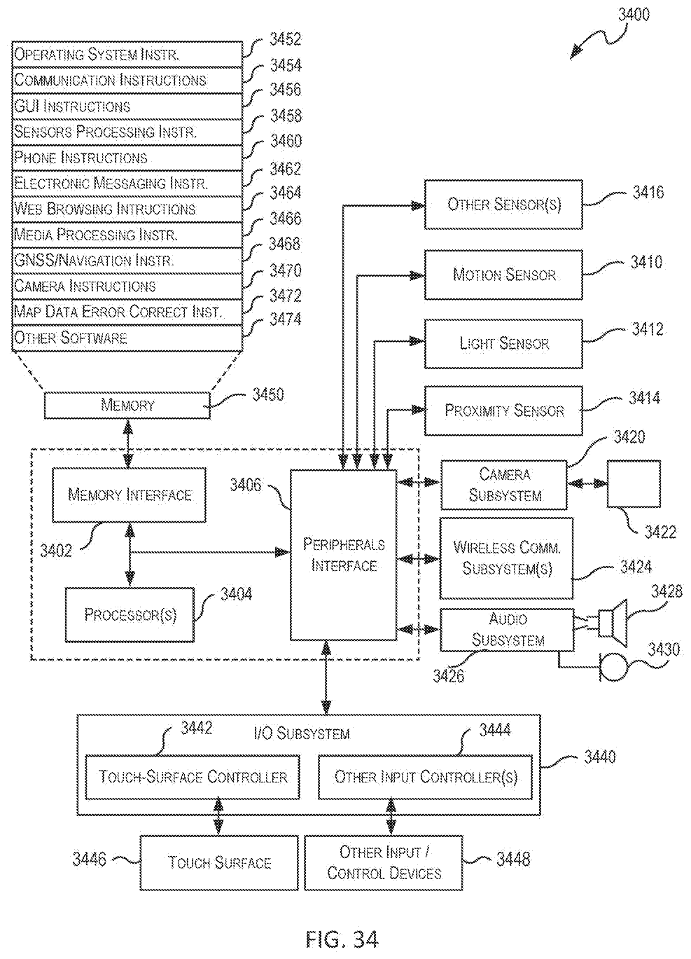

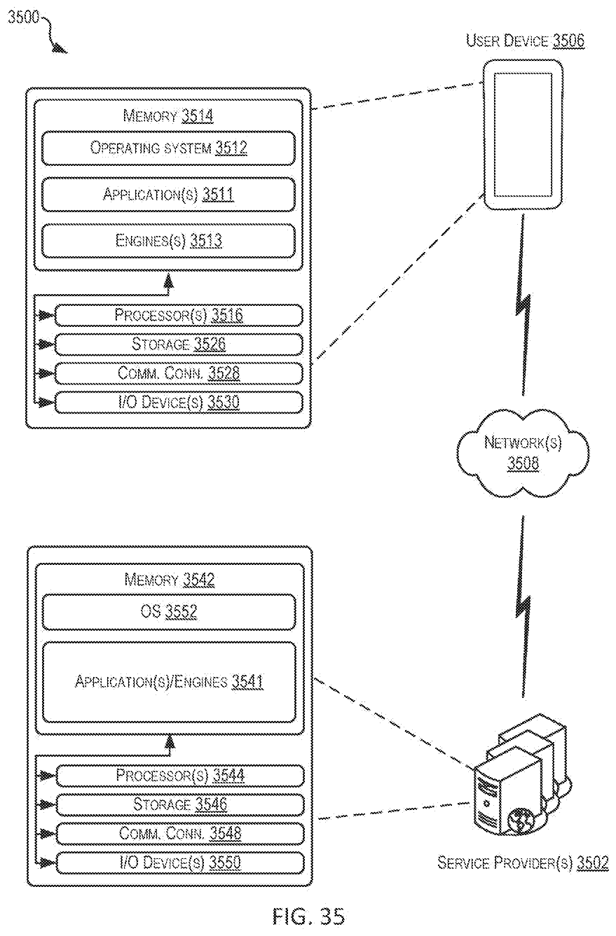

The system arrangement 100 may include a navigation generation system 102. The navigation generation system 102 may include a computing system, such as one or more networked computing devices, one or more servers, and/or one or more cloud devices. In some embodiments, the navigation generation system 102 may include one or more of the features of the computing device 3400 (FIG. 34) and/or the service provider computer 3502 (FIG. 35). The navigation generation system 102 may include one or more memory devices that can store path segments and/or direction paths generated by the navigation generation system 102. In some embodiments, the memory devices may be separate and networked to the navigation generation system 102.

The navigation generation system 102 may determine path segments to be utilized for generating direction paths. The path segments generated by the navigation generation system 102 may provide detailed information that can be utilized to indicate detailed directions on a high fidelity map representation. For example, a high fidelity map may show lanes, sidewalks, dividers, lines, and other details related to a road system that are not shown or not properly shown by lower fidelity maps. The path segments generated by the navigation generation system 102 may indicate a lane and/or other portion of a road system that is suggested to be traveled.

The system arrangement 100 may further include one or more databases that can provide data to the navigation generation system 102 for determining the path segments. For example, the system arrangement 100 includes a probe database 104, a low fidelity map database 106, a high fidelity map database 108, and a current status database 110 in the illustrated embodiment. The navigation generation system 102 may be coupled to the databases and may query the databases for data for determining the path segments to be generated. Further, the navigation generation system 102 may query the databases for data for generating direction paths in some embodiments.

The probe database 104 may store probe data related to a road system. The probe data may indicate trips that were traveled by users and/or vehicles utilizing the road system. For example, users and/or vehicles may be presented with an option to opt in to sharing data related to trips traveled by the users and/or vehicles. Further, users may be presented with an option whether devices and/or vehicles associated with the users are to collect and/or report data related to trips traveled by the users and/or vehicles. In some embodiments, the users and/or the vehicles may have a computer device (such as a smart phone and/or built-in navigation device) that can capture current locations of the users and/or the vehicles. The current locations can be captured continuously, at set intervals, and/or at set triggers. The computer device may be set to share indications of the current locations of the users and/or the vehicles with the probe database 104. The indications of the current locations may further include a time stamp indicating the time that the indication was captured and/or an identifier of the computer device, the user, and/or the vehicle. The probe database 104 may receive the indications of the current locations and determine trips traveled by the users and/or vehicles based on the indicated locations, time stamps, and/or identifiers associated with the indications of the current locations. The probe database 104 may stoic these determined trips as probe trips that can be utilized to determine path segments.

The low fidelity map database 106 may store low fidelity maps of the road system. For example, the low fidelity maps stored by the low fidelity map database 106 may be basic map representations that omit high fidelity details of the road system, such as lanes of the road system, dividers of the road system, markings of the road system, and/or elements around the road system. The low fidelity maps may represent the road system via outlines of the road system in some embodiments.

The high fidelity map database 108 may store high fidelity maps of the road system. In particular, the high fidelity maps stored by the high fidelity map database 108 may provide more information about the road system than the low fidelity maps stored by the low fidelity map database 106. The high fidelity maps may include high fidelity details of the road system, such as lanes of the road system, dividers of the road system, markings of the road system, elements around the road system, and/or objects on parts of the mad system.

The status database 110 may store information about current conditions of the road system. For example, the information stored by the status database 110 may indicate temporary conditions affecting the road system, such as maintenance operations affecting the road system, construction affecting the road system, obstructions (such as accidents and/or other objects) affecting the road system, and/or travel experiences (such as traffic) affecting the road system. The information stored in the status database 110 may be contributed by users, vehicles, maintainers of the road systems, institutions, and/or new sources.

The navigation generation system 102 may query the low fidelity map database 106, the high fidelity map database 108, and/or the status database 110 for data to be utilized to determine checkpoints for the road system. For example, the navigation generation system 102 may identify decision trigger areas for the road system based on data retrieved from the low fidelity map database 106, the high fidelity map database 108, and/or the status database 110.

Generally, the navigation generation system 102 may determine decision trigger areas (e.g., an area of a road system where a driver is presented with multiple options from which a driver can select to proceed and/or is presented with more or fewer lanes in which to proceed), including permanent decision trigger areas and/or temporary decision trigger areas. The permanent decision trigger areas may include decision trigger areas determined based on the road system, such as roadway intersections, roadway exits, roadway entrances, roadway lane merges, and/or roadway lane splits. The temporary decision trigger areas may include decision triggers areas determined based on temporary conditions affecting the road system, such as maintenance operations affecting the road system, construction affecting the road system, obstructions affecting the road system, and/or travel experiences affecting the road system. The navigation generation system 102 may persist the identified permanent decision trigger areas for as long as no changes are made to the road system that affect the decision trigger areas. For the temporary decision trigger areas, the navigation generation system 102 may update the temporary decision trigger areas based on updates related to temporary conditions provided to the navigation generation system 102 and/or may query the databases at intervals for updates related to temporary conditions.

The navigation generation system 102 may determine checkpoints for the road system based on the decision trigger areas. The checkpoints may be determined along road segments of the road systems and/or within the decision trigger areas. For each of the decision trigger areas, the navigation generation system 102 may identify one or more road segments coupled to the decision trigger area. The navigation generation system 102 may identify points where the road segments connect to the decision trigger area and utilize one or more of the points where the road segments connect to the decision trigger area to determine locations of the checkpoints.

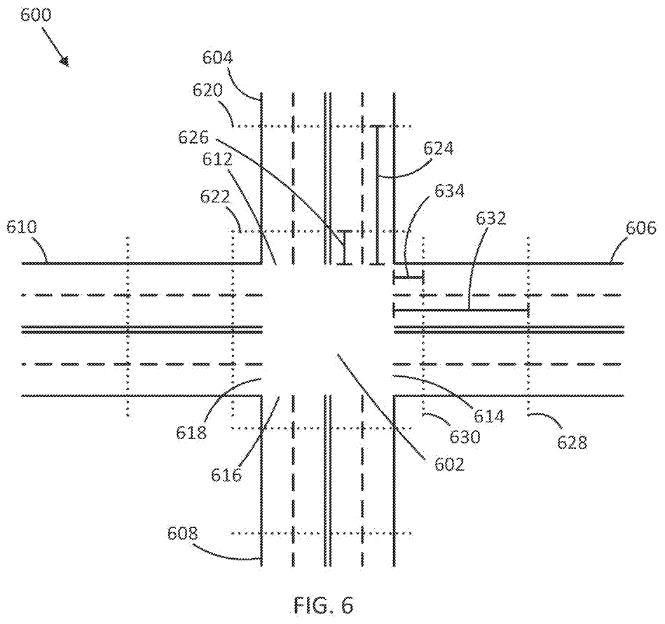

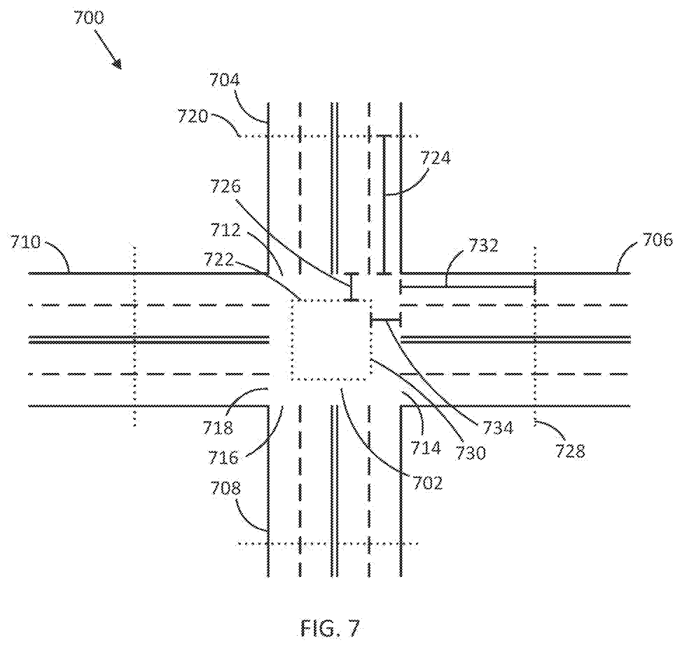

In some embodiments, the navigation generation system 102 may determine multiple checkpoints based on each of the connection points of the road segments with the decision trigger area, such as described further in relation to the decision trigger area arrangement 600 (FIG. 6), and/or the decision trigger area arrangement 700 (FIG. 7). For example, the navigation generation system 102 may determine that a first checkpoint for a connection point is located at a first distance from the connection point along a road segment outside of the decision trigger area. The navigation generation system 102 may determine a second checkpoint for the connection point is located at a second distance from the connection point along the road segment outside of the decision trigger area or within the decision trigger area. In instances where the second checkpoint is determined to be outside of the decision trigger area, the second distance utilized for determining the second checkpoint may be less than the first distance utilized for determining the first checkpoints. The first distance and the second distance may be predefined and/or may be determined based on the classification of the road segments to which each of the first checkpoint and the second checkpoint correspond. In some instances, the first distance may be 100 feet and the second distance may be 50 feet, where the first checkpoint is located 100 feet from the connection point of the decision trigger area along the road segment based on the first distance and the second checkpoint is located 50 feet from the connection point of the decision trigger area along the road segment.

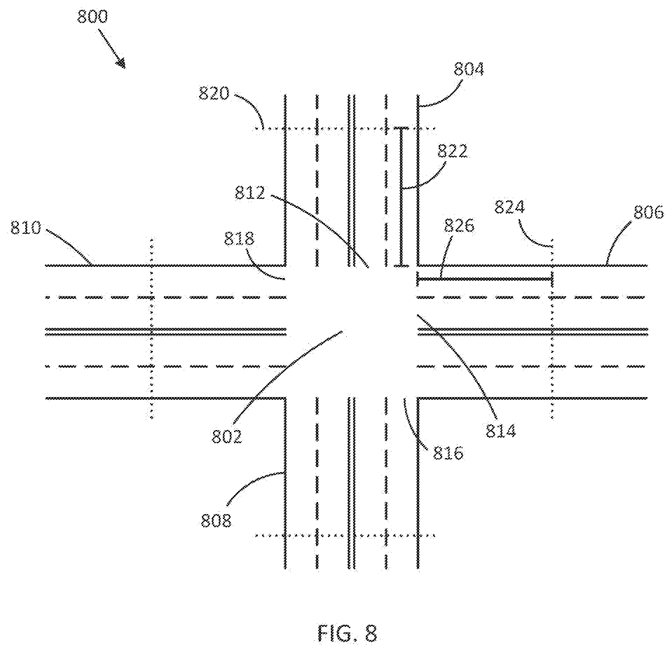

In other embodiments, the navigation generation system 102 may determine a single checkpoint based on each of the connection points of the road segments with the decision trigger area, such as described further in relation to the decision trigger area arrangement 800 (FIG. 8). For example, the navigation generation system 102 may determine that a checkpoint for a connection point is located at a distance from the connection point along a road segment outside of the decision trigger area.

The navigation generation system 102 may identify quadruples of the determined checkpoints for generating path segments. In particular, the navigation generation system 102 may identify four consecutive checkpoints corresponding to a direction of travel and group the four consecutive checkpoints in a quadruple. Each of the quadruples of checkpoints identified by the navigation generation system 102 could represent at least one maneuver to be performed along a route defined by the checkpoints.

In some embodiments, the navigation generation system 102 may select an entry point to a decision trigger area from the connection points of road segments to the decision trigger area and a possible exit point, corresponding to the entry point, from the connection points of road segments to the decision trigger area. The navigation generation system 102 may identify the checkpoints corresponding to the entry point and the checkpoints corresponding to the exit point. Where the navigation generation system 102 determines the multiple checkpoints for each of the connection points, the entry point may have two determined corresponding checkpoints and the exit point may have two determined corresponding checkpoints. The navigation generation system 102 may identify both of the checkpoints corresponding to the entry point and both of the checkpoints corresponding to the exit points. The navigation generation system 102 may determine that the checkpoint corresponding to the entry point farthest from the decision trigger area is an entry checkpoint of a quadruple and the checkpoint corresponding to the entry point closest to the decision trigger area is a first intermediate checkpoint of the quadruple. Further, the navigation generation system 102 may determine that the checkpoint corresponding to the exit point farthest from the decision trigger area is an exit checkpoint of the quadruple and the checkpoint corresponding to the exit point closes to the decision trigger area is a second intermediate checkpoint of the quadruple.

In other embodiments, the navigation generation system 102 may identify checkpoints from consecutive decision trigger areas along a route to be grouped as a quadruple of checkpoints. For example, the navigation generation system 102 may determine a route including at least two decision trigger areas for which a path segment is to be generated. In some of these embodiments, the navigation generation system 102 may identify four consecutive checkpoints along the route to be grouped as a quadruple. For example, the route may extend from a first decision trigger area through a second decision trigger area to a third decision trigger area. The navigation generation system 102 may identify a first checkpoint corresponding to where the route enters the second decision trigger area and a second checkpoint corresponding to where the route exits the second decision trigger area. The navigation generation system 102 may further identify a third checkpoint corresponding to where the route exits the first decision trigger area and a fourth checkpoint corresponding to where the mute enters the third decision trigger area. The navigation generation system 102 may group the first checkpoint, the second checkpoint, the third checkpoint, and the fourth checkpoint as a quadruple.

In other of these embodiments, the navigation generation system 102 may utilize checkpoints before or after the decision trigger areas along the route to define a quadruple. For example, the navigation generation system 102 may determine four consecutive decision trigger areas along the route. In embodiments where the navigation generation system 102 utilizes checkpoints before the decision trigger areas, the navigation generation system 102 may identify each of the checkpoints corresponding to points where the route enters the decision trigger areas. In embodiments where the navigation generation system 102 utilizes checkpoints after the decision trigger areas, the navigation generation system 102 may identify each of the checkpoints corresponding to points where the route exits the decision trigger areas. Accordingly, the navigation generation system 102 may identify a first checkpoint corresponding to the first decision trigger area, a second checkpoint corresponding to the second decision trigger area, a third checkpoint corresponding to the third decision trigger area, and a fourth checkpoint corresponding to the fourth decision trigger area. The navigation generation system 102 may group the first checkpoint, the second checkpoint, the third checkpoint, and the fourth checkpoint as a quadruple.

The navigation generation system 102 may utilize determined quadruples to obtain probe trips for generating path segments. For example, the navigation generation system 102 may query the probe database 104 for stored probe trips that pass through the determined quadruples of checkpoints. The navigation generation system 102 may retrieve one or more probe trips, and/or portions of the probe trips, from the probe database 104 that pass through the four checkpoints of the quadruple of checkpoints.

The navigation generation system 102 may map match the retrieved probe trips to a low fidelity map corresponding to the quadruple of checkpoints. For example, the navigation generation system 102 may retrieve a low fidelity map from the low fidelity map database 106 corresponding to a quadruple of checkpoints. The navigation generation system 102 may map match the retrieved probe trips to portions of the road system corresponding to the quadruple of the checkpoints represented by the retrieved low fidelity map. In some embodiments, if one or more of the probe trips fail to map match to the portions of the road system within a certain error threshold, the probe trips that fail may be removed from plurality of probe trips utilized for determining the path segments.

The navigation generation system 102 may utilize the map matched plurality of probe trips to generate a path segment corresponding to the quadruple of the checkpoints. For example, the navigation generation system 102 may aggregate the map matched plurality of probe trips to generate the path segment. The navigation generation system 102 may sample the plurality of probe trips to generate sample points for each of the probe trips. The navigation generation system 102 may determine geometric medians for the sample points within the same sampling area. The navigation generation system 102 may connect the geometric medians to produce the path segment.

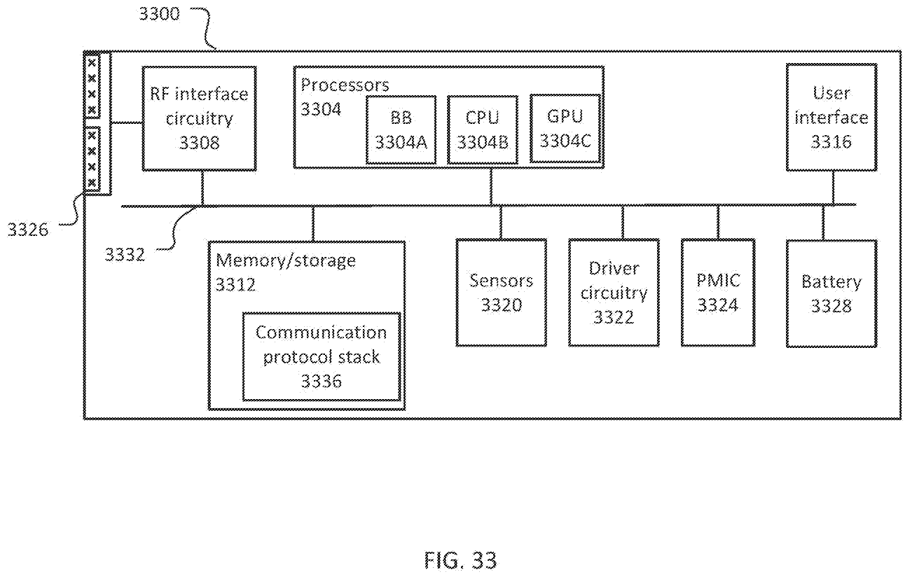

The system arrangement 100 may further include a user device 112. The user device 112 may include a computing device, such as a smart phone and/or a navigation device. In some embodiments, the user device 112 may include one or more of the features of the user device 3300 (FIG. 33), the computing device 3400 (FIG. 34), and/or the user device 3506 (FIG. 35). The user device 112 may be coupled to the navigation generation system 102. The user device 112 may request directions from the navigation generation system 102 from a first location to a second location via the road system. For example, the user device 112 may transmit a request to the navigation generation system 102 that indicates the first location and the second location.

The navigation generation system 102 may identify the request for directions from the first location to second location received from the user device 112. The navigation generation system 102 may retrieve a high fidelity map from the high fidelity map database 108 that includes the first location and the second location. The navigation generation system 102 may determine a route from the first location to the second location via the road system. The navigation generation system 102 may identify one or more path segments previously generated by the navigation generation system along the route from the first location to the second location. In instances where the navigation generation system 102 has not previously generated a path segment for a portion of the route, the navigation generation system 102 may generate a generic path segment for the portion of the route that connects the previously generated path segments for adjacent portions of the route. The navigation generation system 102 may utilize the path segments to produce a direction path from the first location to the second location. For example, the navigation generation system 102 may merge the path segments corresponding to the mute to produce a direction path from the first location to the second location.

The navigation generation system 102 may provide at least a portion of the direction path with a corresponding portion of the high fidelity map to the user device 112. For example, the navigation generation system 102 may determine a location of the user device 112 and provide a portion of the direction path with the corresponding portion of the high fidelity map corresponding to the location of the user device 112. The portion of the direction path may indicate a portion of a road segment (such as a lane) that is recommended to be travelled from the first location to the second location. The user device 112 may display the portion of the high fidelity map and an indication of the portion of the direction path received from the navigation generation system 102.

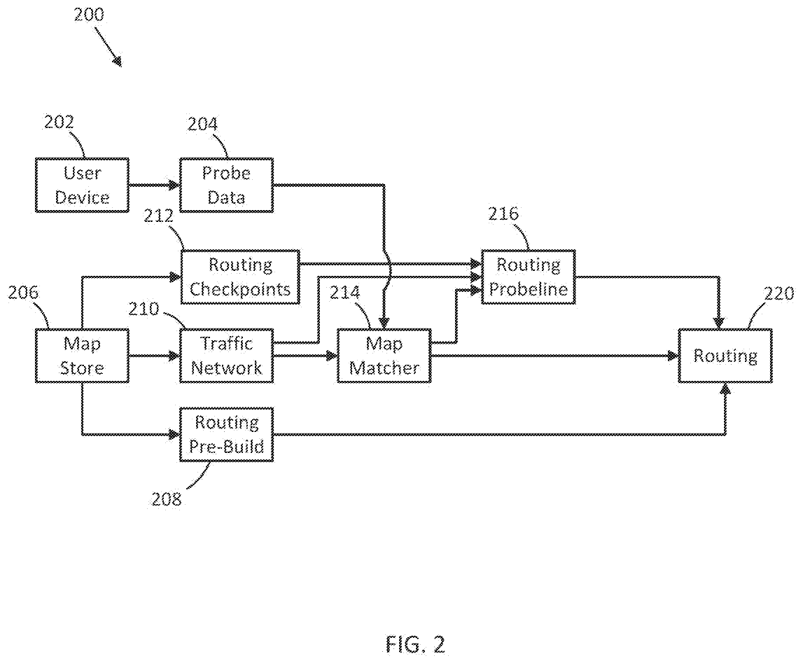

FIG. 2 illustrates another example system arrangement 200 in accordance with some embodiments. The system arrangement 200 indicates entities in accordance with some embodiments that can generate direction path for generating direction paths. One or more of the entities of the system arrangement 200 may be included in a navigation generation system (such as the navigation generation system 102 (FIG. 1)) in some embodiments. In some embodiments, the system arrangement 200 may generate an estimated time of arrival (ETA) for the generated direction paths.

The system arrangement 200 may include a user device 202. The user device 202 may include a computing device, such as a smartphone and/or a navigation device. In some embodiments, the user device 202 may include one or more of the features of the user device 3300 (FIG. 33), the computing device 3400 (FIG. 34), and/or the user device 3506 (FIG. 35). The user device 202 may capture probe data that indicates a location of the user device 202 as a user and/or vehicle that has the user device 202 travels along a road system. In some embodiments, a user of the user device 202 may select whether and/or when the user device 202 captures the probe data that indicates the location of the user device 202 and/or provides the probe data to other devices. The probe data may further indicate times that the probe data was captured. The user device 202 may be one of multiple user devices that can capture probe data and/or provides probe data to other devices. Each of the multiple user devices can provide the option to users whether the user devices capture and/or provide the probe data.

The system arrangement 200 may include a probe data store 204. The probe data store 204 may store probe data received from user devices. The user device 202 may establish a connection with the probe data store 204 and provide the captured probe data to the probe data store 204. The probe data store 204 may store the probe data received from the user device 202. The probe data store 204 may determine probe trips from the probe data based on the locations indicated by the probe data and the times that the probe data was captured.

The system arrangement 200 may include a map store 206. The map store 206 may store one or more maps representing at least a portion of a road system. The map store 206 may store low fidelity maps and/or high fidelity maps.

The system arrangement 200 may include a routing pre-build element 208. The routing pre-build element 208 may receive a map from the map store 206. The routing pre-build element 208 may determine a route based on the map. The routing pre-build element 208 may further receive a request for directions from a first location to a second location and may generate the route based further on the request.

The system arrangement 200 may include a traffic network 210. The traffic network 210 may store information regarding traffic for the road system. For example, the traffic network 210 may store information indicating any high traffic areas for the road system. The traffic network 210 may receive the map from the map store 206. The traffic network 210 may determine traffic conditions for the portion of the road system represented by the map received from the map store 206.

The system arrangement 200 may include a routing checkpoints element 212. The routing checkpoints element 212 may determine checkpoints for a road system. For example, the routing checkpoints element 212 may determine checkpoints for a road system in accordance with the approach for determining checkpoints described in relation to FIG. 1 and throughout this disclosure. The routing checkpoints element 212 may receive the map from the map store 206. The routing checkpoints element 212 may determine checkpoints for the portion of the road system represented by the map.

The system arrangement 200 may include a map matcher element 214. The map matcher element 214 may map match probe trips to a map. The map matcher element 214 may receive the map with traffic information from the traffic network. Further, the map matcher element 214 may receive probe trips from the probe data store 204. The map matcher element 214 may map match the probe trips to the map.

The system arrangement 200 may include a routing probe line element 216. The routing probe line element 216 may generate a direction path (which may be referred to as a probe line) for directions between locations. The routing probe line element 216 may receive the map with the probe trips map matched from the map matcher element 214, the traffic information for the portion of the road system represented by the map from the traffic network 210, and indication of the checkpoints for the portion of the road system from the routing checkpoints element 212. The routing probe line element 216 may generate a direction path based on the received map, traffic information, and indication of checkpoints.

The system arrangement 200 may include a routing element 220. The routing element 220 may determine a route. For example, the routing element 220 may receive the direction path from the routing probe line element 216, the route from the routing pre-build element 208, and the map from the map matcher element 214. The routing element 220 may determine the route based on the received data.

### Path Segment Generation

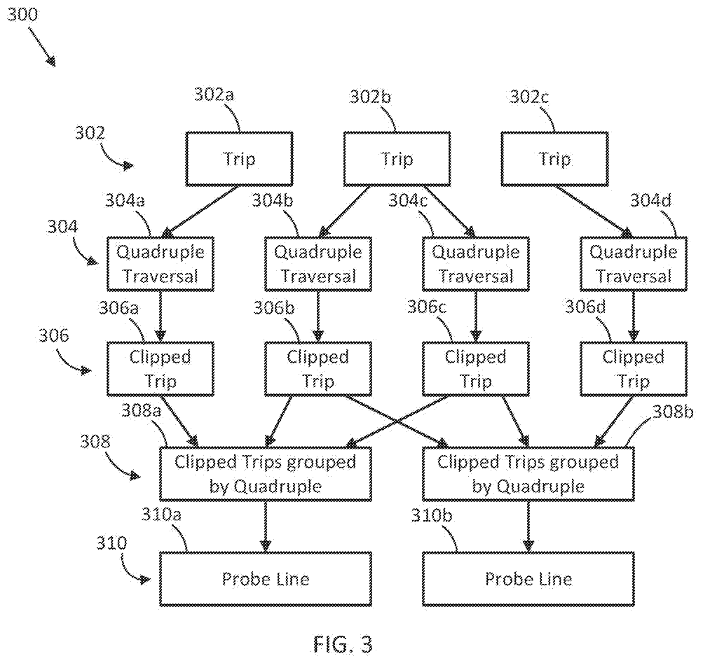

FIG. 3 illustrates an example procedure 300 for generating probe lines in accordance with some embodiments. In particular. FIG. 3 illustrates a logic chart that shows operations of a procedure 300 for generating probe lines. The procedure 300 may be performed by the system arrangement 100 (FIG. 1) and/or the system arrangement 200 (FIG. 2).

The procedure 300 may include retrieving one or more probe trips 302 corresponding to a road system. For example, the procedure 300 may retrieve a first probe trip 302a, a second probe trip 302b, and a third probe trip 302c. The probe trips 302 may be generated based on probe data received from computing devices that have travelled the road system.

The procedure 300 may include determining one or more quadruple traversals 304 from the probe trips 302. For example, the procedure 300 may include determining one or more quadruples of checkpoints that are that are traversed by the probe trips. In the illustrated embodiment, the first probe trip 302a may be determined to have a first quadruple traversal 304a of a first quadruple of checkpoints. The second probe trip 302b may be determined to have a second quadruple traversal 304b of a second quadruple of checkpoints and a third quadruple traversal 304c of a third quadruple of checkpoints. The third probe trip 302c may be determined to have a fourth quadruple traversal 304d of a fourth quadruple of checkpoints.

The procedure 300 may include generating clipped trips 306 from the quadruple traversals 304. In particular, the quadruple traversals 304 may traverse four checkpoints. The clipped trips 306 may be generated by taking the portion of the quadruple traversals 304 that extends between the inner two checkpoints of the four checkpoints. The portion that extends between the inner two checkpoints may be the clipped trips 306 for each of the quadruple traversals 304. In the illustrated embodiment, a first clipped trip 306a is generated from the first quadruple traversal 304a, a second clipped trip 306b is generated from the second quadruple traversal 304b, a third clipped trip 306c is generated from the third quadruple traversal 304c, and a fourth clipped trip 306d is generated from the fourth quadruple traversal 304d.

The procedure 300 may include grouping the clipped trips 306 by the corresponding quadruples to create clipped trip groups 308. In particular, the clipped trips 306 may be grouped in accordance with the quadruple from which the clipped trips 306 were clipped. In the illustrated embodiment, a first clipped trip group 308a and a second clipped trip group 308b are generated. The first clipped trip group 308a may correspond to a first quadruple of checkpoints. The second clipped trip group 308b may correspond to a second quadruple of checkpoints. The first clipped trip 306a and the second clipped trip 306b may be grouped into the first clipped trip group 308a. The third clipped trip 306c and the fourth clipped trip 306d may grouped into the second clipped trip group 308b.

The procedure 300 may include generating probe lines 310. For example, the take the clipped trips 306 grouped into each of the clipped trip groups 308 and aggregate the clipped trips grouped within a clipped trip group to produce a probe line corresponding to the quadruple. In the illustrated embodiment, a first probe line 310a may be generated by aggregating the clipped trips within the first clipped trip group 308a to produce the first probe line 310a. Further, a second probe line 310b may be generated by aggregating the clipped trips within the second clipped trip group 308b to produce the second probe line 310b.

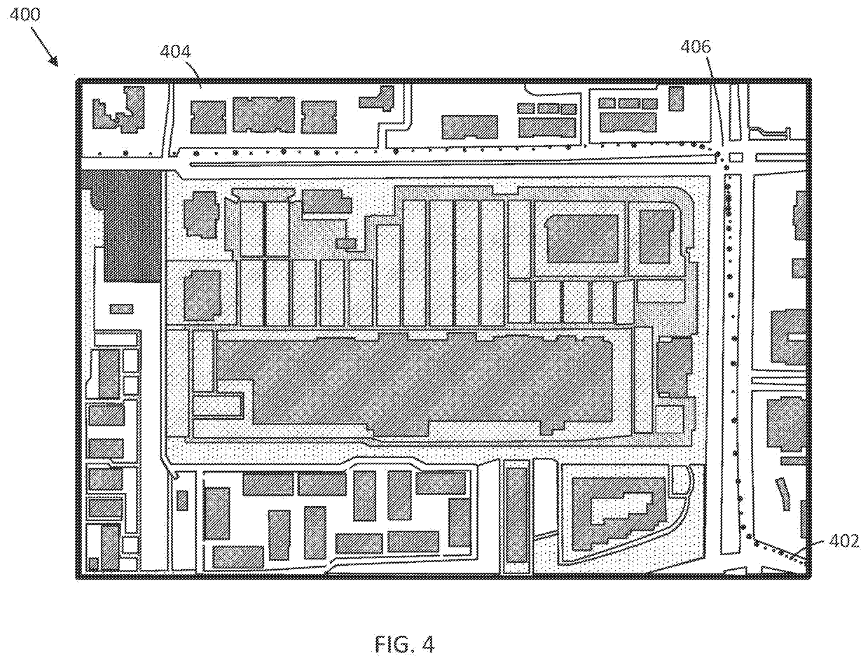

FIG. 4 illustrates an example map representation 400 showing a probe trip in accordance with some embodiments. In particular, the map representation 400 may illustrate a probe trip 402 on a low fidelity map that represents a part of the road system. The map representation 400 may visually represent part of a procedure performed by a navigation generation system, such as the navigation generation system 102 (FIG. 1). For example, the illustrate map representation 400 may illustrate the probe trip 402 prior to being map matched to a map 404 included in the map representation 400.

The navigation generation system may retrieve the probe trip 402 from a probe data store, such as the probe database 104 (FIG. 1) and/or the probe data store 204 (FIG. 2). The probe trip 402 may include a plurality of probe data points corresponding to a trip traveled by a device (such as a smartphone and/or a navigation device). In the illustrated embodiments, the probe data points are indicated by the dots that form the probe trip 402. The probe data points of the probe trip 402 may indicate locations at which the probe data points were captured and/or times at which the probe data points were captured.

The navigation generation system may determine a location of the probe trip 402. Based on determining the navigation generation system determining the location of the probe trip 402, the navigation generation system may retrieve a portion of the map 404 from a map store (such as the low fidelity map database 106 (FIG. 1), the high fidelity map database 108 (FIG. 1), and/or the map store 206 (FIG. 2)) that corresponds to the location of the probe trip 402. The portion of the map 404 retrieved from the map store may be a portion of a low fidelity map in some embodiments. The portion of the map 404 may include one or more decision trigger areas. One or more of the decision trigger areas may correspond to the probe trip 402. In the illustrated embodiment, the map 404 includes an intersection 406 located in the upper-right corner of the map 404 that can be identified as a decision trigger area by the navigation generation system.

As can be seen from the map representation 400, the probe trip 402 is close to roads shown in the map 404 but does not precisely overlay the roads. This difference in the location of the probe trip 402 and the roads may be caused by inaccuracies in the map and/or the captured probe data. These differences in location of the probe trip and the roads can cause issues with the generation of path segments. Accordingly, the navigation generation system may perform map matching of the probe trip 402 with the roads on the map 404 to address the differences, as described further throughout this disclosure.

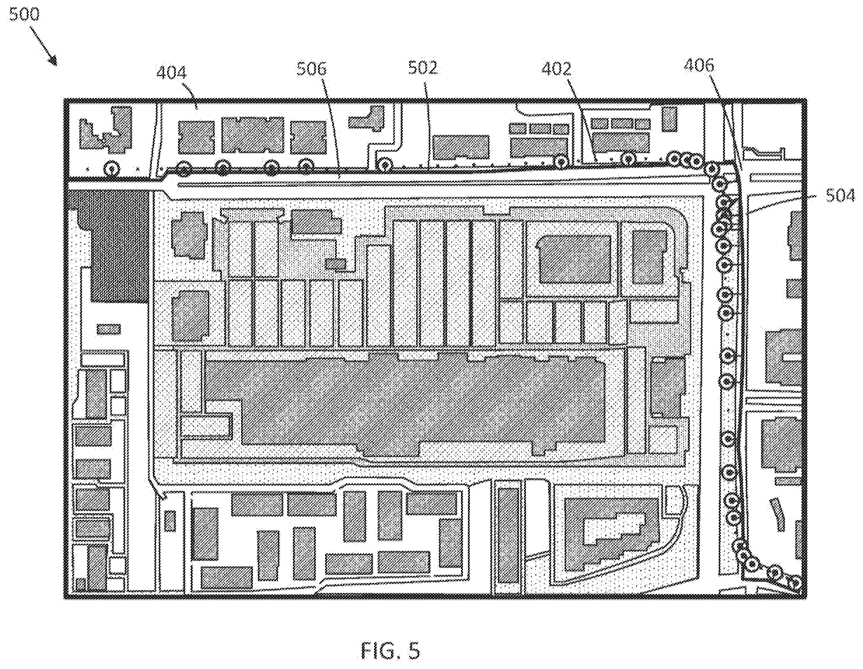

FIG. 5 illustrates another example map representation 500 showing a map matching of a map matched probe trip 502 in accordance with some embodiments. In particular, the map representation 500 illustrates the probe trip 402 being map matched to the roads of the map 404. A navigation generation system (such as the navigation generation system 102 (FIG. 1)) may perform the map matching to match the probe trip 402 to the roads.

The navigation generation system may locate the probe trip 402 (shown by dotted lines) on the map 404. The navigation generation system may compare the probe trip 402 to roads on the map 404 to determine which roads are locationally near the probe trip 402 and/or which roads travel in the same or similar directions to the probe trip 402. In the illustrated embodiment, the navigation generation system may determine that a first road segment 504, the intersection 406, and a second road segment 506 are locationally near the probe trip 402 and travel in similar directions to the probe trip 402. Based on the first road segment 504, the intersection 406, and the second road segment 506 being locationally near the probe trip 402 and travelling in similar directions to the probe trip 402, the navigation generation system may determine that the probe trip 402 corresponds to the first road segment 504, the intersection 406, and the second road segment 506.

The navigation generation system may determine whether probe trip 402 is properly represented on the map 404 to determine whether a location of the probe trip 402 should be adjusted to match the map 404. For example, the navigation generation system may compare the locations of the probe trip 402 to the locations of the first road segment 504, the intersection 406, and the second road segment 506. If the navigation generation system determines that the probe trip 402 is located within the boundaries of the first road segment 504, the intersection 406, and the second road segment 506, the navigation generation system may determine that the location of the probe trip 402 relative to the map 404 is proper and does not need adjustment. If the navigation generation system determines that the probe trip 402 is located outside of the boundaries of any of the first road segment 504, the intersection 406, and the second road segment 506, the navigation generation system may determine that the probe trip 402 is to be adjusted to properly match the map.

The navigation generation system may perform map matching to match the probe trip 402 to the determined corresponding roads and/or intersections. In the illustrated embodiment, the navigation generation system may perform map matching to match the probe trip 402 to the first road segment 504, the intersection 406, and the second road segment 506. While the following describes one approach of map matching being performed by the navigation generation system, it should be understood that there are multiple approaches of map matching known in the art and the navigation generation system may utilize any of the map matching approaches.

For the map matching, the navigation generation system may attempt to shift the probe trip 402 to be within the borders of the first road segment 504, the intersection 406, and/or second road segment 506. The navigation generation system may shift the probe trip 402 by shifting individual probe points of the probe trip 402, by shifting groups of probe points of the probe trip 402, and/or by shifting the probe trip 402 as a whole. In the illustrated embodiments, the navigation generation system is shown shifting the probe trip 402 by the individual probe points. In some embodiments, there may be limits on how far the navigation generation system can shift the probe trip 402 (and/or probe points of the probe trip 402). In embodiments where there are limits on how far the probe trip 402 can be shifted, the navigation generation system may shift the probe trip 402 and/or the probe points of the probe trip 402 the maximum amount within the limits or may not shift the probe trip 402 in instances where the amount of shift of the probe trip 402 and/or the probe points of the probe trip 402 would exceed the limits to place the probe trip 402 within the boundaries of the determined roads.

The navigation generation system may utilize map matching to generate a map matched probe trip that can be used for generating path segments. In the illustrated embodiment, the navigation generation system shifts the probe trip 402 (shown as a dotted line) to generate a map match probe trip 502 (shown as a solid line). In particular, the navigation generation system may shift the probe points of the probe trip 402 to be within the boundaries of the first road segment 504, the intersection 406, and the second road segment 506. The navigation generation system may connect the probe points within the boundaries of the first road segment 504, the intersection 406, and the second road segment 506 (including the shifted probe points) to generate the map matched probe trip 502. The navigation generation system may store the map matched probe trip 502 (such as being stored within the probe database 104 (FIG. 1) and/or the probe data store 204 (FIG. 2)) to be utilized for generating one or more path segments based on the map matched probe trip 502.

As part of the procedure of generating a path segment, a navigation generation system (such as the navigation generation system 102 (FIG. 1)) may determine checkpoints for decision trigger areas. FIG. 6 illustrates an example decision trigger area arrangement 600 with checkpoints in accordance with some embodiments. For example, the decision trigger area arrangement 600 illustrates an example of the navigation generation system determining multiple checkpoints based on each of the connections points of a decision trigger area 602 with the multiple checkpoints located outside of the decision trigger area in accordance with some embodiments.

The navigation generation system may identify a decision trigger area for which checkpoints are to be determined. In the illustrated embodiment, the navigation generation system may identify an intersection as the decision trigger area 602. The navigation generation system may identify the decision trigger area 602 from a map that includes the intersection.

Further, the navigation generation system may identify where the edges of the decision trigger area meet, with one or more road segments. In the illustrated embodiment, a first road segment 604, a second road segment 606, a third road segment 608, and a fourth road segment 610 may connect to the decision trigger area 602. The navigation generation system may identify a first connection point 612 where the first road segment 604 connects to the decision trigger area 602, a second connection point 614 where the second road segment 606 connects to the decision trigger area 602, a third connection point 616 where the third road segment 608 connects to the decision trigger area 602, and a fourth connection point 618 where the fourth road segment 610 connects to the decision trigger area 602.

In the illustrated embodiment, the navigation generation system may determine that checkpoints are to be located outside of the decision trigger area at certain distances from the decision trigger area. The distances that the checkpoints are to be located from the decision trigger area may be predefined and may be based on a classification of the road segment corresponding to the checkpoints, a speed limit of the road segment corresponding to the checkpoints, a number of lanes of the road segment corresponding to the checkpoints, or some combination thereof. For example, the navigation generation system may determine that two checkpoints are to be generated based on the first road segment 604 in the illustrated embodiment. In particular, a first checkpoint 620 and a second checkpoint 622 are to be generated based on the first road segment 604. The navigation generation system may determine the distances that the first checkpoint 620 and the second checkpoint 622 are to be located from the decision trigger area based on one or more characteristics of the first road segment 604, such as the classification of the first road segment 604, the speed limit of the first road segment 604, the number of lanes of the first road segment 604, or some combination thereof.

Based on the characteristics of the first road segment 604, the navigation generation system may determine that the first checkpoint 620 is to be located a first distance 624 from the first connection point 612 and the second checkpoint 622 is to be located a second distance 626 from the first connection point 612. Further, the navigation generation system may determine that the checkpoints are to be located along the corresponding road segment. For example, the navigation generation system may determine the first checkpoint 620 and the second checkpoint are to be generated along the corresponding first road segment 604. Accordingly, the navigation generation system may generate the first checkpoint 620 at the first distance 624 from the decision trigger area 602 along the first road segment 604 (as shown by the corresponding dotted line) and the second checkpoint 622 at the second distance 626 from the decision trigger aca 602 along the first road segment 604 (as shown by the corresponding dotted line).

The navigation generation system may repeat the procedure for determining the locations of the checkpoints for each of the road segments connecting to the decision trigger area. For example, the navigation generation system may determine that a third checkpoint 628 is located along the second road segment 606 at a third distance 632 from the decision trigger area 602 and a fourth checkpoint 630 is located along the second road segment 606 at a fourth distance 634 from the decision trigger area 602. The distances of the third checkpoint 628 and the fourth checkpoint 630 from the decision trigger area 602 may be different than the distances of the first checkpoint 620 and the second checkpoint 622 from the decision trigger area 602 based on any differences between the first road segment 604 and the second road segment 606, such as differences in classifications, speed limits, and/or number of lanes of the first road segment 604 and the second road segment.

FIG. 7 illustrates another example decision trigger area arrangement 700 with checkpoints in accordance with some embodiments. For example, the decision trigger area arrangement 70) illustrates an example of the navigation generation system determining multiple checkpoints based on each of the connection points of a decision trigger area in accordance with some embodiments. The navigation generation system may determine checkpoints located within the decision trigger area and outside of the decision trigger area.

The navigation generation system may identify a decision trigger area for which checkpoints are to be determined. In the illustrated embodiment, the navigation generation system may identify an intersection 702. The navigation generation system may identify the decision trigger area from a map that includes the intersection 702.

Further, the navigation generation system may identify where the edges of the decision trigger area meet with one or more road segments. In the illustrated embodiment, a first road segment 704, a second road segment 706, a third road segment 708, and a fourth mad segment 710 may connect to the intersection 702. The navigation generation system may identify a first connection point 712 where the first mad segment 704 connects to the intersection 702, a second connection point 714 where the second road segment 706 connects to the intersection 702, a third connection point 716 where the third road segment 708 connects to the intersection 702, and a fourth connection point 718 where the fourth road segment 710 connects to the intersection 702.

In the illustrated embodiment, the navigation generation system may determine that a portion of the checkpoints are to be located outside of the decision trigger area at certain distances from the decision trigger area and a portion of the checkpoints are located within the decision trigger area at certain distances from the edges of the decision trigger area. The distances that the checkpoints are to be located from the decision trigger area may be predefined and may be based on a classification of the road segment corresponding to the checkpoints, a speed limit of the road segment corresponding to the checkpoints, a number of lanes of the road segment corresponding to the checkpoints, or some combination thereof. For example, the navigation generation system may determine that two checkpoints are to be generated based on the first road segment 704 in the illustrated embodiment. In particular, a first checkpoint 720 and a second checkpoint 722 are to be generated based on the first road segment 704. The navigation generation system may determine the distances that the first checkpoint 720 and the second checkpoint 722 are to be located from the edges of the decision trigger area based on one or more characteristics of the first road segment 704, such as the classification of the first road segment 704, the speed limit of the first road segment 704, the number of lanes of the first road segment 704, or some combination thereof. In some embodiments, the navigation generation system may determine that the checkpoints within the decision trigger area (such as the second checkpoint 722) are to be located at the connection points rather than a distance from the connection points.

Based on the characteristics of the first road segment 704, the navigation generation system may determine that the first checkpoint 720 is to be located a first distance 724 from the first connection point 712 outside of the intersection 702 along the first road segment 704. The navigation generation system may further determine that the second checkpoint 722 is to be located a second distance 726 from the first connection point 712 within the intersection 702. Accordingly, the navigation generation system may generate the first checkpoint 720 at the first distance 724 from the intersection 702 along the first road segment 704 (as shown by the corresponding dotted line) and the second checkpoint 722 at the second distance 726 within the intersection 702 (as shown by the corresponding dotted line.

The navigation generation system may repeat the procedure for determining the locations of the checkpoints for each of the road segments connecting to the decision trigger area. For example, the navigation generation system may determine that a third checkpoint 728 is located along the second road segment 706 at a third distance 732 from the intersection 702 and a fourth checkpoint 730 is located within the intersection 702 at a fourth distance 734 from the second connection point 714. The distances of the third checkpoint 728 and the fourth checkpoint 730 from the second connection point 714 of the intersection 702 may be different than the distances of the first checkpoint 720 and the second checkpoint 722 from the first connection point 712 of the intersection 702 based on any differences between the first road segment 704 and the second road segment 706, such as differences in classifications, speed limits, and/or number of lanes of the first road segment 704 and the second road segment 706.

FIG. 8 illustrates another example decision trigger area arrangement 800M with checkpoints in accordance with some embodiments. For example, the decision trigger area arrangement 800 illustrates an example of the navigation generation system determining a single checkpoint for each of the connection points of a decision trigger area in accordance with some embodiments. The single checkpoint for each of the connection points may be located outside of the decision trigger area.

The navigation generation system may identify a decision trigger area for which checkpoints are to be determined. In the illustrated embodiment, the navigation generation system may identify an intersection 802. The navigation generation system may identify the decision trigger area from a map that includes the intersection 802. The map utilized by the navigation generation system for determining the checkpoints may be a high fidelity map.

Further, the navigation generation system may identify where the edges of the decision trigger area meet, with one or more road segments. In the illustrated embodiment, a first road segment 804, a second road segment 806, a third road segment 808, and a fourth road segment 810 may connect to the intersection 802. The navigation generation system may identify a first connection point 812 where the first road segment 804 connects to the intersection 802, a second connection point 814 where the second road segment 806 connects to the intersection 802, a third connection point 816 where the third mad segment 808 connects to the intersection 802, and a fourth connection point 818 where the fourth road segment 810 connects to the intersection 802.

In the illustrated embodiment, the navigation generation system may determine that the checkpoints are to be located outside of the decision trigger area at certain distances from the decision trigger area. The distances that the checkpoints are to be located from the decision trigger area may be predefined and may be based on a classification of the road segment corresponding to the checkpoints, a speed limit of the mad segment corresponding to the checkpoints, a number of lanes of the road segment corresponding to the checkpoints, or some combination thereof. For example, the navigation generation system may determine that a checkpoint is to be generated based on the first road segment 804 in the illustrated embodiment. In particular, a first checkpoint 820 is to be generated based on the first road segment 804. The navigation generation system may determine the distance that the first checkpoint 820 is to be located from the corresponding edge of the decision trigger area based on one or more characteristics of the first road segment 804, such as the classification of the first road segment 804, the speed limit of the first road segment 804, the number of lanes of the first road segment 804, or some combination thereof.

Based on the characteristics of the first road segment 804, the navigation generation system may determine that the first checkpoint 820 is to be located a first distance 822 from the first connection point 812 outside of the intersection 802 along the first road segment 804. Accordingly, the navigation generation system may generate the first checkpoint 820 at the first distance 822 from the intersection 802 along the first, road segment 804 (as shown by the corresponding dotted line).

The navigation generation system may repeat the procedure for determining the locations of the checkpoints for each of the road segments connecting to the decision trigger area. For example, the navigation generation system may determine that a second checkpoint 824 is located along the second road segment 806 at a second distance 826 from the intersection 802. The distance of the second checkpoint 824 the second connection point 814 of the intersection 802 may be different than the distance of the first checkpoint 820 from the first connection point 812 of the intersection 802 based on any differences between the first road segment 804 and the second road segment 806, such as differences in classifications, speed limits, and/or number of lanes of the first road segment 804 and the second road segment 806.

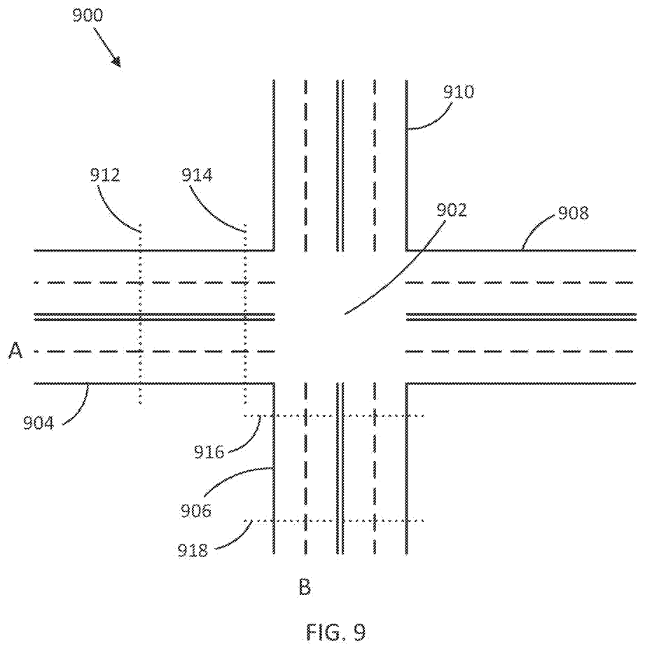

The navigation generation system may utilize the determined checkpoints to generate path segments based on the decision trigger areas. For example, the navigation generation system may utilize the determined checkpoints to limit the probe trips to be utilized for generating path segments. FIG. 9 illustrates an example quadruple checkpoint arrangement 900 for path generation in accordance with some embodiments. For example, the quadruple checkpoint arrangement 900 illustrates an example quadruple of checkpoints for embodiments with multiple checkpoints determined per connection point for a decision trigger area with the checkpoints located outside of the decision trigger area, as described in relation to decision trigger area arrangement 600 of FIG. 6. The described procedure for generating the path segments may also be utilized for determining path segments for embodiments with multiple checkpoints determined per connection point for a decision trigger area with the checkpoints located outside of the decision trigger area and with the decision trigger area.

The quadruple checkpoint arrangement 900 may include an intersection 902. The navigation generation system may determine that the intersection 902 is a decision trigger area in the illustrated embodiment. The navigation generation system may identify possible entry points and corresponding exit points for a decision trigger area. The entry points may include any road segment from which a vehicle may enter the decision trigger area. The corresponding exit points for an entry point may be any road segment from which a vehicle may exit the decision trigger area after entering the decision trigger area via the entry point. The navigation generation system may take into account rules regarding the road system including the decision trigger area and/or rules regarding the decision trigger area in determining the entry points and/or the corresponding exit points. For example, a road segment connected to the decision trigger area has a rule that defines the road segment for one-way travel away from the decision trigger area, the navigation generation system may determine that the road segment is not to be treated as an entry point for the intersection.

In the illustrated embodiment, the navigation generation system may determine that a first road segment 904 may be an entry point for the intersection 902. The navigation generation system may further determine that rules applicable to the intersection allow vehicles to turn right, go straight, or turn left from the first road segment 904 through the intersection 902. Accordingly, the navigation generation system may determine that a second road segment 906 corresponding to a right turn from the first road segment 904, a third road segment 908 corresponding to going straight from the first road segment 904, and a fourth road segment 910 corresponding to a left turn from the first road segment 904 may be corresponding exit points to entry point of the first road segment 904 in the illustrated embodiment. The navigation generation system may apply similar approaches to determine other entry points and corresponding exit points for the intersection 902.

Once the navigation generation system has identified the entry points and the corresponding exit points for the decision trigger area, the navigation generation system may determine that path segments are to be generated from each entry point to each of the corresponding exit points. For example, if the navigation generation system identifies an entry with three corresponding exit points, the navigation generation system may determine that a first path segment is to be generated from the entry point to a first exit point, a second path segment is to be generated from the entry point to a second exit point, and a third path segment is to be generated from the entry point to a third exit point.

The navigation generation system may identify quadruples of checkpoints corresponding to a path segment to be generated to be utilized for generating the path segment. In the illustrated embodiment, the navigation generation system may determine that a path segment is to be generated from entry point ‘A’ along the first road segment 904 to exit point ‘B’ along the second road segment 906. The navigation generation system may identify a quadruple of checkpoints between the entry point ‘A’ and the exit point ‘B’ and determine that the identified checkpoints correspond to the path segment to be generated. In the illustrated embodiment, the navigation generation system may identify a first checkpoint 912, a second checkpoint 914, a third checkpoint 916, and a fourth checkpoint 918 as a quadruple of checkpoints between the entry point ‘A’ and the exit point ‘B’ Since the path segment is to be generated from the entry point ‘A’ to the exit point ‘B,’ the first checkpoint 912 may be referred to as an entry checkpoint, the second checkpoint 914 may be referred to as a first intermediate checkpoint, the third checkpoint 916 may be referred to as a second intermediate checkpoint, and the fourth checkpoint 918 may be referred to as an exit checkpoint.

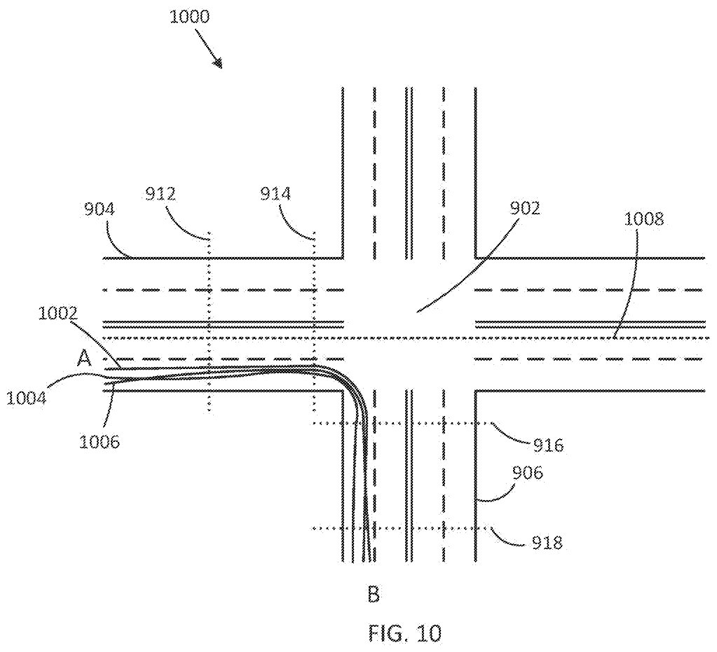

FIG. 10 illustrates an example probe trip arrangement 1000 corresponding to the quadruple checkpoint arrangement 900 of FIG. 9 in accordance with some embodiments. For example, the probe trip arrangement 1000 illustrates example probe trips that can be utilized by the navigation generation system based on the quadruple of checkpoints determined for the quadruple checkpoint arrangement 900.

The probe trip arrangement 1000 includes the intersection 902 with the first road segment 904 and the second road segment 906 connected to the intersection 902. The probe trip arrangement 1000 further includes the quadruple of checkpoints determined by the navigation generation system including the first checkpoint 912, the second checkpoint 914, the third checkpoint 916, and the fourth checkpoint 918.

The navigation generation system may utilize the quadruple of checkpoints to retrieve probe trips for generating a path segment corresponding to the entry point ‘A’ and exit point ‘B.’ For example, the navigation generation system may request a plurality of probe trips that pass through the quadruple of checkpoints. The navigation generation system may request the plurality of probe trips from a probe data store, such as the probe database 104 (FIG. 1) and/or the probe data store 204 (FIG. 2). In some embodiments, the probe trips retrieved by the navigation generation system may include map matched probe trips.

In particular, the navigation generation system may request a plurality of probe trips that pass through the first checkpoint 912, the second checkpoint 914, the third checkpoint 916, and the fourth checkpoint 918 in the direction of travel from entry point ‘A’ to exit point ‘B’ in the illustrated embodiment. The navigation generation system may obtain a first probe trip 1002, a second probe trip 1004, and a third probe trip 1006 that pass through the first checkpoint 912, the second checkpoint 914, the third checkpoint 916, and the fourth checkpoint 918 in the direction of travel in the illustrated embodiment. The request for probe trips that pass through the quadruple of checkpoints can cause other probe trips that pass through the decision trigger area but not through the quadruple of checkpoints to be omitted, such as a fourth probe trip 1008 (shown in a dashed line to indicate that the fourth probe trip 1008 is not utilized for generating the path segment).

The navigation generation system may extract a portion of the retrieved probe trips corresponding to quadruple of checkpoints to produce clipped trips. FIG. 1I illustrates an example clipped trips arrangement 1100 in accordance with some embodiments, in particular, FIG. 1I illustrates some example clipped trips that may be extracted from the probe trips illustrated in the probe trip arrangement 1000 (FIG. 10).

The clipped trips arrangement 1100 includes the intersection 902 with the first road segment 904 and the second road segment 906 connected to the intersection 902. The clipped trips arrangement 100M further includes the quadruple of checkpoints determined by the navigation generation system including the first checkpoint 912, the second checkpoint 914, the third checkpoint 916, and the fourth checkpoint 918.

The navigation generation system may extract clipped trips from the retrieved probe trips between the intermediate checkpoints. Extracting the clipped trips may include keeping the portion of the probe trips located between the intermediate checkpoints for generating the path segment.

In the illustrated embodiment, the second checkpoint 914 is the first intermediate checkpoint and the third checkpoint 916 is the second intermediate checkpoint in the illustrated embodiment. The navigation generation system may keep the portions of the first probe trip 1002 (FIG. 10), the second probe trip 1004 (FIG. 10), and the third probe trip 1006 (FIG. 10) between the second checkpoint 914 and the third checkpoint 916 to produce the clipped trips. In particular, the navigation generation system may generate a first clipped trip 1102 between the second checkpoint 914 and the third checkpoint 916 from the first probe trip 1002, a second clipped trip 1104 between the second checkpoint 914 and the third checkpoint 916 from the second probe trip 1004, and a third clipped trip 1106 between the second checkpoint 914 and the third checkpoint 916 from the third probe trip 1006. For example, the first clipped trip 1102 may be a saved part of the first probe trip 1002, the second clipped trip 1104 may be a saved part of the second probe trip 1004, and the third clipped trip 1106 may be a saved part of the third probe trip 1006.

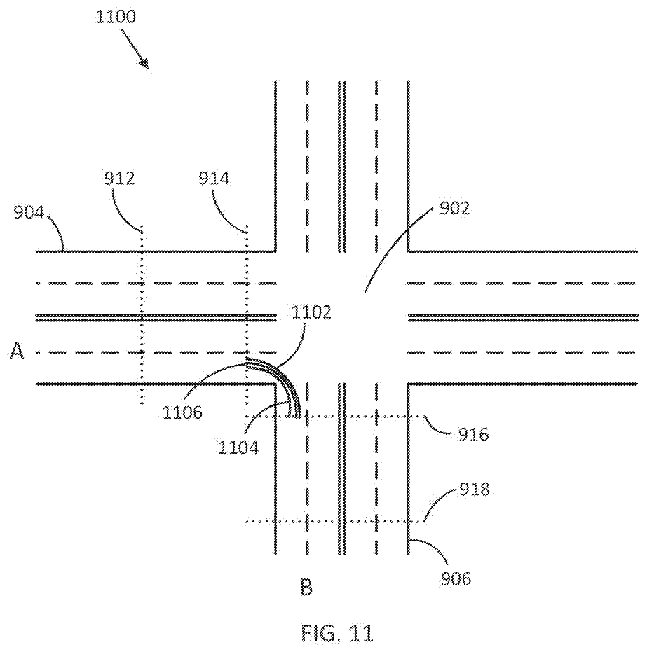

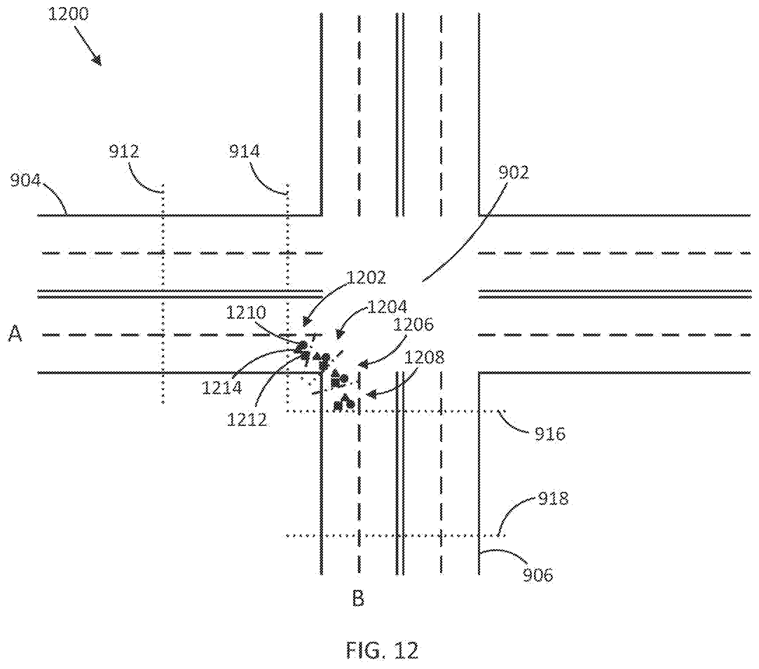

The navigation generation system may sample the clipped trips to produce samples points for aggregating the clipped trips. For example, the navigation generation system may divide the clipped trips into multiple probe segments. The navigation generation system may divide the clipped trips into equally sized probe segments in some embodiments. The navigation generation system may sample each of the clipped trips within the probe segments to produce points to be utilized for generating the path segment. FIG. 12 illustrates an example sampling arrangement 1200 in accordance with some embodiments. In particular, the sampling arrangement 1200 may illustrate sampling performed by the navigation generation system on the clipped trips from the clipped trips arrangement 1100 (FIG. 11).

The sampling arrangement 1200 includes the intersection 902 with the first road segment 904 and the second road segment 906 connected to the intersection 902. The sampling arrangement 120) further includes the quadruple of checkpoints determined by the navigation generation system including the first checkpoint 912, the second checkpoint 914, the third checkpoint 916, and the fourth checkpoint 918.

The navigation generation system may separate the area between the intermediate checkpoints into multiple probe segments for sampling. For example, the navigation generation system has separated the area between second checkpoint 914 and the third checkpoint 916 into four equally sized probe segments. In particular, the navigation generation system has divided the area into a first probe segment 1202, a second probe segment 1204, a third probe segment 1206, and a fourth probe segment 1208.

The navigation generation system may sample each of the clipped trips within the probe segments to generate points corresponding to each of the clipped trips within the probe segments. The points produced may be utilized for generating a path segment between the second checkpoint 914 and the third checkpoint 916. In the illustrated embodiment, the navigation generation system may generate a first set of points 1210 (shown via circles in the illustrated embodiment) by sampling the first clipped trip 1102 (FIG. 11), a second set of points 1212 (shown via squares in the illustrated embodiment) by sampling the second clipped trip 1104 (FIG. 11), and a third set of points 1214 (shown via triangles in the illustrated embodiment) by sampling the third clipped trip 1106 (FIG. 11). The sampling for a clipped trip within a probe segment may include selecting a probe location of the clipped trip within the probe segment to produce the point corresponding to the clipped trip within the probe segment.

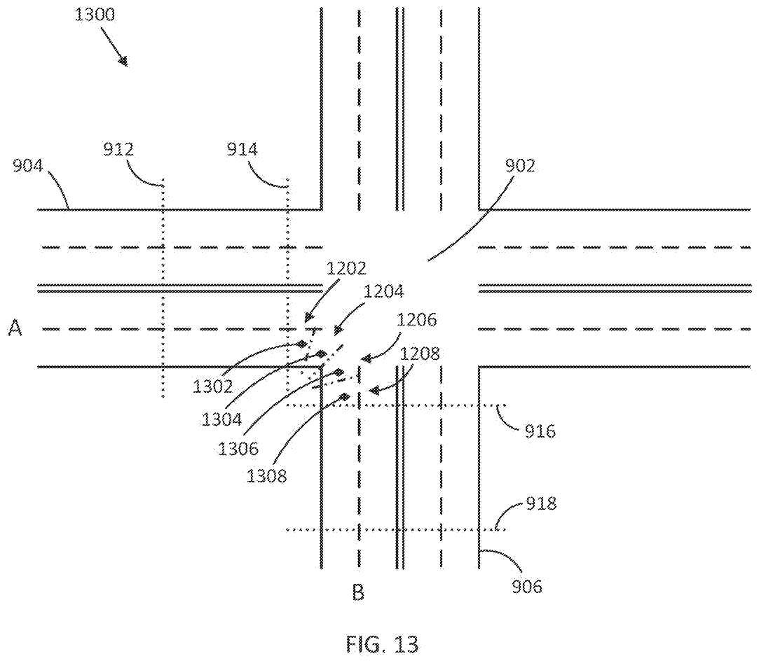

The navigation generation system may aggregate the points generated by the sampling to generate aggregated points for producing the path segment. The aggregating of the points may include the navigation generation system determining geometric medians from the sample points for each of the probe segments to produce the aggregated points. FIG. 13 illustrates an example aggregated points arrangement 1300 in accordance with some embodiments. In particular, the aggregated points arrangement 1300 may illustrate a result of aggregating the sets of points from the sampling arrangement 1200 (FIG. 12) to produce aggregated points.

The aggregated points arrangement 1300 includes the intersection 902 with the first road segment 904 and the second road segment 906 connected to the intersection 902. The aggregated points arrangement 130) further includes the quadruple of checkpoints determined by the navigation generation system including the first checkpoint 912, the second checkpoint 914, the third checkpoint 916, and the fourth checkpoint 918. The aggregated points arrangement 1300 further includes the first probe segment 1202, the second probe segment 1204, the third probe segment 1206, and the fourth probe segment 1208.

The navigation generation system may utilize a point from each set of points within a probe segment to determine a geometric median for the probe segment. Further, the navigation generation system may generate an aggregated point for each of the probe segments at the determined geometric median for the probe segment.

For example, the navigation generation system may determine a geometric median for the first probe segment 1202 based on a first point from the first set of points 1210 (FIG. 12), a first point from the second set of points 1212 (FIG. 12), and a first point from the third set of points 1214 (FIG. 12) located within the first probe segment 1202. The navigation generation system may generate a first aggregated point 1302 for the first probe segment 1202 at the determined geometric median for the first probe segment 1202. The navigation generation system may determine a geometric median for the second probe segment 1204 based on a second point from the first set of points 1210, a second point from the second set of points 1212, and a second point from the third set of points 1214 located within the second probe segment 1204. The navigation generation system may generate a second aggregated point 1304 for the second probe segment 1204. The navigation generation system may determine a geometric median for the third probe segment 1206 based on a third point from the first set of points 1210, a third point from the second set of points 1212, and a third point from the third set of points 1214 located within the third probe segment 1206. The navigation generation system may generate a third aggregated point 1306 for the third probe segment 1206. The navigation generation system may determine a geometric median for the fourth probe segment 1208 based on a fourth point from the first set of points 1210, a fourth point from the second set of points 1212, and a fourth point from the third set of points 1214 located within the fourth probe segment 1208. The navigation generation system may generate a fourth aggregated point 1308 for the fourth probe segment 1208.

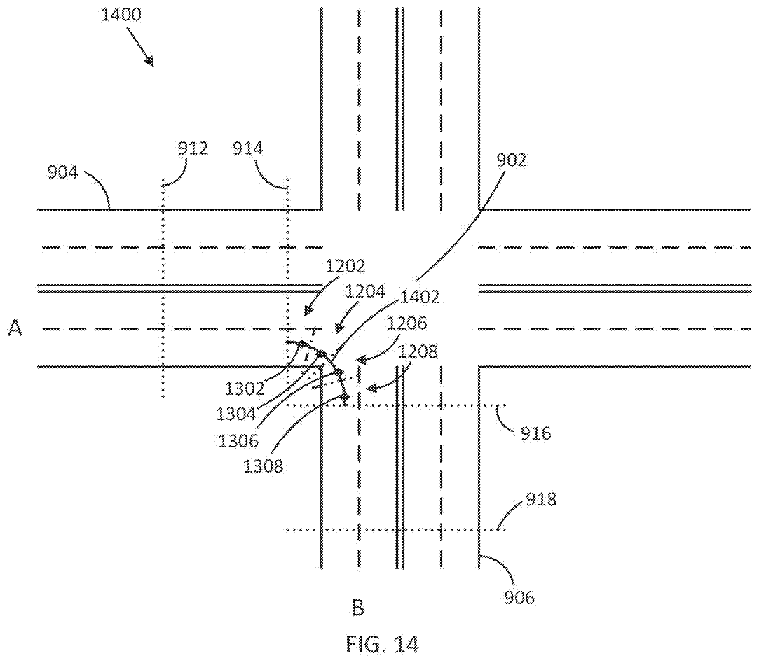

The navigation generation system may generate a path segment between the intermediate checkpoints, where the path passes through or close to the aggregated points. FIG. 14 illustrates an example segment path arrangement 1400 in accordance with some embodiments. In particular, the segment path arrangement 1400 may illustrate a path segment generated based on the aggregated points from the aggregated points arrangement 1300 (FIG. 13).

The segment path arrangement 1400 includes the intersection 902 with the first road segment 904 and the second road segment 906 connected to the intersection 902. The segment path arrangement 1400 further includes the quadruple of checkpoints determined by the navigation generation system including the first checkpoint 912, the second checkpoint 914, the third checkpoint 916, and the fourth checkpoint 918. The segment path arrangement 1400 further includes the first probe segment 1202, the second probe segment 1204, the third probe segment 1206, and the fourth probe segment 1208. Further, the segment path arrangement 1400 includes the first aggregated point 1302, the second aggregated point 1304, the third aggregated point 1306, and the fourth aggregated point 1308.

The navigation generation system may generate a path segment 1402 from the second checkpoint 914 to the third checkpoint 916. The path segment 1402 may pass through the first aggregated point 1302, the second aggregated point 1304, the third aggregated point 1306, and the fourth aggregated point 1308. As the first aggregated point 1302, the second aggregated point 1304, the third aggregated point 1306, and the fourth aggregated point 1308 are generated based on the first probe trip 1002, the second probe trip 1004, and the third probe trip 1006, the path segment 1402 may be generated based on the plurality of probe trips. The navigation generation system may generate the path segment 1402 to be a smooth curve between the second checkpoint 914 and the third checkpoint 916. In some embodiments, the path segment 1402 may further be generated based on a third path segment between the first checkpoint 912 and the second checkpoint 914, and/or a fourth path segment between the third checkpoint 916 and the fourth checkpoint 918. In instances where the positions of the aggregated points would not allow for a curve passing through the aggregated points to meet a predefined smoothness threshold, the navigation generation system may generate a curve that meets the predefined smoothness threshold and limits the distance between the curve and the aggregated points. The navigation generation system may store the path segment 1402 to be utilized for generating direction paths that pass through the intersection 902.

The described procedure for generating the path segment may be utilized for generating other path segments along the road system. For example, the navigation generation system may identify another quadruple of checkpoints that has the first checkpoint 912 as the first intermediate checkpoint and the second checkpoint 914 as the second intermediate checkpoint, such as by having an adjacent checkpoint along the first road segment being included in a quadruple of checkpoints with the first checkpoint 912, the second checkpoint 914, and the third checkpoint 916. The navigation generation system may then apply the procedure to generate a path segment from the first checkpoint 912 to the second checkpoint 914.

The approach for generating the path segments may differ for embodiments where a single checkpoint is determined per connection point for a decision trigger area. For example, the navigation generation system may determine quadruples of checkpoints for generating the path segments, where the checkpoints within the quadruples may correspond to at least two different decision trigger areas. The navigation generation system may utilize checkpoints before the decision trigger areas based on the direction of the path segments to be generated, checkpoints after the decision trigger areas based on the direction of the path segments to be generated, or both the checkpoints before and after the checkpoints.

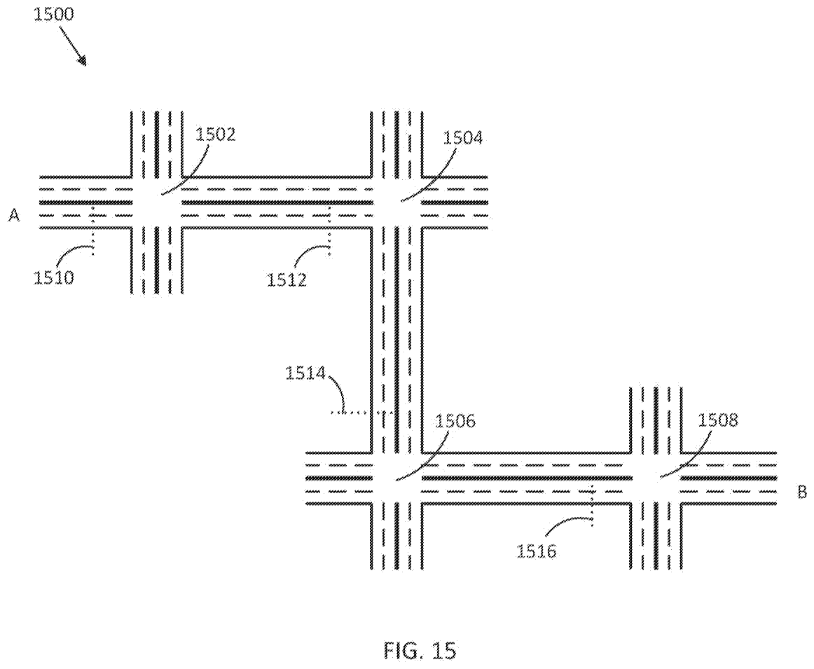

FIG. 15 illustrates an example quadruple checkpoint arrangement 1500 for path generation in accordance with some embodiments. For example, the quadruple checkpoint arrangement 900 illustrates an example quadruple of checkpoint for embodiments with a single checkpoint determined per connection point for a decision trigger area, as described in relation to the decision trigger area arrangement 800 of FIG. 8. In the illustrated embodiment, the navigation generation system may utilize the checkpoints before the decision trigger areas based on the direction of the path segment to be produced to produce the path segment.

In the illustrated embodiment, the navigation generation system may be generating path segments in a direction from location ‘A’ to location ‘B.’ The navigation generation system may identify checkpoints before the decision trigger area for identifying a quadruple of checkpoints.

For example, the quadruple checkpoint arrangement 1500 includes a first decision trigger area 1502, a second decision trigger area 1504, a third decision trigger area 1506, and a fourth decision trigger area 1508 in the illustrated embodiment. In the illustrated embodiment, the first decision trigger area 1502, the second decision trigger area 1504, the third decision trigger area 1506, and the fourth decision trigger area 1508 are illustrated as intersections. It should be understood that the decision trigger areas may be any combination of the classifications of decision trigger areas described throughout this disclosure. The navigation generation system may have determined that a first checkpoint 1510 is located before the first decision trigger area 1502, a second checkpoint 1512 is located before the second decision trigger area 1504, a third checkpoint 1514 is located before the third decision trigger area 1506, and a fourth checkpoint 1516 is located before the fourth decision trigger area 1508.

The navigation generation system may identify four consecutive checkpoints to be included in a quadruple of checkpoints for generating a path segment. In the illustrated embodiment where the direction is to be from location ‘A’ to location ‘B,’ the navigation generation system may determine that the first checkpoint 1510, the second checkpoint 1512, the third checkpoint 1514, and the fourth checkpoint 1516 are consecutive checkpoints for the direction from location ‘A’ to location ‘B.’ The navigation generation system may group the first checkpoint 1510, the second checkpoint 1512, the third checkpoint 1514, and the fourth checkpoint 1516 as a quadruple of checkpoints.

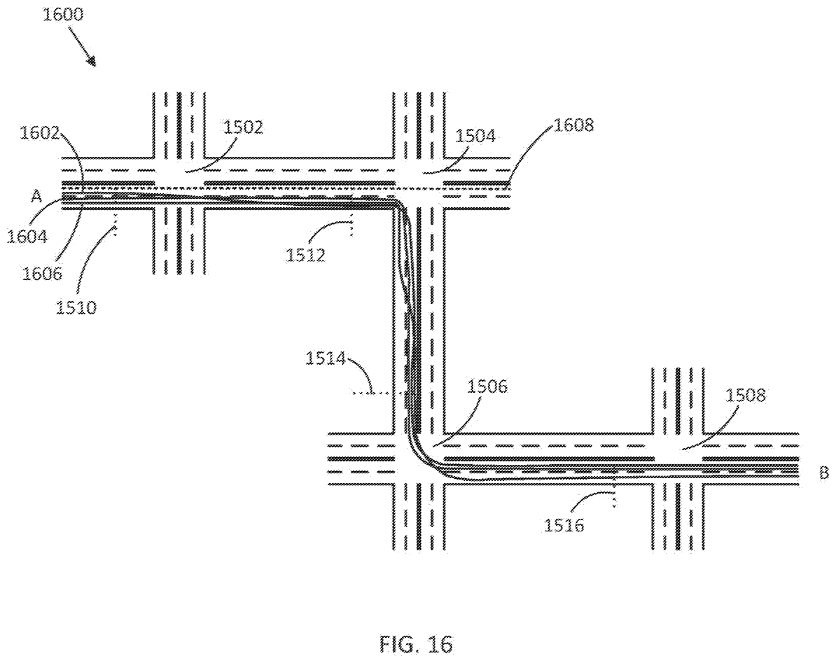

The navigation generation system may retrieve a plurality of probe trips based on the identified quadruple of checkpoints. FIG. 16 illustrates an example probe trip arrangement 1600 corresponding to the quadruple checkpoint arrangement 1500 of FIG. 15 in accordance, with some embodiments. For example, the probe trip arrangement 1600 illustrates example probe trips that can be utilized by the navigation generation system based on the quadruple of checkpoints identified in the quadruple checkpoint arrangement 1500.

The probe trip arrangement 1600 includes the first decision trigger area 1502, the second decision trigger area 1504, the third decision trigger area 1506, and the fourth decision trigger area 1508. Further, the probe trip arrangement 1600 includes the first checkpoint 1510, the second checkpoint 1512, the third checkpoint 1514, and the fourth checkpoint 1516.

The navigation generation system may utilize the quadruple of checkpoints to retrieve probe trips for generating a path segment between the location ‘A’ and the location ‘B.’ For example, the navigation generation system may request a plurality of probe trips that pass through the quadruple of checkpoints for the direction from location ‘A’ to location ‘B.’ The navigation generation system may request the plurality of probe trips from a probe data store, such as the probe database 104 (FIG. 1) and/or the probe data store 204 (FIG. 2). In some embodiments, the probe trips retrieved by the navigation generation system may include map matched probe trips.

For example, the navigation generation system may request a plurality of probe trips that pass through the first checkpoint 1510, the second checkpoint 1512, the third checkpoint 1514, and the fourth checkpoint 1518 in the direction of travel from location ‘A’ to location ‘B’ in the illustrated embodiment. The navigation generation system may obtain a first probe trip 1602, a second probe trip 1604, and a third probe trip 1606 that pass through the first checkpoint 1510, the second checkpoint 1512, the third checkpoint 1514, and the fourth checkpoint 1518 in the direction of travel in the illustrated embodiment. The request for probe trips that pass through the quadruple of checkpoints can cause other probe trips that pass through the decision trigger area but not through the quadruple of checkpoints to be omitted, such as a fourth probe trip 1608 (shown in a dashed line to indicate that the fourth probe trip 1608 is not utilized for generating the path segment).

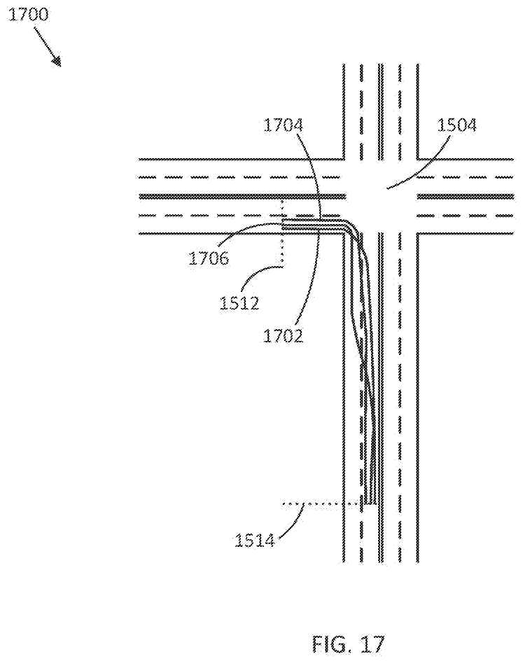

The navigation generation system may extract a portion of the retrieved probe trips corresponding to quadruple of checkpoints to produce clipped trips. FIG. 17 illustrates an example clipped trips arrangement 1700 in accordance with some embodiments. In particular, FIG. 17 illustrates some example clipped trips that may be extracted from the probe trips illustrated in the probe trip arrangement 1600 (FIG. 16).

The clipped trips arrangement 1700 includes the second decision trigger area 1504. The clipped trips arrangement 1700 further includes the second checkpoint 1512 and the third checkpoint 1514.

The navigation generation system may extract clipped trips from the retrieved probe trips between the intermediate checkpoints. Extracting the clipped trips may include keeping the portion of the probe trips located between the intermediate checkpoints for generating the path segment.

In the illustrated embodiment, the second checkpoint 1512 is the first intermediate checkpoint and the third checkpoint 1514 is the second intermediate checkpoint in the illustrated embodiment. The navigation generation system may keep the portions of the first probe trip 1602 (FIG. 16), the second probe trip 1604 (FIG. 16), and the third probe trip 1606 (FIG. 16) between the second checkpoint 1512 and the third checkpoint 1514 to produce the clipped trips. In particular, the navigation generation system may generate a first clipped trip 1702 between the second checkpoint 1512 and the third checkpoint 1514 from the first probe trip 1602, a second clipped trip 1704 between the second checkpoint 1512 and the third checkpoint 1514 from the second probe trip 1604, and a third clipped trip 1706 between the second checkpoint 1512 and the third checkpoint 1514 from the third probe trip 1606. For example, the first clipped trip 1702 may be a saved part of the first probe trip 1602, the second clipped trip 1704 may be a saved part of the second probe trip 1604, and the third clipped trip 1706 may be a saved part of the third probe trip 1606.

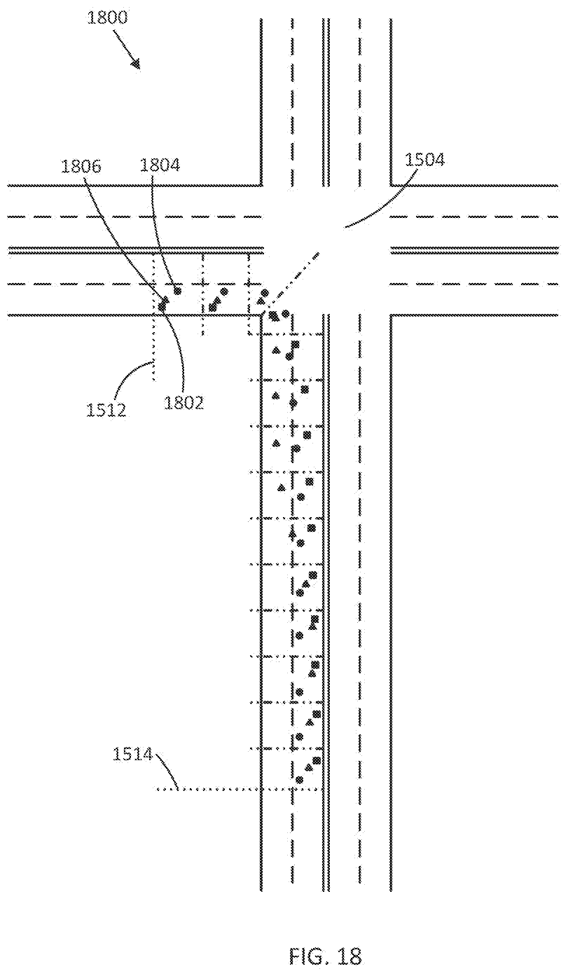

The navigation generation system may sample the clipped trips to produce sample points for aggregating the clipped trips. For example, the navigation generation system may divide the clipped trips into multiple probe segments. The navigation generation system may divide the clipped trips into equally sized probe segments in some embodiments. The navigation generation system may sample each of the clipped trips within the probe segments to produce points to be utilized for generating the path segment. FIG. 18 illustrates an example sampling arrangement 1800 in accordance with some embodiments. In particular, the sampling arrangement 1800 may illustrate sampling performed by the navigation generation system on the clipped trips from the clipped trips arrangement 1700 (FIG. 17).

The sampling arrangement 1800 includes the second decision trigger area 1504. The sampling arrangement 1800 further includes the second checkpoint 1512 and the third checkpoint 1514.

The navigation generation system may separate the area between the intermediate checkpoints into multiple probe segments for sampling. For example, the navigation generation system has separated the area between second checkpoint 1512 and the third checkpoint 1514 into four equally sized probe segments in the illustrated embodiment, as indicated by dashed and dotted lines separating the area between the second checkpoint 1512 and the third checkpoint 1514.

The navigation generation system may sample each of the clipped trips within the probe segments to generate points corresponding to each of the clipped trips within the probe segments. The points produced may be utilized for generating a path segment between the second checkpoint 1512 and the third checkpoint 1514. In the illustrated embodiment, the navigation generation system may generate a first set of points 1802 (shown via squares in the illustrated embodiment) by sampling the first clipped trip 1702 (FIG. 17), a second set of points 1804 (shown via circles in the illustrated embodiment) by sampling the second clipped trip 1704 (FIG. 17), and a third set of points 1806 (shown via triangles in the illustrated embodiment) by sampling the third clipped trip 1706 (FIG. 17). The sampling for a clipped trip within a probe segment may include selecting a probe location of the clipped trip within the probe segment to produce the point corresponding to the clipped trip within the probe segment.

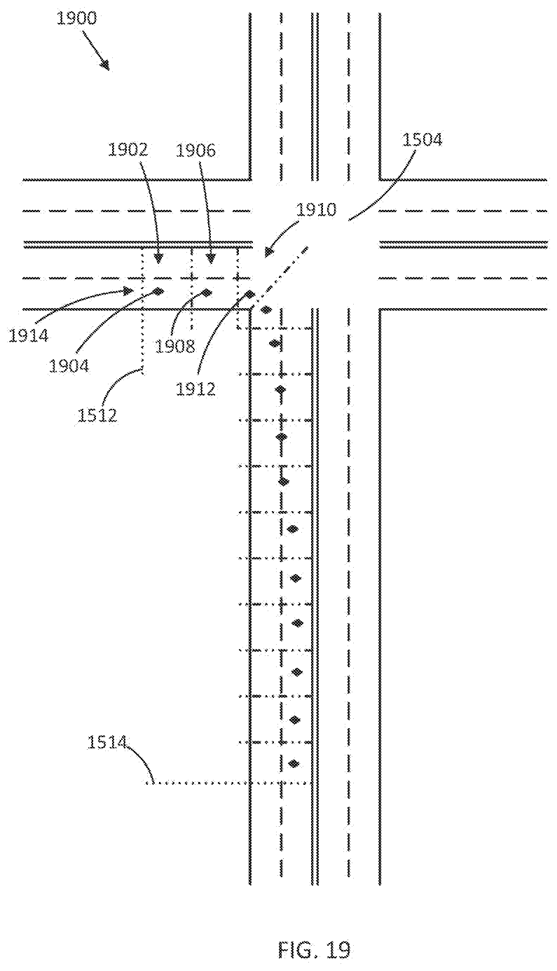

The navigation generation system may aggregate the points generated by the sampling to generate aggregated points for producing the path segment. The aggregating of the points may include the navigation generation system determining geometric medians from the sample points for each of the probe segments to produce the aggregated points. FIG. 19 illustrates an example aggregated points arrangement 1900 in accordance with some embodiments. In particular, the aggregated points arrangement 1900 may illustrate a result of aggregating the sets of points from the sampling arrangement 1800 (FIG. 18) to produce aggregated points.

The aggregated points arrangement 1900 includes the second decision trigger area 1504. The aggregated points arrangement 1900 further includes the second checkpoint 1512 and the third checkpoint 1514. The aggregated points arrangement 1900 further illustrates the probe segments between the second checkpoint 1512 and the third checkpoint 1514.

The navigation generation system may utilize a point from each set of points within a probe segment to determine a geometric median for the probe segment. Further, the navigation generation system may generate an aggregated point for each of the probe segments at the determined geometric median for the probe segment.

For example, the navigation generation system may determine a geometric median for a first probe segment 1902 based on a first point from the first set of points 1810 (FIG. 18), a first point from the second set of points 1812 (FIG. 18), and a first point from the third set of points 1814 (FIG. 18) located within the first probe segment 1902. The navigation generation system may generate a first aggregated point 1904 for the first probe segment 1902 at the determined geometric median for the first probe segment 1902. The navigation generation system may determine a geometric median for a second probe segment 1906 based on a second point from the first set of points 1810, a second point from the second set of points 1812, and a second point from the third set of points 1814 located within the second probe segment 1906. The navigation generation system may generate a second aggregated point 1908 for the second probe segment 1906. The navigation generation system may determine a geometric median for a third probe segment 1910 based on a third point from the first set of points 1810, a third point from the second set of points 1812, and a third point from the third set of points 1814 located within the third probe segment 1910. The navigation generation system may generate a third aggregated point 1912 for the third probe segment 1910. The navigation generation system may continue to determine the geometric medians and generate the aggregated points for the remaining probe segments between the second checkpoint 1512 and the third checkpoint 1514 to produce a set of aggregated points 1914 (shown via diamonds in the illustrated embodiment) including the first aggregated point 1904, the second aggregated point 1908, and the third aggregated point 1912.

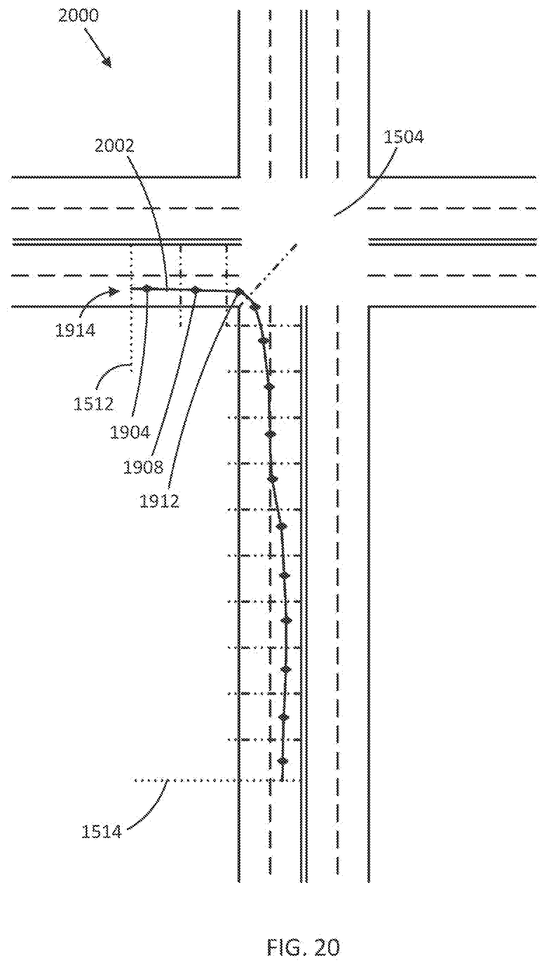

The navigation generation system may generate a path segment between the intermediate checkpoints, where the path passes through or close to the aggregated points. FIG. 20 illustrates an example segment path arrangement 2000 in accordance with some embodiments. In particular, the segment path arrangement 2000 may illustrate a path segment generated based on the aggregated points from the aggregated points arrangement 1900 (FIG. 19).

The segment path arrangement 2000 includes the second decision trigger area 1504. The segment path arrangement 2000 further includes the second checkpoint 1512 and the third checkpoint 1514. Further, the segment path arrangement 2000 includes the set of aggregated points 1914.

The navigation generation system may generate a path segment 2002 from the second checkpoint 1512 to the third checkpoint 1514. The path segment 2002 may pass through the aggregated points of the set of aggregated points 1914, including the first aggregated point 1904, the second aggregated point 1908, and the third aggregated point 1912. As the aggregated points are generated based on the first probe trip 1602, the second probe trip 1604, and the third probe trip 1606, the path segment 2002 may be generated based on the plurality of probe trips. The navigation generation system may generate the path segment 2002 to be a smooth curve between the second checkpoint 1512 and the third checkpoint 1514. In some embodiments, the path segment 2002 may further be generated based on a third path segment between the first checkpoint 1510 (FIG. 15) and the second checkpoint 1512, and/or a fourth path segment between the third checkpoint 1514 and the fourth checkpoint 1516 (FIG. 15). In instances where the positions of the aggregated points would not allow for a curve passing through the aggregated points to meet a predefined smoothness threshold, the navigation generation system may generate a curve that meets the predefined smoothness threshold and limits the distance between the curve and the aggregated points. The navigation generation system may store the path segment 2002 to be utilized for generating direction paths that pass through the second decision trigger area 1504.

The described procedure for generating the path segment may be utilized for generating other path segments along the road system. For example, the navigation generation system may identify another quadruple of checkpoints that includes a checkpoint adjacent to the first checkpoint 1510 (FIG. 15) along the road system, the first checkpoint 1510, the second checkpoint 1512 (FIG. 15), and the third checkpoint 1514 (FIG. 15). In this instance, the first checkpoint 1510 may be the first, intermediate checkpoint and the second checkpoint 1512 may be the second intermediate checkpoint. The navigation generation system may then apply the procedure to generate a path segment from the first checkpoint 1510 to the second checkpoint 1512.

In some embodiments, the navigation generation system may determine whether a probe trip is to be utilized for generating a path segment and/or whether a path segment is to be stored based the location and/or shape of the probe trip and/or the path segment. For example, the navigation generation system may determine whether to utilize a probe trip and/or store a path segment based on a tortuosity of the probe trip and/or the path segment in some embodiments.

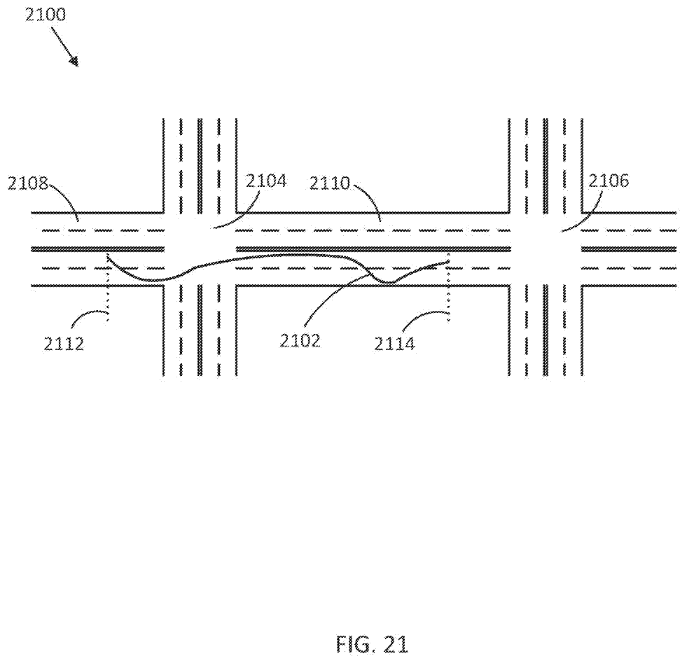

FIG. 21 illustrates an example road system arrangement 2100 in accordance with some embodiments. The road system arrangement 2100 illustrates a portion of a road system with a line segment 2102 that can be utilized for determine whether a probe trip is to be utilized and/or a path segment is to be stored. The line segment 2102 may be a probe trip or a path segment in different instances.

The road system arrangement 2100 includes a first decision trigger area 2104 and a second decision trigger area 2106. Further, the road system arrangement 2100 includes a first road segment 2108 that connects to the first decision trigger area 2104 and a second road segment 2110 that extends between the first decision trigger area 2104 and the second decision trigger area 2106. The road system arrangement 2100 further includes a first checkpoint 2112 and a second checkpoint 2114. The navigation generation system may have determined the first checkpoint 2112 based on the first decision trigger area 2104 and the second checkpoint 2114 based on the second decision trigger area 2106.

The line segment 2102 may extend between the first checkpoint 2112 and the second checkpoint 2114. The navigation generation system may determine a measurement of the tortuosity of the line segment 2102. Further, the navigation generation system may determine the tortuosity of a portion of the road system corresponding to the line segment 2102. In particular, the navigation generation system may determine the tortuosity from the first checkpoint 2112 to the second checkpoint 2114 including the portion of the first road segment 2108 and the portion of the second road segment 2110 located between the first checkpoint 2112 and the second checkpoint 2114.

The navigation generation system may compare the tortuosity of the line segment 2102 with the tortuosity of the portion of the road system corresponding to the line segment 2102. The navigation generation system may determine an amount of difference between the tortuosity of the line segment 2102 and the corresponding portion of the road system. The navigation generation system may have a predefined tortuosity difference threshold. The navigation generation system may compare the difference between the tortuosity of the line segment 2102 and the corresponding portion of the road system with the tortuosity difference threshold. If the navigation generation system determines that the tortuosity exceeds the tortuosity difference threshold, the navigation generation system may determine that the probe trip corresponding to the line segment 2102 is not to be utilized or the path segment corresponding to the line segment 2102 is not to be stored. If the navigation generation system determines that the tortuosity is within the tortuosity difference threshold, the navigation generation system may determine that the probe trip corresponding to the line segment 2102 is to be utilized or the path segment corresponding to the line segment is to be stored.

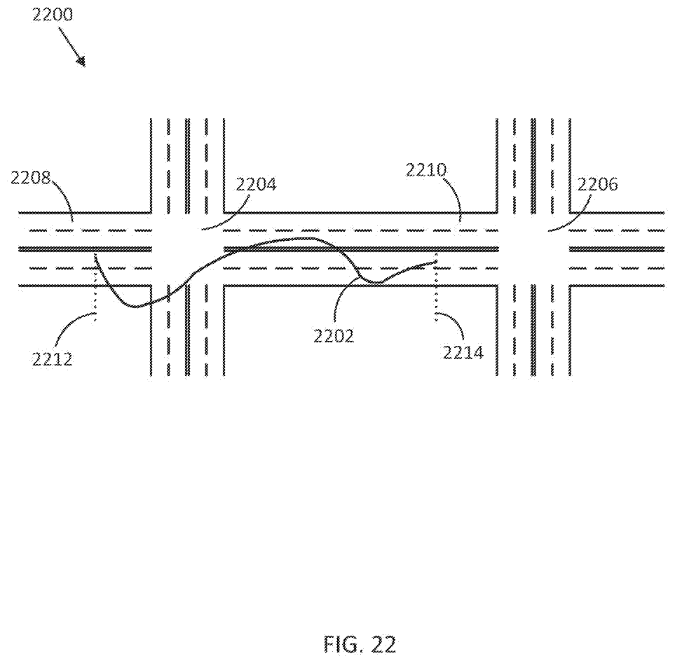

In some embodiments, the navigation generation system may determine whether to utilize a probe trip and/or store a path segment based on a location of the probe trip and/or the path segment. FIG. 22 illustrates an example road system arrangement 2200 in accordance with some embodiments. The road system arrangement 2200 illustrates a portion of a road system with a line segment 2202 that can be utilized for determine whether a probe trip is to be utilized and/or a path segment is to be stored. The line segment 2202 may be a probe trip or a path segment in different instances.

The road system arrangement 2200 includes a first decision trigger area 2204 and a second decision trigger area 2206. Further, the road system arrangement 2200 includes a first road segment 2208 that connects to the first decision trigger area 2204 and a second road segment 2210 that extends between the first decision trigger area 2204 and the second decision trigger area 2206. The road system arrangement 2200 further includes a first checkpoint 2212 and a second checkpoint 2214. The navigation generation system may have determined the first checkpoint 2212 based on the first decision trigger area 2204 and the second checkpoint 2214 based on the second decision trigger area 2206.

The line segment 2202 may extend between the first checkpoint 2212 and the second checkpoint 2214. The navigation generation system may identify the location of the line segment 2202. Further, the navigation generation system may determine the boundaries of a portion of the road system corresponding to the line segment 2022. For example, the navigation generation system may determine the boundaries from the first checkpoint 2212 to the second checkpoint 2214 in the illustrated embodiment, including the boundaries of the first road segment 2208, the first decision trigger area 2204, and the second road segment 2210.

The navigation generation system may compare the boundaries of the portion of the road system with the location of the line segment 2202. If the navigation generation system determines that a portion of the line segment 2202 is located outside of the boundaries of the portion of the road system, the navigation generation system may determine that the probe trip corresponding to the line segment 2202 is not to be utilized or the path segment corresponding to the line segment 2202 is not to be stored. If the navigation generation system determines that the line segment 2202 is located within the boundaries of the portion of the road system, the navigation generation system may determine that the probe trip corresponding to the line segment 2202 is to be utilized or the path segment corresponding to the line segment is to be stored.

The navigation generation system may repeat the procedure for generating path segments for a road system. For example, the navigation generation system may identify decision trigger areas of the road system and generate path segments based on the decision trigger areas. The navigation generation system may store the generated paths to be utilized for generating direction paths,

### Direction Path Generation

A navigation generation system (such as the navigation generation system 102 (FIG. 1)) may receive requests from computing devices (such as the user device 112 (FIG. 1) and/or the user device 202 (FIG. 2)) for directions between locations. The navigation generation system may utilize the path segments generated for the road system to generate direction paths between the locations. The navigation generation system may cause the computing devices to display portions of the direction paths to direct users of the computing devices between the requested locations.

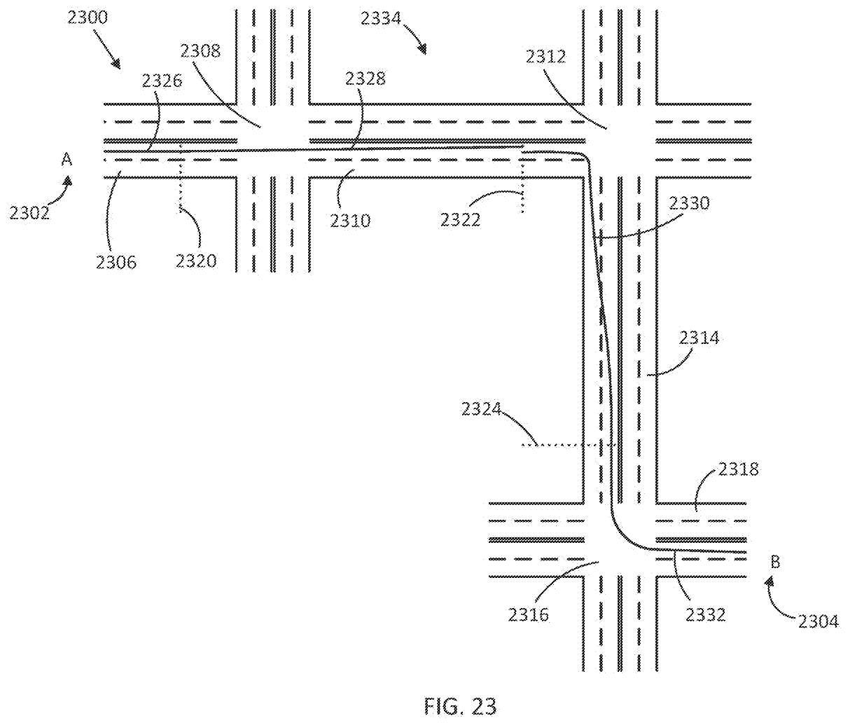

FIG. 23 illustrates an example direction path generation arrangement 2300 in accordance with some embodiments. For example, the direction path generation arrangement 2300 illustrates path segments that the navigation generation system may retrieve for generating a direction path from a location ‘A’ to a location ‘B.’

The navigation generation system may receive a request from a user device for directions from a location ‘A’ 2302 to a location ‘B’ 2304. The navigation generation system may request a high fidelity map from a map store (such as the high fidelity map database 108 (FIG. 1) and/or the map store 206 (FIG. 2) that includes the location ‘A’ 2302 and the location ‘B’ 2304. The navigation generation system may receive a high fidelity map 2334 that includes the location ‘A’ 2302 and the location ‘B’ 2304.

The navigation generation system may determine a direction route via the road system from location ‘A’ 2302 to location ‘B’ 2304. For example, the navigation generation system may determine that a direction route including a first road segment 2306, a first decision trigger area 2308, a second road segment 2310, a second decision trigger area 2312, a third road segment 2314, a third decision trigger area 2316, and a fourth road segment 2318 from location ‘A’ 2302 to location ‘B’ 2304. The navigation generation system may determine the direction route based on a defined criteria, such as a shortest distance from location ‘A’ 2302 to location ‘B’ 2304, a shortest travel time from location ‘A’ 2302 to the location ‘B’ 2304, a lowest fuel usage amount of traveling from location ‘A’ 2302 to location ‘B’ 2304, and/or other criteria known in the art for determining direction routes.

In some embodiments, the navigation generation system may determine checkpoints for the determined direction routes. In the illustrated embodiment, the navigation generation system may determine the single checkpoints per connection point prior to the decision trigger areas for determining the checkpoints. In other embodiments, the other approaches for determining the checkpoints described throughout this disclosure may be utilized for the determining the checkpoints. In the illustrated embodiments, the navigation generation system may determine a first checkpoint 2320 corresponding to the first decision trigger area 2308, a second checkpoint 2322 corresponding to the second decision trigger area 2312, and a third checkpoint 2324 corresponding to the third decision trigger area 2316.

The navigation generation system may determine path segment corresponding to the direction route. In instances where the navigation generation system determines checkpoints, the navigation generation system may determine path segments associated with the checkpoints. For example, the navigation generation system may determine a first path segment 2326 to the first checkpoint 2320, a second path segment 2328 from the first checkpoint 2320 to the second checkpoint 2322, a third path segment 2330 from the second checkpoint 2322 to the third checkpoint 2324, and a fourth path segment 2332 from the third checkpoint 2324.

In instance where the navigation generation system did not determine the checkpoints, the navigation generation system may determine the path segments based the determined direction route. For example, the navigation generation system may determine path segments corresponding to the direction route. In particular, the navigation generation system may identify the first path segment 2326, the second path segment 2328, the third path segment 2330, and the fourth path segment 2332 based on the path segments being along the direction route.

In instances where the navigation generation system does not have a path segment stored corresponding to a portion of the direction route, the navigation generation system may produce a generic path segment for the portion of the direction route. The generic path segment may connect to the path segments on either side of the portion of the direction route. The navigation generation system may produce the generic path segment to be a straight connection between the path segments on either side of the portion, or to be gently curved connection between the path segments on either side of the portion. For example, if the navigation generation system does not have a path segment stored from the first checkpoint 2320 to the second checkpoint 2322, the navigation generation system may generate a path segment between the first checkpoint 2320 and the second checkpoint 2322 that connects the first path segment 2326 and the third path segment 2330.

The navigation generation system may connect the path segments together to generate a direction path from location ‘A’ 2302 to location ‘B’ 2304. In some instances, adjacent path segments may meet at an intersection area between the path segments. For example, the intersection area may be at a checkpoint where one path segment ends and another path segment begins. For example, a location of the first checkpoint 2320 may form an intersection area between the first road segment 2306 and the second road segment 2310. In the illustrated embodiment, the first road segment 2306 and the second road segment 2310 may meet at the intersection area. The navigation generation system may merge the first road segment 2306 and the second road segment 2310 by connecting the first road segment 2306 and the second road segment 2310 at the intersection area as part of generating the direction path.

In other instances, adjacent path segments may not meet at an intersection area. For example, a location of the second checkpoint 2322 may form an intersection area between the second road segment 2310 and the third road segment 2314. As can be seen from the illustrated embodiment, the second road segment 2310 and the third road segment 2314 do not meet at intersection area at the second checkpoint 2322.

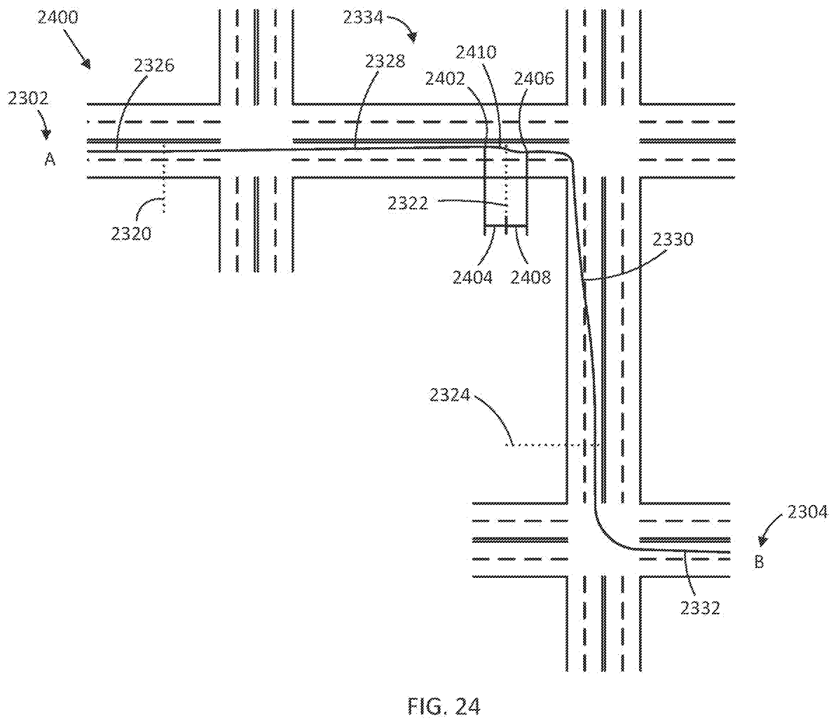

In the instances where the adjacent path segments do not meet in the intersection area between the adjacent path segments, the navigation generation system may generate a smooth connection between the adjacent path segments. FIG. 24 illustrates an example path merging arrangement 2400 in accordance with some embodiments. In particular, the path merging arrangement 2400 can illustrate path merging of path segments from the direction path generation arrangement 2300 (FIG. 23) that do not meet at an intersection area.

The path merging arrangement 2400 may include the map 2334. The path merging arrangement 2400 may further include the first checkpoint 2320, the second checkpoint 2322, and the third checkpoint 2324. Further, the path merging arrangement 2400 may include the first path segment 2326, the second path segment 2328, the third path segment 2330, and the fourth path segment 2332.

The navigation generation system may perform a merging between the second path segment 2328 and the third path segment 2330. As can be seen from the direction path generation arrangement 2300, the original second path segment 2328 and the original third path segment 2330 do not meet at the intersection area corresponding to the second checkpoint 2322. The navigation generation system may determine a first point 2402 along the second path segment 2328 located a first distance 2404 from the intersection area located at the second checkpoint 2322. The navigation generation system may additionally determine a second point 2406 along the third path segment 2330 located at a second distance 2408 from the intersection area located at the second checkpoint 2322. The navigation generation system may generate a smooth curve 2410 between the first point 2402 and the second point 2406. The navigation generation system may replace the portions of the second path segment 2328 and the third path segment 2330 with the smooth curve 2410 to connect the second path segment 2328 and the third path segment 2330.

The navigation generation system may perform the merging of path segments for any the path segments that do not meet at the corresponding intersection areas. Based on the merging of path segments, the navigation generation system may produce a continuous direction path from location ‘A’ 2302 to location ‘B’ 2304. In the illustrated embodiments, the direction path includes the connected first path segment 2326, the second path segment 2328, the third path segment 2330, and the fourth path segment 2332 as shown in the path merging arrangement 240).

The navigation generation system may utilize the generated direction path to provide representations of portions of the direction path to the computing device that requested the directions. For example, the navigation generation system may determine a location of the computing device in some embodiments, such as by receiving communications from computing device that indicates the location of the computing device. The navigation generation system may determine portions of the direction path which the computing device is approaching based on the location of the computing device. The navigation generation system may provide representations of the portions of the direction path that the computing device is approaching, where the computing device may utilize the representations of the portions of the direction path to display indications of the direction path on the computing device to provide directions to the user of the computing device. In some embodiments, the navigation generation system may provide the entire direction path to the computing device after generation of the direction path and the computing device may determine when to display indications of the portion of the direction paths for directions.

The direction paths being generated on the high fidelity map may provide details regarding the direction path that cannot be provided on a low fidelity map, such as a lane in which direction path is located, a portion of the road system which the direction path traverses, and/or other details that cannot be represented on low fidelity maps. The representations of portions of the direction path provided by the navigation generation system may include the details. When the computing device displays the indications of the direction path, the displayed indications may provide the details.

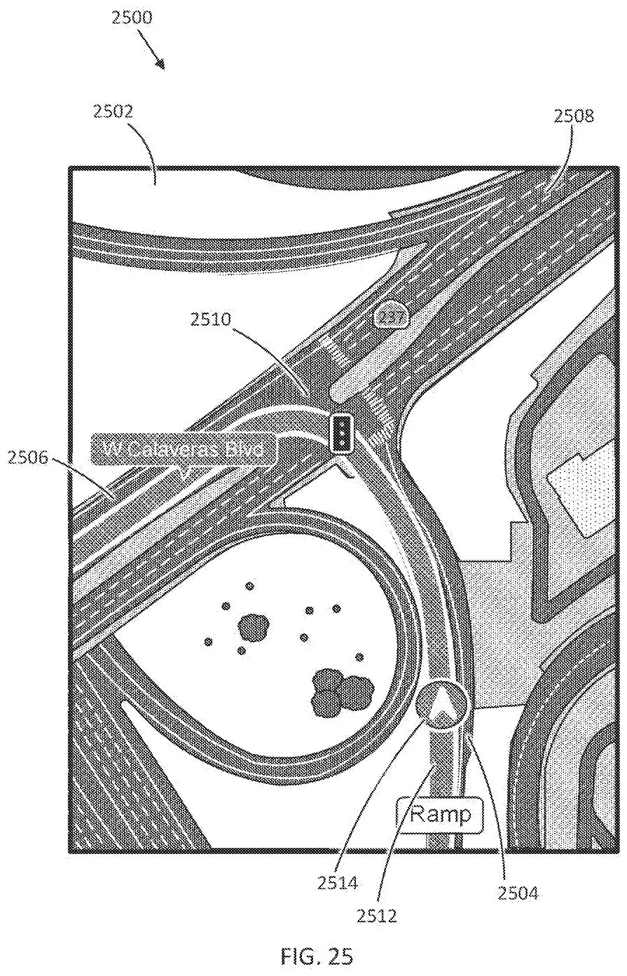

FIG. 25 illustrates an example display interface 2500 that may be displayed by a computing device in accordance with some embodiments. For example, the computing device may display the display interface 2500 on a display of the computing device based on the representations of a direction path or portions of a direction path provided by the navigation generation system.

The display interface 2500 may include a portion of a high fidelity map 2502. The high fidelity map 2502, or portion thereof, may be provided by the navigation generation system. In the illustrated embodiments, the high fidelity map 2502 includes a first road segment 2504, a second road segment 2506, and a third road segment 2508. Further, the high fidelity map 2502 further includes a decision trigger area 2510, which is an intersection where the first road segment 2504, the second road segment 2506, and the third road segment 2508 meet. The high fidelity map 2502 may show the lane indicators of the road segments, the crosswalks related to the decision trigger area 2510, elements surrounding the road system, and/or other details not shown in low fidelity maps.

The display interface 2500 may include an indication of a portion of a direction path 2512 provided by the navigation generation system. In particular, the display interface 2500 includes a line that indicates the direction path 2512 and an arrow symbol 2514 that indicates a determined location of the computing device as the computing device travels the direction path 2512. The portion of the direction path 2512 illustrates directions for travel from the first road segment 2504, taking a left turn through the decision trigger area 2510, and continuing down the second road segment 2506. The direction path 2512 illustrates portions of the road system suggested to be traveled based on the probe data utilized for generating the direction path. For example, the direction path 2512 is shown as extending down a left portion of the first road segment 2504 and is shown extending down the left lanes of the second road segment 2506. The location of the direction path 2512 toward the left portion of the first road segment 2504 and in the left lanes of the second road segment 2506 may indicate that the direction path 2512 suggests traveling down the left portion of the first mad segment 2504 and in the left lanes of the second road segment 2506 based on the probe data utilized for generating the direction path 2512.

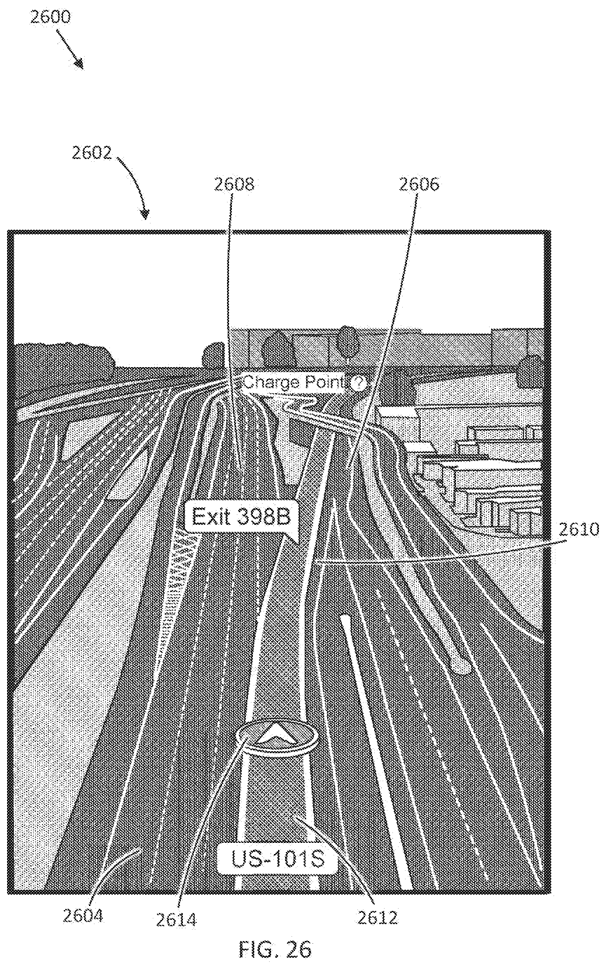

FIG. 26 illustrates another example display interface 2600 that may be displayed by a computing device in accordance with some embodiments. For example, the computing device may display the display interface 2600 on a display of the computing device based on the representations of a direction path or portions of a direction path provided by the navigation generation system.

The display interface 2600 may include a portion of a high fidelity map 2602. The high fidelity map 2602, or portion thereof, may be provided by the navigation generation system. In the illustrated embodiments, the high fidelity map 2602 includes a first road segment 2604, a second road segment 2606, and a third road segment 2608. Further, the high fidelity map 2602 further includes a decision trigger area 2610, which is a roadway exit where the first road segment 2604 includes a portion of a freeway leading up to the roadway exits, the third road segment 2608 includes another portion of freeway extending past the decision trigger area 2610, and the roadway exit provides for an exit from the first road segment 2604 to the second road segment. The high fidelity map 2602 may show the lane indicators of the mad segments, divider indicators related to the road system, elements surrounding the road system, and/or other details not shown in low fidelity maps.

The display interface 2600 may include an indication of a portion of a direction path 2612 provided by the navigation generation system. In particular, the display interface 2600 includes a line that indicates the direction path 2612 and an arrow symbol 2614 that indicates a determined location of the computing device as the computing device travels the direction path 2612. The portion of the direction path 2612 illustrates directions for travel from the first road segment 2604, taking the exit provided by the decision trigger area 2610, and continuing down the second road segment 2606. The direction path 2612 illustrates portions of the road system suggested to be traveled based on the probe data utilized for generating the direction path. For example, the direction path 2612 is shown extending down the right lane of the first road segment 2604 and traveling down the left portion of the decision trigger area 2610 and the second mad segment 2606. The location of the direction path 2612 down the right lane of the first road segment 2604 and the left portion of the decision trigger area 2610 may indicate that the direction path 2612 suggests traveling down the right lane of the first road segment 2604 and down the left portion of the decision trigger area 2610 and the second mad segment 2606 based on the probe data utilized for generating the direction path.

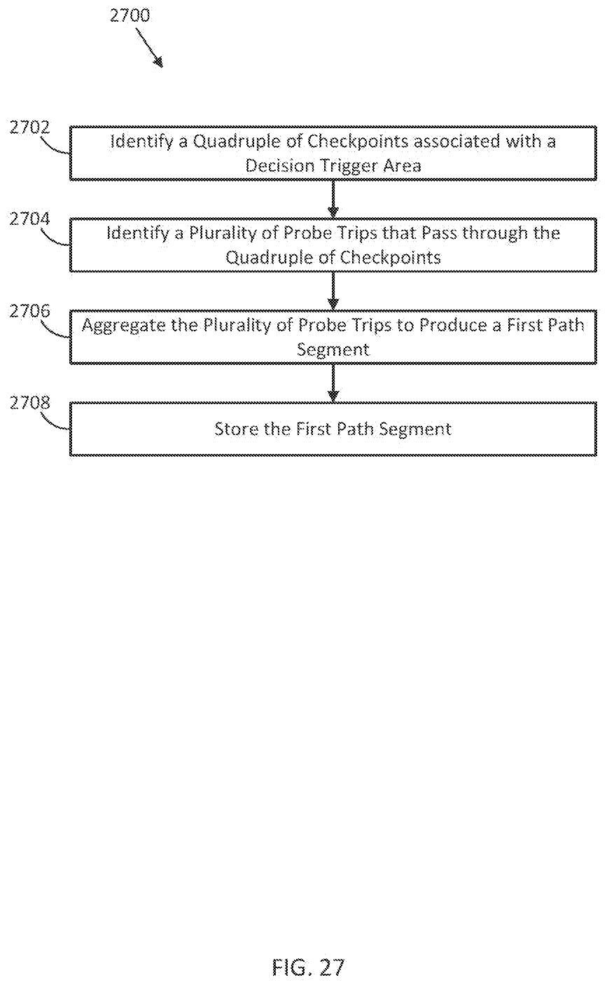

FIGS. 27, 28, 29, 30, 31, and 32 illustrate example flow diagrams showing respective processes 2700, 2800, 2900, 3000.3100, and 3200, as described herein. The processes 2700, 2800, 2900, 3000, 3100, and 3200, are illustrated as logical flow diagrams, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be omitted or combined in any order and/or in parallel to implement the processes.

Additionally, some, any, or all of the processes may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable storage medium, for example, in the form of a computer program comprising a plurality of instructions executable by one or more processors. The computer-readable storage medium is non-transitory.

FIG. 27 illustrates a diagram showing a flow chart corresponding to an example process 2700 for generating a path segment to be utilized for production of direction paths in accordance with some embodiments. The process 2700 may be implemented by a navigation generation system (such as the navigation generation system 102 (FIG. 1)), a system arrangement (such as the system arrangement 200 (FIG. 2)) or portion thereof, and/or a service provider computer (such as the service provider computer 3502 (FIG. 35)). The process 2700 is described herein as being performed by a navigation generation system, although it should be understood that a system arrangement (or portion thereof) or service provider computer may perform the operations in other embodiments. The process 2700 may result in one or more technical improvements including, for example, an accurate and detailed direction path to be displayed on a high fidelity map.

The process 2700 begins at block 2702 by the navigation generation system identifying a quadruple of checkpoints associated with a decision trigger area. In some embodiments, the decision trigger area may include a roadway intersection, a roadway exit, a roadway lane merge, a roadway lane split, or a roadway obstruction of a road system. The quadruple of checkpoints may include an entry checkpoint, a first intermediate checkpoint, a second intermediate checkpoint, and an exit checkpoint.

In some embodiments, the entry checkpoint may be located at a first predefined distance from an entrance of the decision trigger area. Further, the exit checkpoint may be located at a second predefined distance, from an exit of the decision trigger area in some embodiments. The first predefined distance may depend on a first classification of a first road segment connected to the entrance of the decision trigger area and the second predefined distance may depend on a second classification of a second road segment connected to the exit of the decision trigger area. In some embodiments, the first intermediate checkpoint may be located within the decision trigger area at a first predefined distance from an entrance of the decision trigger area. Further, the second intermediate checkpoint may be located within the decision trigger area at a second predefined distance from an exit of the decision trigger area.

In some embodiments, the process 2700 may further include identifying the decision trigger area of a road system. The navigation generation system may determine that, the entry checkpoint is located along the road system outside of the decision trigger area at a first predefined distance from an entry of the decision trigger area. Further, the navigation generation system may determine that the first intermediate checkpoint is located along the road system within the decision trigger area at a second predefined distance from the entry of the decision trigger area. The navigation generation system may determine that the second intermediate checkpoint is located along the road system within the decision trigger area at a third predefined distance from an exit of the decision trigger area. Further, the navigation generation system may determine that the exit checkpoint is located along the road system outside of the decision trigger area at a fourth predefined distance from the exit of the decision trigger area.

At block 2704, the process 2700 includes the navigation generation system identifying a plurality of probe trips that pass through the quadruple of checkpoints. In some embodiments, the process 2700 may further include map matching the plurality of probe trips to a map representation, where identifying the plurality of probe trips includes identifying the plurality of probe trips that have been map matched to the map representation. In some of these embodiments, the map representation may be first map representation.

At block 2706, the process 2700 includes the navigation generation system aggregating the plurality of probe trips to produce a first path segment between the first intermediate checkpoint and the second intermediate checkpoint based on a portion of the plurality of probe trips, a second path segment between the entry checkpoint and the first intermediate checkpoint, and a third path segment between the second intermediate checkpoint and the exit checkpoint.

In some embodiments, aggregating the plurality of probe trips may include dividing an area between the first intermediate checkpoint and the second intermediate checkpoint into multiple probe segments. Further, aggregating the plurality of probe trips may include sampling each of the multiple probe segments to acquire points from the plurality of probe trips within each of the multiple probe segments. Aggregating the plurality of probe trips may include determining geometric medians for each of the multiple probe segments based at least in part on the points from the plurality of probe trips. Further, aggregating the plurality of probe trips may include producing the first path segment based at least in part on the geometric medians for each of the multiple probe segments.

At block 2708, the process 2700 includes the navigation generation system storing the first path segment to be utilized for production of direction paths. In some embodiments, the direction paths produced are to be displayed on a second map representation. The second map representation may be a higher fidelity representation than the first map representation utilized for map matching.

In some embodiments, the process 2700 may further include the navigation generation system determining a first tortuosity of a segment of a road system from the first intermediate checkpoint to the second intermediate checkpoint and determining a second tortuosity of the first path segment. The navigation generation system may compare the first tortuosity and the second tortuosity. The first path segment may be stored based on the second tortuosity being within a defined threshold of the first tortuosity.

In some embodiments, the process 2700 may further include the navigation generation system determining a tortuosity of the first path segment. Further, the navigation generation system may determine that, the tortuosity is within a tortuosity threshold. The first path segment may be stored based at least in part on the tortuosity being within the tortuosity threshold.

In some embodiments, the process 2700 may further include the navigation generation system receiving a request for a direction route from a first location to a second location. Further, the navigation generation system, may determine that the entry checkpoint, the first intermediate checkpoint, the second intermediate checkpoint, and the exit checkpoint are along the direction route. The navigation generation system may utilize the first path segment to produce a direction path for the direction route. The direction path may be utilized to provide directions from the first location to the second location.

In some embodiments, the request for the direction route is received from a device. The navigation generation system may provide at least a portion of the direction path to the device for display by the device.

In some embodiments, utilizing the first path segment to produce the direction path may include merging the first path segment with a fourth path segment located adjacent to the first path segment to produce the direction path. Further, merging the first path segment with the fourth path segment comprises generating a smooth connection between a first point on the first path segment located a distance from an intersection area between the first path segment and the second path segment and a second point on the second path segment located the distance from the intersection area.

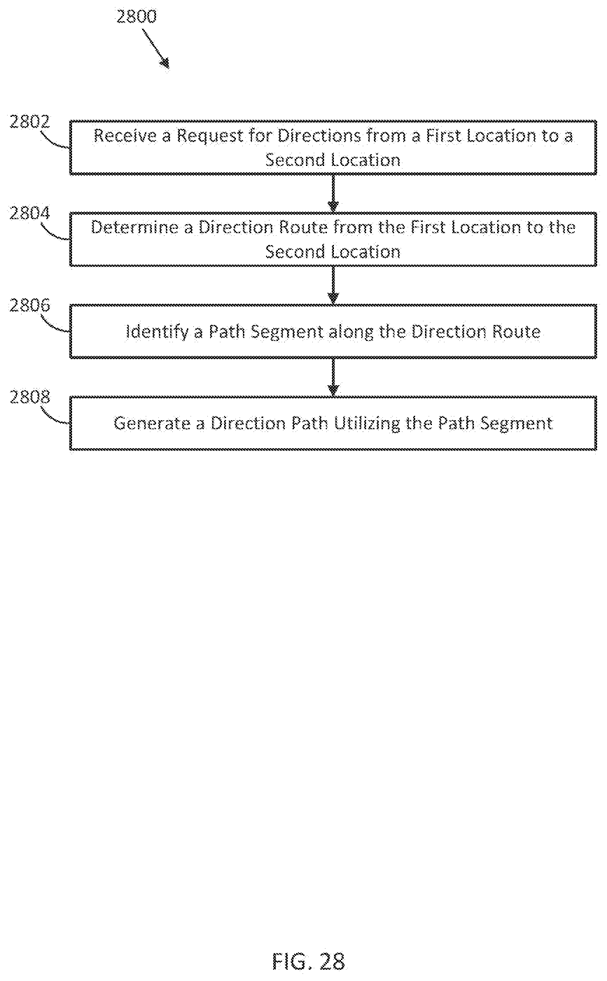

FIG. 28 is a diagram showing a flow chart corresponding to an example process 2800 for generating a direction path utilizing a path segment in accordance with some embodiments. The process 2800 may be implemented by a navigation generation system (such as the navigation generation system 102 (FIG. 1)), a system arrangement (such as the system arrangement 200 (FIG. 2)) or portion thereof, and/or a service provider computer (such as the service provider computer 3502 (FIG. 35)). The process 2800 is described herein as being performed by a navigation generation system, although it should be understood that a system arrangement for portion thereof) or a service provider computer may perform the operations in other embodiments. The process 2800 may result in one or more technical improvements including, for example, an accurate and detailed direction path to be displayed on a high fidelity map.

The process 2800 begins at block 2802 by the navigation generation system receiving a request for directions from a first location to a second location along a road system. In some embodiments, the request for directions may be received from a device.

At block 2804, the process 2800 includes the navigation generation system determining a direction route from the first location to the second location.

At block 2806, the process 2800 includes the navigation generation system identifying a path segment along the direction route. The path segment may be generated based at least in part on a portion of a plurality of probe trips that pass through a quadruple of checkpoints associated with a decision trigger area. The quadruple of checkpoints may include an entry checkpoint, a first intermediate checkpoint, a second intermediate checkpoint, and an exit checkpoint.

In some embodiments, the path segment may be a first path segment. The first path segment may be between the first intermediate checkpoint and the second intermediate checkpoint. The first path segment may be generated based further on a second path segment between the entry checkpoint and the first intermediate checkpoint, and a third path segment between the second intermediate checkpoint and the exit checkpoint.

In some embodiments, the process 2800 may include the navigation generation system identifying the entry checkpoint, the first intermediate checkpoint, the second intermediate checkpoint, and the exit checkpoint. Further, the navigation generation system may identify the plurality of probe trips from the entry checkpoint to the exit checkpoint that pass through the first intermediate checkpoint and the second intermediate checkpoint. The navigation generation system may aggregate the plurality of probe trips to produce the path segment. Further, the navigation generation system may store the path segment to be utilized for production of direction paths.

In some embodiments, aggregating the plurality of probe trips may include dividing an area between the first intermediate checkpoint and the second intermediate checkpoint into multiple probe segments. Further, aggregating the plurality of probe trips may include sampling each of the multiple probe segments to acquire points from the plurality of probe trips within each of the multiple probe segments. Aggregating the plurality of probe trips may include determining geometric medians for each of the multiple probe segments based at least in part on the points from the plurality of probe trips. Further, aggregating the plurality of probe trips may include producing the path segment based at least in part on the geometric medians for each of the multiple probe segments.

In some embodiments, the process 2800 may include the navigation generation system identifying the decision trigger area of a road system along the direction route. Further, identifying the entry checkpoint may include determining that the entry checkpoint is located along the road system outside of the decision trigger area at a first predefined distance from an entry of the decision trigger area. Identifying the first intermediate checkpoint may include determining that the first intermediate checkpoint is located along the road system within the decision trigger area at a second predefined distance from the entry of the decision trigger area. Further, identifying the second intermediate checkpoint comprises determining that the second intermediate checkpoint is located along the road system within the decision trigger area at a third predefined distance from an exit of the decision trigger area. Identifying the exit checkpoint comprises determining that the exit checkpoint is located along the road system outside of the decision trigger area at a fourth predefined distance from the exit of the decision trigger area.

At block 2808, the process 2800 includes the navigation generation system generating a direction path utilizing the path segment, the direction path to be utilized to provide directions from the first location to the second location.

In some embodiments, generating the direction path may include identifying a second path segment. The second path segment may be located adjacent to the first path segment along the direction route. In some of these embodiments, the plurality of probe trips may include a first plurality of probe trips and the second path segment may be generated based at least in part on a portion of a second plurality of probe trips corresponding to a second quadruple of checkpoints. Further, generating the direction path may include merging the first path segment with the second path segment. In some of these embodiments, merging the first path segment with the second path segment may include generating a smooth connection between a first point on the first path segment located a distance from an intersection area between the first path segment and the second path segment and a second point on the second path segment located the distance from the intersection area.

In some embodiments, the process 2800 may include the navigation generation system providing at least a portion of the direction path to a device for display by the device based on the request for directions. The device may be a device from which the request for directions is received.

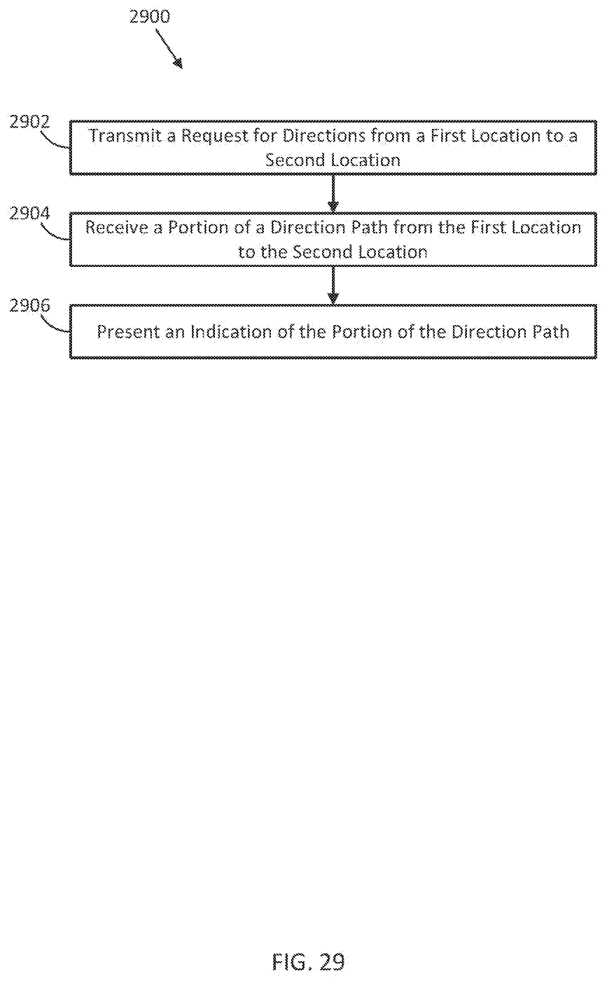

FIG. 29 is a diagram showing a flow chart corresponding to an example process 2900 for presenting an indication of a portion of a direction path in accordance with some embodiments. The process 2900 may be implemented by a user device, such as the user device 112 (FIG. 1), the user device 202 (FIG. 2), the user device 3300 (FIG. 33), and/or the user device 3506 (FIG. 35). The process 2900 may result in one or more technical improvements including, for example, an accurate and detailed direction path to be displayed on a high fidelity map on the user device.

The process 2900 begins at block 2902 by the user device transmitting a request for directions from a first location to a second location along a road system.

At block 2904, the process 2900 includes the user device receiving a portion of a direction path from the first location to the second location. The portion of the direction path may include a path segment generated based at least in part on a plurality of probe trips that pass through a quadruple of checkpoints associated with a decision trigger area. The quadruple of checkpoints may include an entry checkpoint, a first intermediate checkpoint, a second intermediate checkpoint, and an exit checkpoint. In some embodiments, the entry checkpoint is located along the road system outside of the decision trigger area at a distance from an entry of the decision trigger area.

At block 2906, the process 2900 includes the user device presenting an indication of the portion of the direction path, the indication of the portion of the direction path indicating at least one lane of the road system. In some embodiments, the process 2900 may include the user device determining a location of a user device. The process 2900 may further include the user device determining that the location of the device is at the entry checkpoint. Further, the process 2900 may include the user device presenting the indication of the portion of the direction path based at least in part on the location of the device being at the entry checkpoint.

In some embodiments, presenting the indication of the portion of the direction path may include presenting an indication of at least one lane of the road system. Further, presenting the indication of the at least one lane may include displaying a line or arrow indicating the at least one lane in some embodiments. In some embodiments, the indication of the portion of the direction path may indicate a maneuver to be performed corresponding to the decision trigger area.

In some embodiments, the portion of the direction path may include a first portion of the direction path, the plurality of probe trips may include a first plurality of probe trips, and the path segment may include a first path segment. The process 2900 may include the user device receiving a second portion of the direction path in some embodiments. The second portion of the direction path may include a second path segment adjacent to the first path segment. In some embodiments, the process 2900 may include the user device presenting an indication of the portion of the second portion of the direction path,

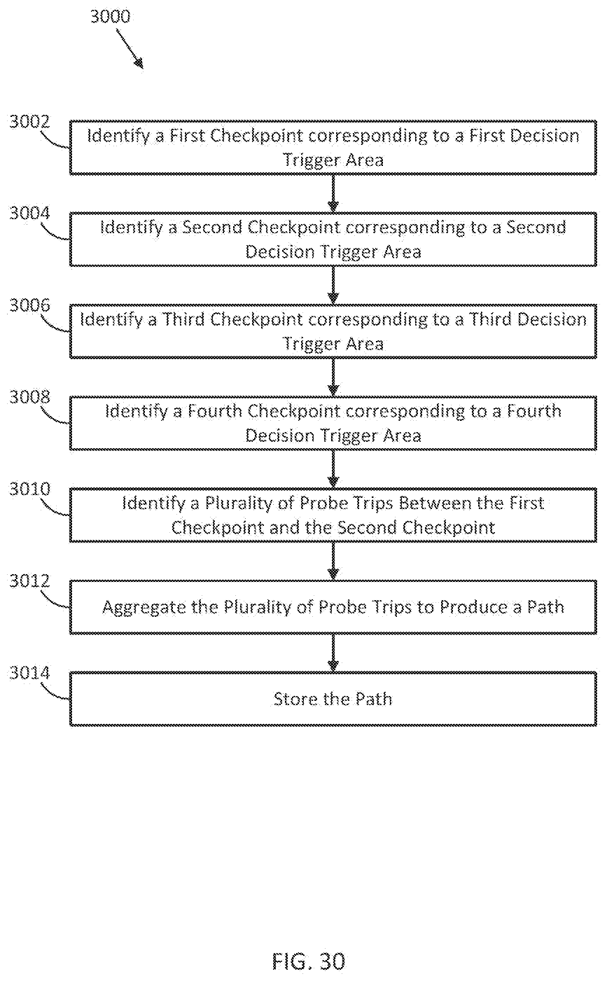

FIG. 30 is a diagram showing a flow chart corresponding to an example process 3010) for producing and storing a path to be utilized for production of direction paths in accordance with some embodiments. The process 3000 may be implemented by a navigation generation system (such as the navigation generation system 102 (FIG. 1)), a system arrangement (such as the system arrangement 200 (FIG. 2)) or portion thereof, and/or a service provider computer (such as the service provider computer 3502 (FIG. 35)). The process 3000 is described herein as being performed by a navigation generation system, although it should be understood that a system arrangement (or portion thereof) or a service provider computer may perform the operations in other embodiments. The process 3000 may result in one or more technical improvements including, for example, an accurate and detailed direction path for a high fidelity map.

The process 3000 begins at block 3002 by the navigation generation system identifying a first checkpoint corresponding to a first decision trigger area of a road system. In some embodiments, identifying the first checkpoint may include identifying the first decision trigger area of the road system. Identifying the first checkpoint may further include determining that the first checkpoint is located at a first predefined distance from the first decision trigger area. In some embodiments, the first decision trigger area may include a first roadway intersection, a first roadway exit, a first roadway lane merge, a first roadway lane split, or a first roadway obstruction of the road system.

At block 3004, the process 3000 includes the navigation generation system identifying a second checkpoint, corresponding to a second decision trigger area of the road system. In some embodiments, identifying the second checkpoint may include identifying the second decision trigger area of the mad system. Identifying the second checkpoint may further include determining that the second checkpoint is located at a second predefined distance from the second decision trigger area. In some embodiments, the second decision trigger area may include a second roadway intersection, a second roadway exit, a second roadway lane merge, a second roadway lane split, or a second roadway obstruction of the road system.

At block 3006, the process 3000 includes the navigation generation system identifying a third checkpoint corresponding to a third decision trigger area of the road system. In some embodiments, identifying the third checkpoint may include identifying the third decision trigger area of the road system. Identifying the third checkpoint may further include determining that the third checkpoint is located at a third predefined distance from the third decision trigger area. In some embodiments, the third decision trigger area may include a third roadway intersection, a third roadway exit, a third roadway lane merge, a third roadway lane split, or a third roadway obstruction of the road system.

At block 3008, the process 3000 includes the navigation generation system identifying a fourth checkpoint corresponding to a fourth decision trigger area. In some embodiments, identifying the fourth checkpoint may include identifying the fourth decision trigger area of the road system. Identifying the fourth checkpoint may further include determining that the fourth checkpoint is located at a fourth predefined distance from the fourth decision trigger area. In some embodiments, the fourth decision trigger area may include a fourth roadway intersection, a fourth roadway exit, a fourth roadway lane merge, a fourth roadway lane split, or a fourth roadway obstruction of the road system.

In some embodiments, the third decision trigger area and the fourth decision trigger area may be a same trigger area. The third checkpoint may be located at a first predefined distance from an entrance of the of the third decision trigger area. The fourth checkpoint is located at a second predefined distance from an exit of the third decision trigger area.

At block 3010, the process 3000 includes the navigation generation system identifying a plurality of probe trips between the first checkpoint to the second checkpoint that pass through the third checkpoint and the fourth checkpoint.

In some embodiments, the process 3000 may include the navigation generation system map matching the plurality of probe trips to a map representation. The map representation may be a first map representation. In some of these embodiments, identifying the plurality of probe trips may include identifying the plurality of probe trips that have been map matched to the map representation.

At block 3012, the process 3000 includes the navigation generation system aggregating the plurality of probe trips to produce a path between the third checkpoint and the fourth checkpoint. In some embodiments, a route along the road system may be defined from the third checkpoint to the fourth checkpoint. Further, aggregating the plurality of probe trips may include dividing the route into multiple route segments and sampling each of the multiple route segments to acquire points from each of the plurality of probe trips within each of the multiple route segments. In some embodiments, aggregating the plurality of probe trips may include determining geometric medians for each of the multiple route segments based at least in part on the points from each of plurality of probe trips. Aggregating the plurality of probe trips may further include producing the path based at least in pan on the geometric medians for each of the multiple route segments in some embodiments.

At block 3014, the process 3000 includes the navigation generation system storing the path between the third checkpoint and the fourth checkpoint to be utilized for production of direction paths. The direction paths may be utilized to provide directions between locations. In some embodiments, the direction paths produced may be displayed on a second map representation. The second map representation being a higher fidelity representation than the first map representation used for performing map matching.

In some embodiments, the process 3000 may further include the navigation generation system determining a first tortuosity of a segment of the road system corresponding to the path and determining a second tortuosity of the path. The navigation generation system may further compare the first tortuosity and the second tortuosity. The path may be stored based on the second tortuosity being within a defined threshold of the first tortuosity.

In some embodiments, the process 3000 may further include the navigation generation system determining a tortuosity of the path. The navigation generation system may further determine that the tortuosity is within a tortuosity threshold. The path may be stored based at least in part on the tortuosity being within the tortuosity threshold.

In some embodiments, the process 3000 may further include the navigation generation system receiving a request for a direction route from a first location to a second location. The navigation generation system may further determine that the first checkpoint, the second checkpoint, the third checkpoint, and the fourth checkpoint are along the direction route. Further, the navigation generation system may utilize the path to produce a direction path for the direction route. The direction path may be utilized to provide directions from the first location to the second location. In some of these embodiments, the request may be received from a device and the navigation generation system may provide at least a portion of the direction path to the device for display by the device based on the request. In some of these embodiments, the path is a first path and utilizing the first path to produce the direction path may include merging the first path with a second path located adjacent to the first path to produce the direction path. Further, merging the first path with the second path comprises generating a smooth connection between a first point on the first path located a distance from an intersection area between the first path and the second path and a second point on the second path located the distance from the intersection area.

In some embodiments, the process 3000 may further include the navigation generation system identifying a fifth checkpoint corresponding to a fifth decision trigger area of the road system, the fifth decision trigger area being adjacent to the fourth checkpoint. Further, the navigation generation system may identify a second plurality of probe trips from the third checkpoint to the fifth checkpoint that pass through the second checkpoint and the fourth checkpoint. The navigation generation system may aggregate the second plurality of probe trips to produce a second path from the second checkpoint to the fourth checkpoint. The navigation generation system may further store the second path from the second checkpoint to the fourth checkpoint to be utilized for production of direction routes.

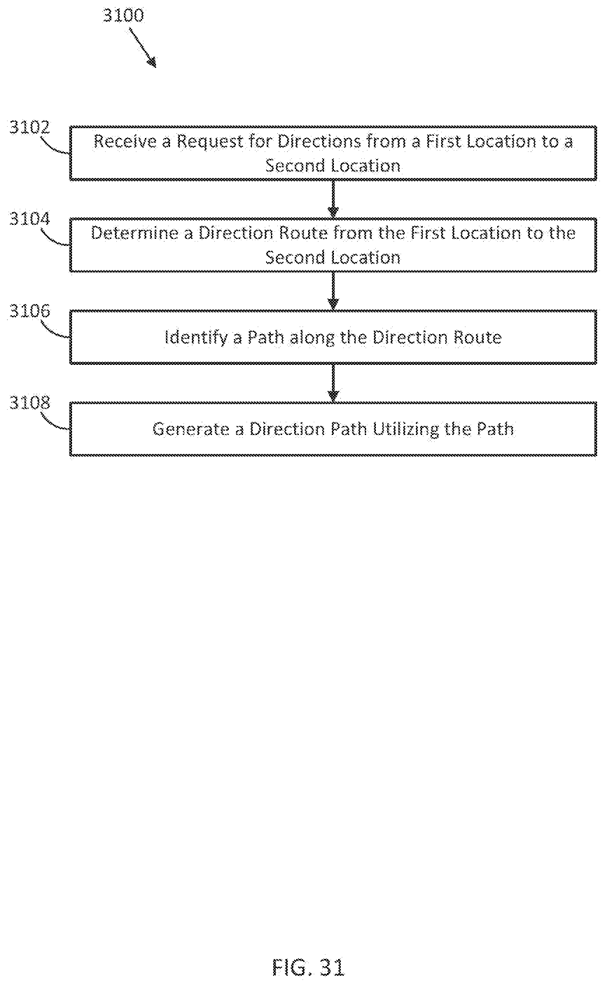

FIG. 31 is a diagram showing a flow chart corresponding to an example process 3100 for generating a direction path utilizing a path in accordance with some embodiments. The process 3100 may be implemented by a navigation generation system (such as the navigation generation system 102 (FIG. 1)), a system arrangement (such as the system arrangement 200 (FIG. 2)) or portion thereof, and/or a service provider computer (such as the service provider computer 3502 (FIG. 35)). The process 3100 is described herein as being performed by a navigation generation system, although it should be understood that a system arrangement (or portion thereof) may perform the operations in other embodiments. The process 3100 may result in one or more technical improvements including, for example, an accurate and detailed direction path to be displayed on a high fidelity map.

The process 3100 begins at block 3102 by the navigation generation system receiving a request for directions from a first location to a second location along a road system.

At block 3104, the process 3100 includes the navigation generation system determining a direction route from the first location to the second location.

At block 3106, the process 3100 includes the navigation generation system identifying a path along the direction route. The path may be generated based at least in part on a plurality of probe trips from a third checkpoint to a fourth checkpoint along the direction route. The plurality of probe trips may pass through a first checkpoint and a second checkpoint.

In some embodiments, the process 3100 may include the navigation generation system identifying the first checkpoint, the second checkpoint, the third checkpoint, and the fourth checkpoint. The navigation generation system may identify the plurality of probe trips from the third checkpoint to the fourth checkpoint that pass through the first checkpoint and the second checkpoint. The navigation generation system may further aggregate the plurality of probe trips to produce the path. Further, the navigation generation system may store the path to be utilized for production of direction paths.

In some embodiments, aggregating the plurality of probe trips may include determining a route along the road system from the first checkpoint to the second checkpoint. Further, aggregating the plurality of probe trips may include dividing the route into multiple route segments. Aggregating the plurality of probe trips may further include sampling each of the multiple route segments to acquire points from each of the plurality of probe trips within each of the multiple route segments. Further, aggregating the plurality of probe trips may include determining geometric medians for each of the multiple mute segments based at least in part on the points from each of the plurality of probe trips. Aggregating the plurality of probe trips may further include producing the path based at least in part on the geometric medians for each of the multiple route segments.

In some embodiments, identifying the first checkpoint may include identifying a first decision trigger area of the road system along the direction route and determining that the first checkpoint is located at a first distance from the first decision trigger area. Further, identifying the second checkpoint may include identifying a second decision trigger area of the road system along the direction route and determining that the second checkpoint is located at a second distance from the second decision trigger area in some embodiments. In some embodiments, identifying the third checkpoint may include identifying a third decision trigger area of the road system along the direction route and determining that the third checkpoint is located at, a third distance from the third decision trigger area. Further, identifying the fourth checkpoint may further include identifying a fourth decision trigger area of the road system along the direction route. The first decision trigger area and the second decision trigger area may be located between the third decision trigger area and the fourth decision trigger area along the direction route. Further, identifying the fourth checkpoint may include determining that the fourth checkpoint is located at a fourth distance from the fourth decision trigger area.

In some embodiments, identifying the first checkpoint may include identifying a first decision trigger area of the road system along the direction route and determining that the first checkpoint is located at a first distance from an entry of the first decision trigger area. Further, identifying the second checkpoint may include identifying the first decision trigger area and determining that the second checkpoint is located at, a second distance from an exit of the first decision trigger area in some embodiments. In some embodiments, identifying the third checkpoint may include identifying a second decision trigger area of the road system along the direction route and determining that the third checkpoint is located at a third distance from the second decision trigger area. Further, identifying the fourth checkpoint may include identifying a third decision trigger area of the road system along the direction route. The first decision trigger area may be located between the second decision trigger area and the third decision trigger area along the direction route. In some embodiments, identifying the fourth checkpoint may further include determining that the fourth checkpoint is located at a fourth distance from the third decision trigger area.

At block 3108, the process 3100 includes the navigation generation system generating a direction path utilizing the path. The direction path may be utilized to provide directions from the first location to the second location.

In some embodiments, the path may be a first path. Generating the direction path may include identifying a second path, the second path located adjacent to the first path along the direction route. Further, generating the direction path may include merging the first path with the second path. In some embodiments, the plurality of probe trips may include a first plurality of probe trips. Further, the second path may be generated based at least in part on a second plurality of probe trips from the first checkpoint to a fifth checkpoint along the direction route. The second plurality of probe trips may pass through the second checkpoint and the fourth checkpoint. In some embodiments, merging the first path with the second path may include generating a smooth connection between a first point on the first path located a distance from an intersection area between the first path and the second path and a second point on the second path located the distance from the intersection area.

In some embodiments, the request may be received from a device. The process 31R) may further include the navigation generation system providing at least a portion of the direction to be displayed by the device.

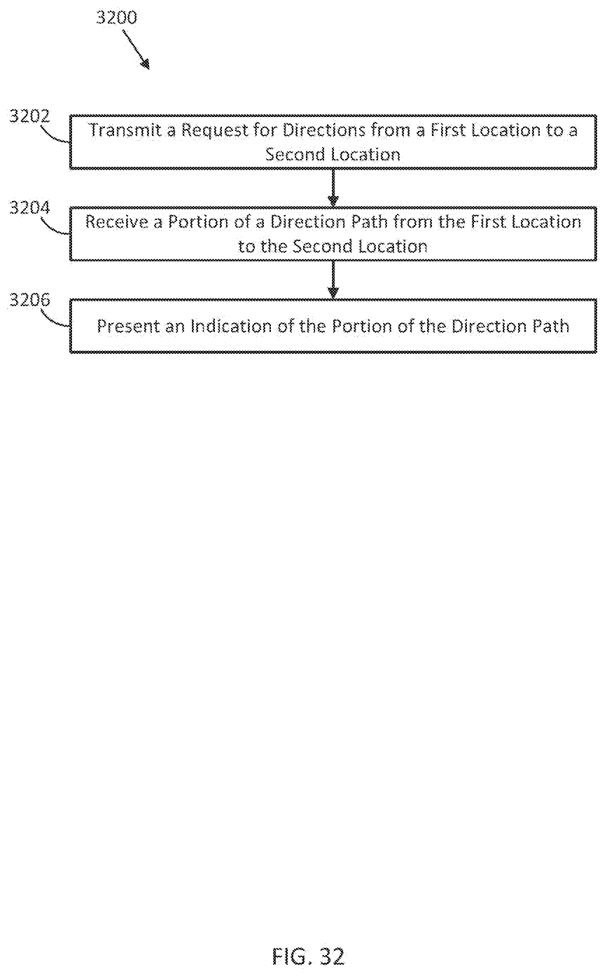

FIG. 32 is a diagram showing a flow chart corresponding to an example process 3200 for presenting an indication of a portion of a direction path in accordance with some embodiments. The process 3200 may be implemented by a user device, such as the user device 112 (FIG. 1), the user device 202 (FIG. 2), the user device 3300 (FIG. 33), and/or the user device 3506 (FIG. 35). The process 3200 may result in one or more technical improvements including, for example, an accurate and detailed direction path to be displayed on a high fidelity map on the user device.

The process 3200 begins at block 3202 by the user device transmitting a request for directions from a first location to a second location along a road system.

At block 3204, the process 3200 includes the user device receiving a portion of a direction path from the first location to the second location. The portion of the direction path may be generated based at least in part on a plurality of probe trips from a first checkpoint to a second checkpoint that pass through a third checkpoint and a fourth checkpoint. The first checkpoint, the second checkpoint, the third checkpoint, and the fourth checkpoint may be along a direction route from the first location to the second location. The direction route may correspond to the portion of the direction path.

In some embodiments, the portion of the direction path may include a first portion of the direction path and the plurality of probe trips may include a first plurality of probe trips. The process 3200 may further include the user device receiving a second portion of the direction path from the first location to the second location. The second portion of the direction path may be generated based at least in part on a second plurality of probe trips from the third checkpoint to a fifth checkpoint that pass through the fourth checkpoint and the second checkpoint. The fifth checkpoint may be along the direction route from the first location to the second location.

In some embodiments, the first portion of the direction path may correspond to a first decision trigger area of the road system. Further, the first portion of the direction path may be received based at least in part on the device approaching the first decision trigger area. The second portion of the direction path may correspond to a second decision trigger area of the road system. The second portion of the direction path may be received based at least in part on the device approaching the second decision trigger area.

In some embodiments, the process 3200 may further include the user device determining locations of the device as the device travels from the first location to the second location. The user device may further transmit indications of the locations of the device. The device may be determined to be approaching the first decision trigger area and the device may be determined to be approaching the second decision trigger area based at least in part on the locations of the device being transmitted by the device.

At block 3206, the process 3200 includes the user device presenting an indication of the portion of the direction path. The indication of the portion of the direction path may indicate at least one lane of the road system. In some embodiments, presenting the indication of the portion of the direction path may include presenting, by the device, a line or an arrow displayed within a representation of the at least one lane on a display of the device.

In some embodiments, the portion of the direction path may correspond to a decision trigger area of the road system. Further, the third checkpoint may correspond to decision trigger area. The device may present the indication of the portion of the direction path based at least in part on a location of the third checkpoint. In some embodiments, the third checkpoint may be located at a distance from the decision trigger area. The process 3200 may include the user device determining a location of the device. The indication of the portion of the direction path may be presented based at least in part on the location of the device being at the location of the third checkpoint. In some embodiments, the indication of the portion of the direction path may indicate a maneuver to be performed corresponding to the decision trigger area.

In some embodiments, the process 3200 may include the user device determining locations of the device as the device travels from the first checkpoint to the second checkpoint through the third checkpoint and the fourth checkpoint. The user device may further transmit indications of the locations of the device. The plurality of probe trips may be updated based on the indications of the locations of the device.

FIG. 33 illustrates an example user device 3300 in accordance with some embodiments. The user device 3300 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices. In some embodiments, the user device 3300 may be a RedCap user device or NR-Light user device.

The user device 3300 may include processors 3304, RF interface circuitry 3308, memory/storage 3312, user interface 3316, sensors 3320, driver circuitry 3322, power management integrated circuit (PMIC) 3324, antenna structure 3326, and battery 3328. The components of the user device 3300 may be implemented as integrated circuits (ICs), portions thereof, discrete electronic devices, or other modules, logic, hardware, software, firmware, or a combination thereof. The block diagram of FIG. 33 is intended to show a high-level view of some of the components of the user device 3300. However, some of the components shown may be omitted, additional components may be present, and different arrangement of the components shown may occur in other implementations.

The components of the user device 3300 may be coupled with various other components over one or more interconnects 3332, which may represent any type of interface, input/output, bus (local, system, or expansion), transmission line, trace, optical connection, etc. that allows various circuit components (on common or different chips or chipsets) to interact with one another.

The processors 3304 may include processor circuitry such as, for example, baseband processor circuitry (BB) 3304A, central processor unit circuitry (CPU) 3304B, and graphics processor unit circuitry (GPU) 3304C. The processors 3304 may include any type of circuitry or processor circuitry that executes or otherwise operates computer-executable instructions, such as program code, software modules, or functional processes from memory/storage 3312 to cause the user device 3300 to perform operations as described herein.

In some embodiments, the baseband processor circuitry 3304A may access a communication protocol stack 3336 in the memory/storage 3312 to communicate over a 3GPP compatible network. In general, the baseband processor circuitry 3304A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 3308.

The baseband processor circuitry 3304A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 3312 may include one or more non-transitory, computer-readable media that includes instructions (for example, communication protocol stack 3336) that may be executed by one or more of the processors 3304 to cause the user device 3300 to perform various operations described herein. The memory/storage 3312 include any type of volatile or non-volatile memory that may be distributed throughout the user device 3300. In some embodiments, some of the memory/storage 3312 may be located on the processors 3304 themselves (for example, L1 and L2 cache), while other memory/storage 3312 is external to the processors 3304 but accessible thereto via a memory interface. The memory/storage 3312 may include any suitable volatile or non-volatile memory such as, but not limited to, dynamic random access memory (DRAM), static random access memory (SRAM), erasable programmable read only memory (EPROM), electrically erasable programmable read only memory (EEPROM). Flash memory, solid-state memory, or any other type of memory device technology.

The RF interface circuitry 3308 may include transceiver circuitry and radio frequency front module (RFEM) that allows the user device 3300 to communicate with other devices over a radio access network. The RF interface circuitry 3308 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 3326 and proceed to filter and amplify (with a low-noise amplifier) the signal. The signal may be provided to a receiver of the transceiver that down-converts the RF signal into a baseband signal that is provided to the baseband processor of the processors 3304.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 3326.

In various embodiments, the RF interface circuitry 3308 may be configured to transmit/receive signals in a manner compatible with NR access technologies.

The antenna 3326 may include antenna elements to convert electrical signals into radio waves to travel through the air and to convert received radio waves into electrical signals. The antenna elements may be arranged into one or more antenna panels. The antenna 3326 may have antenna panels that are omnidirectional, directional, or a combination thereof to enable beamforming and multiple input, multiple output communications. The antenna 3326 may include microstrip antennas, printed antennas fabricated on the surface of one or more printed circuit boards, patch antennas, phased array antennas, etc. The antenna 3326 may have one or more panels designed for specific frequency bands including bands in FR1 or FR2.

The user interface circuitry 3316 includes various input/output (I/O) devices designed to enable user interaction with the user device 3300. The user interface 3316 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the user device 3300.

The sensors 3320 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 3322 may include software and hardware elements that operate to control particular devices that are embedded in the user device 3300, attached to the user device 3300, or otherwise communicatively coupled with the user device 3300. The driver circuitry 3322 may include individual drivers allowing other components to interact with or control various input/output (I/O) devices that may be present within, or connected to, the user device 3300. For example, driver circuitry 3322 may include a display driver to control and allow access to a display device, a touchscreen driver to control and allow access to a touchscreen interface, sensor drivers to obtain sensor readings of sensor circuitry 3320 and control and allow access to sensor circuitry 3320, drivers to obtain actuator positions of electro-mechanic components or control and allow access to the electro-mechanic components, a camera driver to control and allow access to an embedded image capture device, audio drivers to control and allow access to one or more audio devices.

The PMIC 3324 may manage power provided to various components of the user device 3300. In particular, with respect to the processors 3304, the PMIC 3324 may control power-source selection, voltage scaling, battery charging, or DC-to-DC conversion.

In some embodiments, the PMIC 3324 may control, or otherwise be part of, various power saving mechanisms of the user device 3300. For example, if the platform user device is in an RRC_-Connected state, where it is still connected to the RAN node as it expects to receive traffic shortly, then it may enter a state known as Discontinuous Reception Mode (DRX) after a period of inactivity. During this state, the user device 3300 may power down for brief intervals of time and thus save power. If there is no data traffic activity for an extended period of time, then the user device 3300 may transition off to an RRC_Idle state, where it disconnects from the network and does not perform operations such as channel quality feedback, handover, etc. The user device 3300 goes into a very low power state and it performs paging where again it periodically wakes up to listen to the network and then powers down again. The user device 3300 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 3328 may power the user device 3300, although in some examples the user device 3300 may be mounted deployed in a fixed location, and may have a power supply coupled to an electrical grid. The battery 3328 may be a lithium ion battery, a metal-air battery, such as a zinc-air battery, an aluminum-air battery, a lithium-air battery, and the like. In some implementations, such as in vehicle-based applications, the battery 3328 may be a typical lead-acid automotive battery.

FIG. 34 is a block diagram of an example computing device 3400 that can implement the features and processes of FIGS. 1-32 in accordance with some embodiments. The computing device 3400 is an example of the navigation generation system 102 (FIG. 1), the user device 112 (FIG. 1), the system arrangement 200 (FIG. 2), and/or the user device 202 (FIG. 2). The computing device 3400 can include a memory interface 3402, one or more data processors, image processors and/or central processing units 3404, and a peripherals interface 3406. The memory interface 3402, the one or more processors 3404 and/or the peripherals interface 3406 can be separate components or can be integrated in one or more integrated circuits. The various components in the computing device 3400 can be coupled by one or more communication buses or signal lines.

Sensors, devices, and subsystems can be coupled to the peripherals interface 3406 to facilitate multiple functionalities. For example, a motion sensor 3410, a light sensor 3412, and a proximity sensor 3414 can be coupled to the peripherals interface 3406 to facilitate orientation, lighting, and proximity functions. Other sensors 3416 can also be connected to the peripherals interface 3406, such as a global navigation satellite system (GNSS) (e.g., GPS receiver), a temperature sensor, a biometric sensor, magnetometer or other sensing device, to facilitate related functionalities.

A camera subsystem 3420 and an optical sensor 3422 (e.g., a charged coupled device (CCD) or a complementary metal-oxide semiconductor (CMOS) optical sensor) can be utilized to facilitate camera functions, such as recording photographs and video clips. The camera subsystem 3420 and the optical sensor 3422 can be used to collect images of a user to be used during authentication of a user (e.g., by performing facial recognition analysis).

Communication functions can be facilitated through one or more wireless communication subsystems 3424, which can include radio frequency receivers and transmitters and/or optical (e.g., infrared) receivers and transmitters. The specific design and implementation of the communication subsystem 3424 can depend on the communication network(s) over which the computing device 3400 is intended to operate. For example, the computing device 3400 can include communication subsystems 3424 designed to operate over a GSM network, a GPRS network, an EDGE network, a Wi-Fi or WiMax network, and a Bluetooth™ network. In particular, the wireless communication subsystems 3424 can include hosting protocols such that the navigation generation system 102 and/or the system arrangement 200 can be configured as a base station for other wireless devices.

An audio subsystem 3426 can be coupled to a speaker 3428 and a microphone 3430 to facilitate voice-enabled functions, such as speaker recognition, voice replication, digital recording, and telephony functions. The audio subsystem 3426 can be configured to facilitate processing voice commands, voice printing and voice authentication, for example.

The I/O subsystem 3440 can include a touch-surface controller 3442 and/or other input controller(s) 3444. The touch-surface controller 3442 can be coupled to a touch surface 3446. The touch surface 3446 and touch-surface controller 3442 can, for example, detect contact and movement or break thereof using any of a plurality of touch sensitivity technologies, including, but not limited to, capacitive, resistive, infrared, and surface acoustic wave technologies, as well as other proximity sensor arrays or other elements for determining one or more points of contact with the touch surface 3446.

The other input controller(s) 3444 can be coupled to other input/control devices 3448, such as one or more buttons, rocker switches, thumbwheel, infrared port. USB port, and/or a pointer device such as a stylus. The one or more buttons (not shown) can include an up/down button for volume control of the speaker 3428 and/or the microphone 3430.

In one implementation, a pressing of the button for a first duration can disengage a lock of the touch surface 3446; and a pressing of the button for a second duration that is longer than the first duration can turn power to the computing device 3400 on or off. Pressing the button for a third duration can activate a voice control, or voice command, module that enables the user to speak commands into the microphone 3430 to cause the device to execute the spoken command. The user can customize a functionality of one or more of the buttons. The touch surface 3446 can, for example, also be used to implement virtual or soft buttons and/or a keyboard.

In some examples, the computing device 3400 can present recorded audio and/or video files, such as MP3, AAC, and MPEG files. In some examples, the computing device 3400 can include the functionality of an MP3 player, such as an iPod™.

The memory interface 3402 can be coupled to memory 3450. The memory 3450 can include high-speed random-access memory and/or non-volatile memory, such as one or more magnetic disk storage devices, one or more optical storage devices, and/or flash memory (e.g., NAND, NOR). The memory 3450 can store an operating system 3452, such as Darwin, RTXC, LINUX. UNIX, OS X, WINDOWS, or an embedded operating system such as VxWorks.

The operating system 3452 can include instructions for handling basic system services and for performing hardware dependent tasks. In some examples, the operating system 3452 can be a kernel (e.g., UNIX kernel). In some examples, the operating system 3452 can include instructions for performing map data error correction. For example, operating system 3452 can implement, the map data error correction features as described with reference to FIGS. 1-29.

The memory 3450 can also store communication instructions 3454 to facilitate communicating with one or more additional devices, one or more computers and/or one or more servers. The memory 3450 can include graphical user interface instructions 3456 to facilitate graphic user interface processing; sensor processing instructions 3458 to facilitate sensor-related processing and functions; phone instructions 3460 to facilitate phone-related processes and functions; electronic messaging instructions 3462 to facilitate electronic-messaging related processes and functions; web browsing instructions 3464 to facilitate web browsing-related processes and functions; media processing instructions 3466 to facilitate media processing-related processes and functions; GNSS/Navigation instructions 3468 to facilitate GNSS and navigation-related processes and instructions; and/or camera instructions 3470 to facilitate camera-related processes and functions.

The memory 3450 can store software instructions 3472 to facilitate other processes and functions, such as the map data error correction processes and functions as described with reference to FIGS. 1-32.

The memory 3450 can also store other software instructions 3474, such as web video instructions to facilitate web video-related processes and functions; and/or web shopping instructions to facilitate web shopping-related processes and functions. In some examples, the media processing instructions 3466 are divided into audio processing instructions and video processing instructions to facilitate audio processing-related processes and functions and video processing-related processes and functions, respectively.

Each of the above identified instructions and applications can correspond to a set of instructions for performing one or more functions described above. These instructions need not be implemented as separate software programs, procedures, or modules. The memory 3450 can include additional instructions or fewer instructions. Furthermore, various functions of the computing device 3400 can be implemented in hardware and/or in software, including in one or more signal processing and/or application specific integrated circuits.

FIG. 35 illustrates an example architecture or environment 3500 configured to implement techniques described herein in accordance with some embodiments. The architecture 3500 includes a user device 3506 (e.g., the user device 112 (FIG. 1) and/or the user device 202 (FIG. 2)) and a service provider computer 3502 (e.g., the navigation generation system 102 (FIG. 1)). In some examples, the example architecture 3500 may further be configured to enable the user device 3506 and the service provider computer 3502 to share information. In some examples, the devices may be connected via one or more networks 3508 (e.g., via Bluetooth, WiFi, the Internet). In some examples, the service provider computer 3502 may be configured to implement at least some of the techniques described herein with reference to the user device 3506 and vice versa.

In some examples, the networks 3508 may include any one or a combination of many different types of networks, such as cable networks, the Internet, wireless networks, cellular networks, satellite networks, other private and/or public networks, or any combination thereof. While the illustrated example represents the user device 3506 accessing the service provider computer 3502 via the networks 3508, the described techniques may equally apply in instances where the user device 3506 interacts with the service provider computer 3502 over a landline phone, via a kiosk, or in any other manner. It is also noted that the described techniques may apply in other client/server arrangements (e.g., set-top boxes), as well as in non-client/server arrangements (e.g., locally stored applications, peer-to-peer configurations).

As noted above, the user device 3506 may be any type of computing device such as, but not limited to, a mobile phone, a smartphone, a personal digital assistant (PDA), a laptop computer, a desktop computer, a thin-client device, a tablet computer, a wearable device such as a smart watch, an electronic device in a moveable vehicle or transport device, or the like. In some examples, the user device 3506 may be in communication with the service provider computer 3502 via the network 3508, or via other network connections.

In one illustrative configuration, the user device 3506 may include at least one memory 3514 and one or more processing units (or processor(s)) 3516. The processor(s) 3516 may be implemented as appropriate in hardware, computer-executable instructions, firmware, or combinations thereof. Computer-executable instructions or firmware implementations of the processor(s) 3516 may include computer-executable or machine-executable instructions written in any suitable programming language to perform the various functions described. The user device 3506 may also include geo-location devices (e.g., a global positioning system (GPS) device or the like) for providing and/or recording geographic location information associated with the user device 3506. In some examples, the processors 3516 may include a GPU and a CPU.

The memory 3514 may store program instructions that are loadable and executable on the processor(s) 3516, as well as data generated during the execution of these programs. Depending on the configuration and type of the user device 3506, the memory 3514 may be volatile (such as random access memory (RAM)) and/or non-volatile (such as read-only memory (ROM), flash memory). The user device 3506 may also include additional removable storage and/or non-removable storage 3526 including, but not limited to, magnetic storage, optical disks, and/or tape storage. The disk drives and their associated non-transitory computer-readable media may provide non-volatile storage of computer-readable instructions, data structures, program modules, and other data for the computing devices. In some examples, the memory 3514 may include multiple different types of memory, such as static random access memory (SRAM), dynamic random access memory (DRAM), or ROM. While the volatile memory described herein may be referred to as RAM, any volatile memory that would not maintain data stored therein once unplugged from a host and/or power would be appropriate.

The memory 3514 and the additional storage 3526, both removable and non-removable, are all examples of non-transitory computer-readable storage media. For example, non-transitory computer-readable storage media may include volatile or non-volatile, removable or non-removable media implemented in any method or technology for storage of information such as computer-readable instructions, data structures, program modules, or other data. The memory 3514 and the additional storage 3526 are both examples of non-transitory computer-storage media. Additional types of computer-storage media that may be present in the user device 3506 may include, but are not limited to, phase-change RAM (PRAM), SRAM, DRAM. RAM, ROM, Electrically Erasable Programmable Read-Only Memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by the user device 3506. Combinations of any of the above should also be included within the scope of non-transitory computer-readable storage media. Alternatively, computer-readable communication media may include computer-readable instructions, program modules, or other data transmitted within a data signal, such as a carrier wave, or other transmission. However, as used herein, computer-readable storage media does not include computer-readable communication media.

The user device 3506 may also contain communications connection(s) 3528 that allow the user device 3506 to communicate with a data store, another computing device or server, user terminals, and/or other devices via the network 3508. The user device 3506 may also include I/O device(s) 3530, such as a keyboard, a mouse, a pen, a voice input device, a touch screen input device, a display, speakers, and a printer.

Turning to the contents of the memory 3514 in more detail, the memory 3514 may include an operating system 3512 and/or one or more application programs or services for implementing the features disclosed herein such as applications 3511 (e.g., map applications, web application) and map engine 3513. The techniques described with respect to FIGS. 1-32 may be performed by the map engine 3513.

The service provider computer 3502 may also be any type of computing device such as, but not limited to, a collection of virtual or “cloud” computing resources, a remote server, a mobile phone, a smartphone, a PDA, a laptop computer, a desktop computer, a thin-client device, a tablet computer, a wearable device, a server computer, or a virtual machine instance. In some examples, the service provider computer 3502 may be in communication with the user device 3506 via the network 3508, or via other network connections.

In one illustrative configuration, the service provider computer 3502 may include at least one memory 3542 and one or more processing units (or processor(s)) 3544. The processor(s) 3544 may be implemented as appropriate in hardware, computer-executable instructions, firmware, or combinations thereof. Computer-executable instructions or firmware implementations of the processor(s) 3544 may include computer-executable or machine-executable instructions written in any suitable programming language to perform the various functions described.

The memory 3542 may store program instructions that are loadable and executable on the processor(s) 3544, as well as data generated during the execution of these programs. Depending on the configuration and type of service provider computer 3502, the memory 3542 may be volatile (such as RAM) and/or non-volatile (such as ROM and flash memory). The service provider computer 3502 may also include additional removable storage and/or non-removable storage 3546 including, but not limited to, magnetic storage, optical disks, and/or tape storage. The disk drives and their associated non-transitory computer-readable media may provide non-volatile storage of computer-readable instructions, data structures, program modules, and other data for the computing devices. In some examples, the memory 3542 may include multiple different types of memory, such as SRAM, DRAM, or ROM. While the volatile memory described herein may be referred to as RAM, any volatile memory that would not maintain data stored therein, once unplugged from a host and/or power, would be appropriate. The memory 3542 and the additional storage 3546, both removable and non-removable, are both additional examples of non-transitory computer-readable storage media.

The service provider computer 3502 may also contain communications connection(s) 3548 that allow the service provider computer 3502 to communicate with a data store, another computing device or server, user terminals, and/or other devices via the network 3508. The service provider computer 3502 may also include I/O device(s) 3550, such as a keyboard, a mouse, a pen, a voice input device, a touch input device, a display, speakers, and a printer.

Turning to the contents of the memory 3542 in more detail, the memory 3542 may include an operating system 3552 and/or one or more application programs 3541 or services for implementing the features disclosed herein such as those described with reference to FIGS. 1-32.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a user device, base station, network element, etc. as described above in connection with one or more of the preceding figures may be configured to operate in accordance with one or more of the examples set forth below in the example section.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

As described above, one aspect of the present technology is the gathering and use of data available from specific and legitimate sources to generate direction paths to be utilized for providing directions. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to generate direction paths. The direction paths can provide greater detail regarding suggest travel on a road system based on historic travel provided by probe data.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, such as in the case of advertisement delivery services, the present technology can be configured to allow users to select to “opt in” or “opt out” of participation in the collection of personal information data during registration for services or anytime thereafter, in addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

In some examples, “circuitry” can refer to, be part of, or include hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user device” or “user device” as used herein refers to a device with radio communication capabilities and may describe a remote user of network resources in a communications network. The term “user device” or “user device” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user device” or “user device” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

Although the present disclosure has been described with respect to specific embodiments, it will be appreciated that the disclosure is intended to cover all modifications and equivalents within the scope of the following claims.

All patents, patent applications, publications, and descriptions mentioned herein are incorporated by reference in their entirety for all purposes. None is admitted to be prior art.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein am merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure. The use of “or” is intended to mean an “inclusive or,” and not an “exclusive or,” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

Disjunctive language such as the phrase “at least one of X, Y, or Z,” unless specifically stated otherwise, is otherwise understood within the context as used in general to present that an item, term, etc., may be either X. Y, or Z, or any combination thereof (e.g., X, Y. and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

The specific details of particular embodiments may be combined in any suitable manner or varied from those shown and described herein without departing from the spirit and scope of embodiments of the described techniques.

The above description of exemplary embodiments of the described techniques has been presented for the purposes of illustration and description. It is not intended to be exhaustive or to limit the described techniques to the precise form described, and many modifications and variations are possible in light of the teaching above. The embodiments were chosen and described in order to best explain the principles of the described techniques and its practical applications to thereby enable others skilled in the art to best utilize the described techniques in various embodiments and with various modifications as are suited to the particular use contemplated.

All publications, patents, and patent applications cited herein are hereby incorporated by reference in their entirety for all purposes.

### Examples

In the following sections, further exemplary embodiments are provided.

Example 1 may include a computer-implemented method, comprising identifying a quadruple of checkpoints associated with a decision trigger area, the quadruple of checkpoints comprising an entry checkpoint, a first intermediate checkpoint, a second intermediate checkpoint, and an exit checkpoint, identifying a plurality of probe trips that pass through the quadruple of checkpoints, aggregating the plurality of probe trips to produce a first path segment between the first intermediate checkpoint and the second intermediate checkpoint based on (i) a portion of the plurality of probe trips, (ii) a second path segment between the entry checkpoint and the first intermediate checkpoint, and (iii) a third path segment between the second intermediate checkpoint and the exit checkpoint, and storing the first path segment to be utilized for production of direction paths.

Example 2 may include the method of example 1, wherein the entry checkpoint, is located at a first predefined distance from an entrance of the decision trigger area, and wherein the exit checkpoint is located at a second predefined distance from an exit of the decision trigger area.

Example 3 may include the method of example 2, wherein the first predefined distance depends on a classification of a first road segment connected to the entrance of the decision trigger area, and wherein the second predefined distance depends on a classification of a second road segment connected to the exit of the decision trigger area.

Example 4 may include the method of example 1, wherein the first intermediate checkpoint is located within the decision trigger area at a predefined distance from an entrance of the decision trigger area, and wherein the second intermediate checkpoint is located within the decision trigger area at a predefined distance from an exit of the decision trigger area.

Example 5 may include the method of example 1, wherein aggregating the plurality of probe trips comprises dividing an area between the first intermediate checkpoint and the second intermediate checkpoint into multiple probe segments, sampling each of the multiple probe segments to acquire points from the plurality of probe trips within each of the multiple probe segments, determining geometric medians for each of the multiple probe segments based at least in part on the points from the plurality of probe trips, and producing the first path segment based at least in part on the geometric medians for each of the multiple probe segments.

Example 6 may include the method of example 1, further comprising map matching the plurality of probe trips to a map representation, wherein identifying the plurality of probe trips comprises identifying the plurality of probe trips that have been map matched to the map representation.

Example 7 may include the method of example 6, wherein the map representation is a first map representation, and wherein the direction paths produced are to be displayed on a second map representation, the second map representation being a higher fidelity representation than the first map representation.

Example 8 may include the method of example 1, further comprising determining a first tortuosity of a segment of a road system from the first intermediate checkpoint to the second intermediate checkpoint, determining a second tortuosity of the first path segment, and comparing the first tortuosity and the second tortuosity, wherein the first path segment is stored based on the second tortuosity being within a defined threshold of the first tortuosity.

Example 9 may include the method of example 1, further comprising determining a tortuosity of the first path segment, and determining that the tortuosity is within a tortuosity threshold, wherein the first path segment is stored based at least in part on the tortuosity being within the tortuosity threshold.

Example 10 may include the method of example 1, further comprising receiving a request for a direction route from a first location to a second location, determining that the entry checkpoint, the first intermediate checkpoint, the second intermediate checkpoint, and the exit checkpoint are along the direction route, and utilizing the first path segment to produce a direction path for the direction route, wherein the direction path is to be utilized to provide directions from the first location to the second location.

Example 11 may include the method of example 10, wherein the request for the direction route is received from a device, and wherein the method further comprises providing at least a portion of the direction path to the device for display by the device.

Example 12 may include the method of example 10, wherein utilizing the first path segment to produce the direction path comprises merging the first path segment with a fourth path segment located adjacent to the first path segment to produce the direction path.

Example 13 may include the method of example 12, wherein merging the first path segment with the fourth path segment comprises generating a smooth connection between a first point on the first path segment located a distance from an intersection area between the first path segment and the second path segment and a second point on the second path segment located the distance from the intersection area.

Example 14 may include the method of example 1, further comprising identifying the decision trigger area of a road system, determining that the entry checkpoint is located along the road system outside of the decision trigger area at a first predefined distance from an entry of the decision trigger area, determining that the first intermediate checkpoint, is located along the road system within the decision trigger area at a second predefined distance from the entry of the decision trigger area, determining that the second intermediate checkpoint is located along the road system within the decision trigger area at a third predefined distance from an exit of the decision trigger area, and determining that the exit checkpoint is located along the road system outside of the decision trigger area at a fourth predefined distance from the exit of the decision trigger area.

Example 15 may include the method of example 1, wherein the decision trigger area comprises a roadway intersection, a roadway exit, a roadway lane merge, a roadway lane split, or a roadway obstruction of a road system.

Example 16 may include one or more non-transitory computer-readable media comprising computer-executable instructions that, when executed by one or more processors, cause the one or mom processors to perform the method of any one of the examples 1-15.

Example 17 may include a computerized system, comprising a memory configured to store computer-executable instructions, and a processor configured to access the memory and execute the computer-executable instructions to perform the method of any one of examples 1-15.

Example 18 may include a computer-implemented method, comprising receiving a request for directions from a first location to a second location along a road system, determining a direction route from the first location to the second location, identifying a path segment along the direction route, the path segment generated based at least in part on a portion of a plurality of probe trips that pass through a quadruple of checkpoints associated with a decision trigger area, the quadruple of checkpoints comprising an entry checkpoint, a first intermediate checkpoint, a second intermediate checkpoint, and an exit checkpoint, and generating a direction path utilizing the path segment, the direction path to be utilized to provide directions from the first location to the second location.

Example 19 may include the method of example 18, wherein the path segment comprises a first path segment, wherein the first path segment is between the first intermediate checkpoint and the second intermediate checkpoint, and wherein the first path segment is generated based further on (i) a second path segment between the entry checkpoint and the first intermediate checkpoint, and (ii) a third path segment between the second intermediate checkpoint and the exit checkpoint.

Example 20 may include the method of example 18, where the path segment comprises a first path segment, and wherein generating the direction path comprises identifying a second path segment, the second path segment located adjacent to the first path segment along the direction route, and merging the first path segment with the second path segment.

Example 21 may include the method of example 20, wherein the plurality of probe trips comprises a first plurality of probe trips, wherein the second path segment is generated based at least in part on a portion of a second plurality of probe trips corresponding to a second quadruple of checkpoints.

Example 22 may include the method of example 20, wherein merging the first path segment with the second path segment comprises generating a smooth connection between a first point on the first path segment located a distance from an intersection area between the first path segment and the second path segment and a second point on the second path segment located the distance from the intersection area.

Example 23 may include the method of example 18, further comprising identifying the entry checkpoint, the first intermediate checkpoint, the second intermediate checkpoint, and the exit checkpoint, identifying the plurality of probe trips from the entry checkpoint to the exit checkpoint that pass through the first intermediate checkpoint and the second intermediate checkpoint, aggregating the plurality of probe trips to produce the path segment, and storing the path segment to be utilized for production of direction paths.

Example 24 may include the method of example 23, wherein aggregating the plurality of probe trips comprises dividing an area between the first intermediate checkpoint and the second intermediate checkpoint into multiple probe segments, sampling each of the multiple probe segments to acquire points from the plurality of probe trips within each of the multiple probe segments, determining geometric medians for each of the multiple probe segments based at least in part on the points from the plurality of probe trips, and producing the path segment based at least in part on the geometric medians for each of the multiple probe segments.

Example 25 may include the method of example 23, wherein the method further comprises identifying the decision trigger area of a road system along the direction route, identifying the entry checkpoint comprises determining that the entry checkpoint is located along the road system outside of the decision trigger area at a first predefined distance from an entry of the decision trigger area, identifying the first intermediate checkpoint comprises determining that the first intermediate checkpoint is located along the road system within the decision trigger area at a second predefined distance from the entry of the decision trigger area, identifying the second intermediate checkpoint comprises determining that the second intermediate checkpoint is located along the road system within the decision trigger area at a third predefined distance from an exit of the decision trigger area, and identifying the exit checkpoint comprises determining that the exit checkpoint is located along the road system outside of the decision trigger area at a fourth predefined distance from the exit of the decision trigger area.

Example 26 may include the method of example 18, wherein the request for directions is received from a device, and wherein the method further comprises providing at least a portion of the direction path to the device for display by the device based on the request for directions.

Example 27 may include one or more non-transitory computer-readable media comprising computer-executable instructions that, when executed by one or more processors, cause the one or more processors to perform the method of any one of the examples 18-26.

Example 28 may include a computerized system, comprising a memory configured to store computer-executable instructions, and a processor configured to access the memory and execute the computer-executable instructions to perform the method of any one of examples 18-26.

Example 29 may include a computer-implemented method, comprising transmitting a request for directions from a first location to a second location along a road system, receiving a portion of a direction path from the first location to the second location, the portion of the direction path comprising a path segment generated based at least in part on a plurality of probe trips that pass through a quadruple of checkpoints associated with a decision trigger area, the quadruple of checkpoints comprising an entry checkpoint, a first intermediate checkpoint, a second intermediate checkpoint, and an exit checkpoint, and presenting an indication of the portion of the direction path, the indication of the portion of the direction path indicating at least one lane of the road system.

Example 30 may include the method of example 29, wherein the entry checkpoint is located along the road system outside of the decision trigger area at a distance from an entry of the decision trigger area, and the method further comprises determining a location of a device performing the method, determining that the location of the device is at the entry checkpoint, and presenting an indication of the portion of the direction path based at least in part on the location of the device being at the entry checkpoint.

Example 31 may include the method of example 30, wherein presenting the indication of the portion of the direction path comprises presenting an indication of at least one lane of the road system.

Example 32 may include the method of example 31, wherein presenting the indication of the at least one lane comprises displaying a line or arrow indicating the at least one lane.

Example 33 may include the method of example 30, wherein the indication of the portion of the direction path indicates a maneuver to be performed corresponding to the decision trigger area.

Example 34 may include the method of example 29, wherein the portion of the direction path comprises a first portion of the direction path, wherein the plurality of probe trips comprises a first plurality of probe trips, wherein the path segment comprises a first path segment, and wherein the method further comprises receiving a second portion of the direction path, the second portion of the direction path comprising a second path segment adjacent to the first path segment, and presenting an indication of the portion of the second portion of the direction path.

Example 35 may include one or more non-transitory computer-readable media comprising computer-executable instructions that, when executed by one or more processors, cause the one or more processors to perform the method of any one of the examples 29-34.

Example 36 may include a computerized system, comprising a memory configured to store computer-executable instructions, and a processor configured to access the memory and execute the computer-executable instructions to perform the method of any one of examples 29-34.

Example 37 may include a computer-implemented method, comprising identifying, by a system, a first checkpoint corresponding to a first decision trigger area of a road system, identifying, by the system, a second checkpoint corresponding to a second decision trigger area of the road system, identifying, by the system, a third checkpoint corresponding to a third decision trigger area of the road system, identifying, by the system, a fourth checkpoint corresponding to a fourth decision trigger area, identifying, by the system, a plurality of probe trips between the first checkpoint to the second checkpoint that pass through the third checkpoint and the fourth checkpoint, aggregating, by the system, the plurality of probe trips to produce a path between the third checkpoint and the fourth checkpoint, and storing, by the system, the path between the third checkpoint and the fourth checkpoint to be utilized for production of direction paths, the direction paths to be utilized to provide directions between locations.

Example 38 may include the method of example 37, wherein a route along the road system is defined from the third checkpoint to the fourth checkpoint, and wherein aggregating the plurality of probe trips comprises dividing, by the system, the route into multiple route segments, sampling, by the system, each of the multiple route segments to acquire points from each of the plurality of probe trips within each of the multiple route segments, determining, by the system, geometric medians for each of the multiple route segments based at least in part on the points from each of plurality of probe trips, and producing, by the system, the path based at least in part on the geometric medians for each of the multiple route segments.

Example 39 may include the method of example 37, further comprising map matching the plurality of probe trips to a map representation, wherein identifying the plurality of probe trips comprises identifying the plurality of probe trips that have been map matched to the map representation.

Example 40 may include the method of example 39, wherein the map representation is a first map representation, and wherein the direction paths produced am to be displayed on a second map representation, the second map representation being a higher fidelity representation than the first map representation.

Example 41 may include the method of example 37, further comprising determining, by the system, a first tortuosity of a segment of the road system corresponding to the path, determining, by the system, a second tortuosity of the path, and comparing, by the system, the first tortuosity and the second tortuosity, wherein the path is stored based on the second tortuosity being within a defined threshold of the first tortuosity.

Example 42 may include the method of example 37, further comprising determining, by the system, a tortuosity of the path, and determining, by the system, that the tortuosity is within a tortuosity threshold, wherein the path is stored based at least in part on the tortuosity being within the tortuosity threshold.

Example 43 may include the method of example 37, further comprising receiving, by the system, a request for a direction route from a first location to a second location, determining, by the system, that the first checkpoint, the second checkpoint, the third checkpoint, and the fourth checkpoint are along the direction route, and utilizing, by the system, the path to produce a direction path for the direction route, wherein the direction path is to be utilized to provide directions from the first location to the second location.

Example 44 may include the method of example 43, wherein the request is received from a device, and wherein the method further comprises providing at least a portion of the direction path to the device for display by the device based on the request.

Example 45 may include the method of example 41, wherein the path is a first path, and wherein utilizing the first path to produce the direction path comprises merging the first path with a second path located adjacent to the first path to produce the direction path.

Example 46 may include the method of example 45, wherein merging the first path with the second path comprises generating a smooth connection between a first point on the first path located a distance from an intersection area between the first path and the second path and a second point on the second path located the distance from the intersection area.

Example 47 may include the method of example 35, further comprising identifying, by the system, a fifth checkpoint corresponding to a fifth decision trigger area of the road system, the fifth decision trigger area being adjacent to the fourth checkpoint, identifying, by the system, a second plurality of probe trips from the third checkpoint to the fifth checkpoint that pass through the second checkpoint and the fourth checkpoint, aggregating, by the system, the second plurality of probe trips to produce a second path from the second checkpoint to the fourth checkpoint, and storing, by the system, the second path from the second checkpoint to the fourth checkpoint to be utilized for production of direction routes.

Example 48 may include the method of example 35, wherein the third decision trigger area and the fourth decision trigger area are a same trigger area.

Example 49 may include the method of example 48, wherein the third checkpoint is located at a first predefined distance from an entrance of the of the third decision trigger area, and wherein the fourth checkpoint is located at a second predefined distance from an exit of the third decision trigger area.

Example 50 may include the method of example 35, wherein identifying the first checkpoint comprises identifying, by the system, the first decision trigger area of the road system and determining, by the system, that the first checkpoint is located at a first predefined distance from the first decision trigger area, identifying the second checkpoint comprises identifying, by the system, the second decision trigger area of the road system and determining, by the system, that the second checkpoint is located at a second predefined distance from the second decision trigger area, identifying the third checkpoint comprises identifying, by the system, the third decision trigger area of the road system and determining, by the system, that the third checkpoint is located at a third predefined distance from the third decision trigger area, and identifying the fourth checkpoint comprises identifying, by the system, the fourth decision trigger area of the road system and determining, by the system, that the fourth checkpoint is located at a fourth predefined distance from the fourth decision trigger area.

Example 51 may include the method of example 35, wherein the first decision trigger area comprises a first roadway intersection, a first roadway exit, a first roadway lane merge, a first roadway lane split, or a first roadway obstruction of the road system, the second decision trigger area comprises a second roadway intersection, a second roadway exit, a second roadway lane merge, a second roadway lane split, or a second roadway obstruction of the road system, the third decision trigger area comprises a third roadway intersection, a third roadway exit, a third roadway lane merge, a third roadway lane split, or a third roadway obstruction of the road system, and the fourth decision trigger area comprises a fourth roadway intersection, a fourth roadway exit, a fourth roadway lane merge, a fourth roadway lane split, or a fourth roadway obstruction of the road system.

Example 52 may include one or more non-transitory computer-readable media comprising computer-executable instructions that, when executed by one or more processors, cause the one or more processors to perform the method of any one of the examples 37-51.

Example 53 may include a computerized system, comprising a memory configured to store computer-executable instructions, and a processor configured to access the memory and execute the computer-executable instructions to perform the method of any one of examples 37-51.

Example 54 may include a computer-implemented method, comprising receiving, by a system, a request for directions from a first location to a second location along a road system, determining, by the system, a direction route from the first location to the second location, identifying, by the system, a path along the direction route, the path generated based at least in part on a plurality of probe trips from a third checkpoint to a fourth checkpoint along the direction route, the plurality of probe trips passing through a first checkpoint and a second checkpoint, and generating, by the system, a direction path utilizing the path, the direction path to be utilized to provide directions from the first location to the second location.

Example 55 may include the method of example 54, wherein the path comprises a first path, and wherein generating the direction path comprises identifying, by the system, a second path, the second path located adjacent to the first path along the direction route, and merging, by the system, the first path with the second path.

Example 56 may include the method of example 55, wherein the plurality of probe trips comprises a first plurality of probe trips, wherein the second path is generated based at least in part on a second plurality of probe trips from the first checkpoint to a fifth checkpoint along the direction route, and wherein the second plurality of probe trips pass through the second checkpoint and the fourth checkpoint.

Example 57 may include the method of example 55, wherein merging the first path with the second path comprises generating a smooth connection between a first point on the first path located a distance from an intersection area between the first path and the second path and a second point on the second path located the distance from the intersection area.

Example 58 may include the method of example 54, further comprising identifying, by the system, the first checkpoint, the second checkpoint, the third checkpoint, and the fourth checkpoint, identifying, by the system, the plurality of probe trips from the third checkpoint to the fourth checkpoint that pass through the first checkpoint and the second checkpoint, aggregating, by the system, the plurality of probe trips to produce the path, and storing, by the system, the path to be utilized for production of direction paths.

Example 59 may include the method of example 58, wherein aggregating the plurality of probe trips, comprises determining, by the system, a route along the road system from the first checkpoint to the second checkpoint, dividing, by the system, the route into multiple route segments, sampling, by the system, each of the multiple route segments to acquire points from each of the plurality of probe trips within each of the multiple route segments, determining, by the system, geometric medians for each of the multiple route segments based at least in part on the points from each of the plurality of probe trips, and producing, by the system, the path based at least in part on the geometric medians for each of the multiple route segments.

Example 60 may include the method of example 58, wherein identifying the first checkpoint comprises identifying a first decision trigger area of the road system along the direction route and determining that the first checkpoint is located at a first distance from the first decision trigger area, identifying the second checkpoint comprises identifying a second decision trigger area of the road system along the direction route and determining that the second checkpoint is located at a second distance from the second decision trigger area, identifying the third checkpoint comprises identifying a third decision trigger area of the road system along the direction route and determining that the third checkpoint is located at a third distance from the third decision trigger area, and identifying the fourth checkpoint comprises identifying a fourth decision trigger area of the road system along the direction route, the first decision trigger area and the second decision trigger area being located between the third decision trigger area and the fourth decision trigger area along the direction route, and determining that the fourth checkpoint is located at a fourth distance from the fourth decision trigger area.

Example 61 may include the method of example 58, wherein identifying the first checkpoint comprises identifying, by the system, a first decision trigger area of the road system along the direction route and determining, by the system, that the first checkpoint is located at a first distance from an entry of the first decision trigger area, identifying the second checkpoint comprises identifying, by the system, the first decision trigger area and determining, by the system, that the second checkpoint is located at a second distance from an exit of the first decision trigger area, identifying the third checkpoint comprises identifying, by the system, a second decision trigger area of the road system along the direction route and determining, by the system, that the third checkpoint is located at a third distance from the second decision trigger area, and identifying the fourth checkpoint comprises identifying, by the system, a third decision trigger area of the road system along the direction route, the first decision trigger area being located between the second decision trigger area and the third decision trigger area along the direction route, and determining, by the system, the fourth checkpoint is located at a fourth distance from the third decision trigger area.

Example 62 may include the method of example 54, wherein the request is received from a device, and wherein the method further comprises providing, to the device, at least a portion of the direction to be displayed by the device.

Example 63 may include one or more non-transitory computer-readable media comprising computer-executable instructions that, when executed by one or more processors, cause the one or more processors to perform the method of any one of the examples 54-62.

Example 64 may include a computerized system, comprising a memory configured to store computer-executable instructions, and a processor configured to access the memory and execute the computer-executable instructions to perform the method of any one of examples 54-62.

Example 65 may include a computer-implemented method, comprising transmitting, by a device, a request for directions from a first location to a second location along a road system, receiving, by the device, a portion of a direction path from the first location to the second location, the portion of the direction path generated based at least in pan on a plurality of probe trips from a first checkpoint to a second checkpoint that pass through a third checkpoint and a fourth checkpoint, the first checkpoint, the second checkpoint, the third checkpoint, and the fourth checkpoint being along a direction route from the first location to the second location, the direction route corresponding to the portion of the direction path, and presenting, by the device, an indication of the portion of the direction path, the indication of the portion of the direction path indicating at least one lane of the road system.

Example 66 may include the method of example 65, wherein the portion of the direction path corresponds to a decision trigger area of the road system, wherein the third checkpoint corresponds to decision trigger area, and wherein the device presents the indication of the portion of the direction path based at least in part on a location of the third checkpoint.

Example 67 may include the method of example 66, wherein the third checkpoint is located at a distance from the decision trigger area, and wherein the method further comprise, determining, by the device, a location of the device, wherein the indication of the portion of the direction path is presented based at least in part on the location of the device being at the location of the third checkpoint.

Example 68 may include the method of example 66, wherein the indication of the portion of the direction path indicates a maneuver to be performed corresponding to the decision trigger area.

Example 69 may include the method of example 65, wherein presenting the indication of the portion of the direction path comprises presenting, by the device, a line or an arrow displayed within a representation of the at least one lane on a display of the device.

Example 70 may include the method of example 65, wherein the portion of the direction path comprises a first portion of the direction path, wherein the plurality of probe trips comprises a first plurality of probe trips, and wherein the method further comprises receiving, by the device, a second portion of the direction path from the first location to the second location, the second portion of the direction path generated based at least in part on a second plurality of probe trips from the third checkpoint to a fifth checkpoint that pass through the fourth checkpoint and the second checkpoint, the fifth checkpoint being along the direction route from the first location to the second location.

Example 71 may include the method of example 70, wherein the first portion of the direction path corresponds to a first decision trigger area of the road system, wherein the first portion of the direction path is received based at least in part on the device approaching the first decision trigger area, wherein the second portion of the direction path corresponds to a second decision trigger area of the road system, and wherein the second portion of the direction path is received based at least in part on the device approaching the second decision trigger area.

Example 72 may include the method of example 71, further comprising determining, by the device, locations of the device as the device travels from the first location to the second location, and transmitting, by the device, indications of the locations of the device, wherein the device ii determined to be approaching the first decision trigger area and the device is determined to be approaching the second decision trigger area based at least in part on the locations of the device being transmitted by the device.

Example 73 may include the method of example 65, further comprising determining, by the device, locations of the device as the device travels from the first checkpoint to the second checkpoint through the third checkpoint and the fourth checkpoint, and transmitting, by the device, indications of the locations of the device, wherein the plurality of probe trips are updated based on the indications of the locations of the device.

Example 74 may include one or more non-transitory computer-readable media comprising computer-executable instructions that, when executed by one or more processors, cause the one or more processors to perform the method of any one of the examples 65-73.

Example 75 may include a computerized system, comprising a memory configured to store computer-executable instructions, and a processor configured to access the memory and execute the computer-executable instructions to perform the method of any one of examples 65-73.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A computer-implemented method, comprising:
identifying, by a system, a first checkpoint corresponding to a first decision trigger area of a road system;
identifying, by the system, a second checkpoint corresponding to a second decision trigger area of the road system;
identifying, by the system, a third checkpoint corresponding to a third decision trigger area of the road system;
identifying, by the system, a fourth checkpoint corresponding to a fourth decision trigger area;
identifying, by the system, a plurality of probe trips between the first checkpoint to the second checkpoint that pass through the third checkpoint and the fourth checkpoint;
aggregating, by the system, the plurality of probe trips to produce a path between the third checkpoint and the fourth checkpoint; and
storing, by the system, the path between the third checkpoint and the fourth checkpoint to be utilized for production of direction paths, the direction paths to be utilized to provide directions between locations.

2. The method of claim 1, wherein a route along the road system is defined from the third checkpoint to the fourth checkpoint, and wherein aggregating the plurality of probe trips comprises:
dividing, by the system, the route into multiple route segments;
sampling, by the system, each of the multiple route segments to acquire points from each of the plurality of probe trips within each of the multiple mute segments;
determining, by the system, geometric medians for each of the multiple route segments based at least in part on the points from each of plurality of probe trips; and
producing, by the system, the path based at least in part on the geometric medians for each of the multiple route segments.

3. The method of claim 1, further comprising map matching the plurality of probe trips to a map representation, wherein identifying the plurality of probe trips comprises identifying the plurality of probe trips that have been map matched to the map representation.

4. The method of claim 3, wherein the map representation is a first map representation, and wherein the direction paths produced are to be displayed on a second map representation, the second map representation being a higher fidelity representation than the first map representation.

5. The method of claim 1, further comprising:
determining, by the system, a first tortuosity of a segment of the road system corresponding to the path;
determining, by the system, a second tortuosity of the path; and
comparing, by the system, the first tortuosity and the second tortuosity, wherein the path is stored based on the second tortuosity being within a defined threshold of the first tortuosity.

6. The method of claim 1, further comprising:
determining, by the system, a tortuosity of the path; and
determining, by the system, that the tortuosity is within a tortuosity threshold, wherein the path is stored based at least in part on the tortuosity being within the tortuosity threshold.

7. The method of claim 1, further comprising:
receiving, by the system, a request for a direction route from a first location to a second location;
determining, by the system, that the first checkpoint, the second checkpoint, the third checkpoint, and the fourth checkpoint are along the direction route; and
utilizing, by the system, the path to produce a direction path for the direction route, wherein the direction path is to be utilized to provide directions from the first location to the second location.

8. The method of claim 7, wherein the request is received from a device, and wherein the method further comprises providing at least a portion of the direction path to the device for display by the device based on the request.

9. The method of claim 7, wherein the path is a first path, and wherein utilizing the first path to produce the direction path comprises merging the first path with a second path located adjacent to the first path to produce the direction path.

10. The method of claim 9, wherein merging the first path with the second path comprises generating a smooth connection between a first point on the first path located a distance from an intersection area between the first path and the second path and a second point on the second path located the distance from the intersection area.

11. One or more non-transitory computer-readable media comprising computer-executable instructions that, when executed by one or more processors, cause the one or more processors to perform:
identifying a first checkpoint corresponding to a first decision trigger area of a road system;
identifying a second checkpoint corresponding to a second decision trigger area of the road system;
identifying a third checkpoint corresponding to a third decision trigger area of the road system;
identifying a fourth checkpoint corresponding to a fourth decision trigger area;
identifying a plurality of probe trips between the first checkpoint to the second checkpoint that pass through the third checkpoint and the fourth checkpoint;
aggregating the plurality of probe trips to produce a path between the third checkpoint and the fourth checkpoint; and
storing the path between the third checkpoint and the fourth checkpoint to be utilized for production of direction paths, the direction paths to be utilized to provide directions between locations.

12. The one or more non-transitory computer-readable media of claim 1, wherein a route along the road system is defined from the third checkpoint to the fourth checkpoint, and wherein aggregating the plurality of probe trips comprises:
dividing the route into multiple route segments;
sampling each of the multiple route segments to acquire points from each of the plurality of probe trips within each of the multiple route segments;
determining geometric medians for each of the multiple route segments based at least in part on the points from each of plurality of probe trips; and
producing the path based at least in part on the geometric medians for each of the multiple route segments.

13. The one or more non-transitory computer-readable media of claim 11, wherein the instructions, when executed by the one or more processors, further cause the one or more processors to perform map matching the plurality of probe trips to a map representation, wherein identifying the plurality of probe trips comprises identifying the plurality of probe trips that have been map matched to the map representation.

14. The one or more non-transitory computer-readable media of claim 11, wherein the instructions, when executed by the one or more processors, further cause the one or more processors to perform:
identifying a fifth checkpoint corresponding to a fifth decision trigger area of the road system, the fifth decision trigger area being adjacent to the fourth checkpoint;
identifying a second plurality of probe trips from the third checkpoint to the fifth checkpoint that pass through the second checkpoint and the fourth checkpoint;
aggregating the second plurality of probe trips to produce a second path from the second checkpoint to the fourth checkpoint; and
storing the second path from the second checkpoint to the fourth checkpoint to be utilized for production of direction routes.

15. The one or more non-transitory computer-readable media of claim 11, wherein the third decision trigger area and the fourth decision trigger area are a same trigger area.

16. The one or more non-transitory computer-readable media of claim 15, wherein the third checkpoint is located at a first predefined distance from an entrance of the of the third decision trigger area, and wherein the fourth checkpoint is located at a second predefined distance from an exit of the third decision trigger area.

17. The one or more non-transitory computer-readable media of claim 11, wherein:
identifying the first checkpoint comprises:
identifying the first decision trigger area of the road system; and
determining that the first checkpoint is located at a first predefined distance from the first decision trigger area;
identifying the second checkpoint comprises:
identifying the second decision trigger area of the road system; and
determining that the second checkpoint is located at a second predefined distance from the second decision trigger area;
identifying the third checkpoint comprises:
identifying the third decision trigger area of the road system; and
determining that the third checkpoint is located at a third predefined distance from the third decision trigger area; and
identifying the fourth checkpoint comprises:
identifying the fourth decision trigger area of the road system; and
determining that the fourth checkpoint is located at a fourth predefined distance from the fourth decision trigger area.

18. A computerized system, comprising:
memory configured to store computer-executable instructions; and
a processor configured to access the memory and execute the computer-executable instructions to at least:
identify a first checkpoint corresponding to a first decision trigger area of a road system;
identify a second checkpoint corresponding to a second decision trigger area of the road system;
identify a third checkpoint corresponding to a third decision trigger area of the road system;
identify a fourth checkpoint corresponding to a fourth decision trigger area;
identify a plurality of probe trips between the first checkpoint to the second checkpoint that pass through the third checkpoint and the fourth checkpoint;
aggregate the plurality of probe trips to produce a path between the third checkpoint and the fourth checkpoint; and
store the path between the third checkpoint and the fourth checkpoint to be utilized for production of direction paths, the direction paths to be utilized to provide directions between locations.

19. The computerized system of claim 18, wherein the processor is further configured to execute the computer-executable instructions to at least:
receive a request for a direction route from a first location to a second location;
determine that the first checkpoint, the second checkpoint, the third checkpoint, and the fourth checkpoint are along the direction route; and
utilize the path to produce a direction path for the direction route, wherein the direction path is to be utilized to provide directions from the first location to the second location.

20. The computerized system of claim 18, wherein:
the first decision trigger area comprises a first roadway intersection, a first roadway exit, a first roadway lane merge, a first roadway lane split, or a first roadway obstruction of the road system;
the second decision trigger area comprises a second roadway intersection, a second roadway exit, a second roadway lane merge, a second roadway lane split, or a second roadway obstruction of the road system;
the third decision trigger area comprises a third roadway intersection, a third roadway exit, a third roadway lane merge, a third roadway lane split, or a third roadway obstruction of the road system; and
the fourth decision trigger area comprises a fourth roadway intersection, a fourth roadway exit, a fourth roadway lane merge, a fourth roadway lane split, or a fourth roadway obstruction of the road system.
